(19) United States
(12) Patent Application Publication
(10) Pub. No.: US 2023/0402601 A1
(43) Pub. Date: Dec. 14, 2023

(54) BATTERY

(71) Applicant: SEMICONDUCTOR ENERGY LABORATORY CO., LTD., Atsugi-shi (JP)

(72) Inventors: Shunpei YAMAZAKI, Tokyo (JP); Shotaro MURATSUBAKI, Atsugi (JP); Takayuki IKEDA, Atsugi (JP)

(21) Appl. No.: 18/326,655

(22) Filed: May 31, 2023

(30) Foreign Application Priority Data
Jun. 8, 2022 (JP) 2022-092770
Jun. 22, 2022 (JP) 2022-100210
Jun. 28, 2022 (JP) 2022-103321
Jul. 8, 2022 (JP) 2022-110660
Sep. 2, 2022 (JP) 2022-139925
Sep. 22, 2022 (JP) 2022-151119
Jan. 10, 2023 (JP) 2023-001793
Mar. 7, 2023 (JP) 2023-034991

(51) Int. Cl. H01M 4/525; H01M 4/1315

(52) U.S. Cl. CPC H01M 4/525; H01M 4/1315; H01M 2004/028

(57) ABSTRACT

To provide a high-safety battery. The battery includes a positive electrode including a positive electrode active material, a negative electrode including a negative electrode active material, and an electrolyte solution. The positive electrode active material includes a first region and a second region. The first region contains cobalt, magnesium, fluorine, and oxygen. The second region contains cobalt and oxygen. The first region is closer to a surface of the positive electrode active material than the second region is. The negative electrode active material contains graphite. The electrolyte solution contains a mixed organic solvent. When the battery in a fully charged state undergoes a nail penetration test in which the nail diameter is 3 mm and the nail penetration speed is 5 mm/sec, the voltage of the battery decreases from a first voltage Vb to a second voltage Vc and then exceeds the second voltage Vc.

### BACKGROUND OF THE INVENTION

### 1. Field of the Invention

One embodiment of the present invention relates to a battery and more particularly, to a secondary battery. The present invention is not limited to the above field and relates to a semiconductor device, a display device, a light-emitting device, a power storage device, a lighting device, an electronic device, a vehicle, and manufacturing methods thereof. The secondary battery of the present invention can be used as a power supply necessary for the above semiconductor device, display device, light-emitting device, power storage device, lighting device, electronic device, and vehicle. For example, the above electronic device may be an information terminal device provided with the secondary battery. Furthermore, the above power storage device may be a stationary power storage device, for example.

### 2. Description of the Related Art

In recent years, demand for lithium-ion secondary batteries (also referred to as lithium-ion batteries) with high output and high capacity has rapidly grown and the lithium-ion secondary batteries are repeatedly usable energy sources that are essential for today's society.

It is said that lithium-ion secondary batteries can hardly be safe when having high capacity. A positive electrode active material with a layered rock-salt crystal structure, which includes two-dimensional lithium ion diffusion paths, is expected to enable high capacity, for example. However, the positive electrode active material having a layered rock-salt crystal structure has been disadvantageous in terms of safety because the crystal structure will be collapsed by excessive extraction of lithium ions at the time of charging, easily resulting in thermal runaway. To suppress an increase in battery temperature under abnormal conditions, e.g., at the time of nail penetration that is conducted in safety testing called a nail penetration test, Patent Document 1 proposes a structure in which a protective layer is disposed between a positive electrode composite layer and a positive electrode current collector, for example.

A known positive electrode active material with a layered rock-salt crystal structure is lithium cobalt oxide (LiCoO₂). In lithium cobalt oxide, which has a layered rock-salt crystal structure, lithium ions can move two-dimensionally between layers composed of CoO₆ octahedrons, leading to favorable cycle performance. However, lithium cobalt oxide unfortunately undergoes a phase change due to charging and discharging. For example, a phase change from the hexagonal phase to the monoclinic phase occurs in lithium cobalt oxide when lithium ions are extracted to some extent at the time of charging. Thus, to use lithium cobalt oxide such that it enables favorable cycle performance, the amount of lithium ions to be extracted has been limited. Patent Documents 2 to 4, for example, propose structures for solving these problems, in which an additive element is added to lithium cobalt oxide. Crystal structures of positive electrode active materials have also been studied (Non-Patent Documents 1 to 4).

X-ray diffraction (XRD) is one of methods used for analysis of crystal structures of positive electrode active materials. XRD data can be analyzed with the use of the Inorganic Crystal Structure Database (ICSD) described in Non-Patent Document 5. For example, the ICSD can be referred to for the lattice constant of the lithium cobalt oxide described in Non-Patent Document 6. For Rietveld analysis, the analysis program RIETAN-FP (Non-Patent Document 7) can be used, for example.

As image processing software, for example, ImageJ (Non-Patent Documents 8 to 10) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 11) can be used, for example.

Fluorides such as fluorite (calcium fluoride) have been used as fusing agents in iron manufacture and the like for a very long time, and the physical properties of fluorides have been studied (Non-Patent Document 12).

Lithium-ion secondary batteries are known to enter thermal runaway after passing through several states when the temperature increases at the time of charging (Non-Patent Document 13).

Various researches and developments have been conducted for the reliability and safety of lithium-ion secondary batteries. For example, Non-Patent Document 14 shows the thermal stability of a positive electrode active material and an electrolyte solution.

As shown in Non-Patent Document 15, for example, Shannon's ionic radii are known.

### REFERENCE

### Patent Documents

[Patent Document 1] Japanese Published Patent Application No. 2019-129009
[Patent Document 2] Japanese Published Patent Application No. 2019-179758
[Patent Document 3] PCT International Publication No. WO2020/026078
[Patent Document 4] Japanese Published Patent Application No. 2020-140954

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4] G. G. Amatucci et al., “CoO₂, The End Member of the LiₓCoO₂ Solid Solution”, J. Electrochem. Soc., 143 (3), 1114 (1996).
[Non-Patent Document 5] Belsky, A. et al., “New developments in the Inorganic Crystal Structure Database (ICSD): accessibility in support of materials research and design”, Acta Cryst., (2002), B58, 364-369.
[Non-Patent Document 6] Akimoto, J.; Gotoh, Y.; Oosawa, Y. “Synthesis and structure refinement of LiCoO₂ single crystals”, Journal of Solid State Chemistry (1998) 141, pp. 298-302.
[Non-Patent Document 7] F. Izumi and K. Momma, Solid State Phenom., 130, 15-20 (2007).
[Non-Patent Document 8] Rasband, W. S., ImageJ, U. S. National Institutes of Health, Bethesda, Maryland, USA, http://rsb.info.nih.gov/ij/, 1997-2012.
[Non-Patent Document 9] Schneider, C. A., Rasband, W. S., Eliceiri, K. W., “NIH Image to ImageJ: 25 years of image analysis”, Nature Methods, 9, 671-675, 2012.
[Non-Patent Document 10] Abramoff, M. D., Magelhaes, P. J., Ram, S. J., “Image Processing with ImageJ”, Biophotonics International, volume 11, issue 7, pp. 36-42, 2004.
[Non-Patent Document 11] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst, 55.
[Non-Patent Document 12] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1], 12-17 (1953).
[Non-Patent Document 13] Nobuo Eda, “2-4: Mechanism of Heat Generation” in “Learning Charging and Discharging Techniques of Li Ion Battery from Data” [Translated from Japanese.], CQ Publishing Co., Ltd., Apr. 4, 2020, pp. 68-72.
[Non-Patent Document 14] Shinya Kitano et al., GS Yuasa Technical Report, Vol. 2, No. 2, December, 2015, pp. 18-24.
[Non-Patent Document 15] Shannon et al., Acta A, 32 (1976) 751.

### SUMMARY OF THE INVENTION

The lithium cobalt oxide (LiCoO₂, also referred to as LCO) described in Patent Documents 2 to 4 is said to have low thermal stability. In a lithium-ion secondary battery, when an internal short circuit is caused by a nail penetration test, Joule heat is generated to make lithium cobalt oxide have high temperatures and release oxygen. The oxygen released from the lithium cobalt oxide reacts with an electrolyte solution or the like, which leads to thermal runaway in some cases. Patent Document 1 discloses the structure in which a protective layer is disposed between a positive electrode current collector and a positive electrode composite layer to suppress an increase in battery temperature at the time of nail penetration.

In view of the above, an object of one embodiment of the present invention is to provide a high-safety battery. Another object of one embodiment of the present invention is to provide a high-capacity and high-safety battery.

Note that the description of these objects does not preclude the existence of other objects. In one embodiment of the present invention, there is no need to achieve all these objects. Other objects can be derived from the description of the specification, the drawings, and the claims.

One embodiment of the present invention is a battery which includes a positive electrode and in which the positive electrode includes a positive electrode active material; the positive electrode active material includes a first region and a second region; the first region contains lithium, cobalt, magnesium, and oxygen; the second region contains lithium, cobalt, and oxygen; the first region is closer to a surface of the positive electrode active material than the second region is; the first region has a thickness greater than or equal to 1 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains lithium, cobalt, magnesium, nickel, and oxygen; the second region contains lithium, cobalt, and oxygen; the first region is closer to a surface of the positive electrode active material than the second region is; the first region has a thickness greater than or equal to 1 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains lithium, cobalt, magnesium, nickel, fluorine, and oxygen; the second region contains lithium, cobalt, and oxygen; the first region is closer to a surface of the positive electrode active material than the second region is; the first region has a thickness greater than or equal to 2 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains lithium, cobalt, magnesium, and oxygen; the second region contains lithium, cobalt, aluminum, and oxygen; the first region is closer to a surface of the positive electrode active material than the second region is; the first region has a thickness greater than or equal to 2 nm and less than or equal to 20 nm; and the magnesium has a concentration higher than 0 atomic % and lower than or equal to 10 atomic %. In another embodiment of the present invention, the first region preferably extends 5 nm from the surface.

In another embodiment of the present invention, the volume resistivity of powder of the positive electrode active material is preferably higher than or equal to 1.0×10⁵ Ω·cm under a pressure of 64 MPa.

In another embodiment of the present invention, an increment ΔT of the temperature of the battery is preferably less than or equal to 50° C. when the battery undergoes a nail penetration test in which the voltage of the battery is 4.5 V, the nail diameter is 3 mm, and the nail penetration speed is 5 mm/sec.

Another embodiment of the present invention is a battery which includes a positive electrode and in which the positive electrode includes a positive electrode active material; the positive electrode active material includes a first region and a second region; the first region contains first lithium, cobalt, magnesium, and oxygen; the second region contains second lithium, cobalt, and oxygen; the first region is closer to a surface of the positive electrode active material than the second region is; fluorine is adsorbed onto the surface of the positive electrode active material; the fluorine is bonded to the first lithium; the first region has a thickness greater than or equal to 2 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains first lithium, cobalt, magnesium, nickel, and oxygen; the second region contains second lithium, cobalt, and oxygen; the first region is closer to a surface of the positive electrode active material than the second region is; fluorine is adsorbed onto the surface of the positive electrode active material; the fluorine is bonded to the first lithium; the first region has a thickness greater than or equal to 2 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains first lithium, cobalt, magnesium, nickel, first fluorine, and oxygen; the second region contains second lithium, cobalt, and oxygen; the first region is closer to a surface of the positive electrode active material than the second region is; second fluorine is adsorbed onto the surface of the positive electrode active material; the second fluorine is bonded to the first lithium; the first region has a thickness greater than or equal to 2 nm and less than or equal to 20 nm; and the magnesium has a concentration higher than 0 atomic % and lower than or equal to 10 atomic %.

Another embodiment of the present invention is a battery which includes a positive electrode and in which the positive electrode includes a positive electrode active material; the positive electrode active material includes a first region and a second region; the first region contains first lithium, cobalt, magnesium, and oxygen; the second region contains second lithium, cobalt, aluminum, and oxygen; the first region is closer to a surface of the positive electrode active material than the second region is; fluorine is adsorbed onto the surface of the positive electrode active material; the fluorine is bonded to the first lithium; the first region has a thickness greater than or equal to 2 nm and less than or equal to 20 nm; and the magnesium has a concentration higher than 0 atomic % and lower than or equal to 10 atomic %.

In another embodiment of the present invention, the first region preferably extends 5 nm from the surface.

Another embodiment of the present invention is a battery which includes a positive electrode and in which the positive electrode includes a positive electrode active material; the positive electrode active material includes a first region and a second region; the first region contains first lithium, cobalt, magnesium, and oxygen; the second region contains second lithium, cobalt, and oxygen; the first region is closer to a surface of the positive electrode active material than the second region is; fluorine is adsorbed onto the surface of the positive electrode active material; the fluorine is bonded to the first lithium; and the volume resistivity of powder of the positive electrode active material is higher than or equal to 1.0×10⁵ Ω·cm under a pressure of 64 MPa.

Another embodiment of the present invention is a battery which includes a positive electrode and in which the positive electrode includes a positive electrode active material; the positive electrode active material contains cobalt, nickel, and lithium; the positive electrode active material includes a first region and a second region; the first region includes at least part of a surface of the positive electrode active material; the second region is located inward from the first region; the ratio of the number of atoms of the nickel of the first region to the number of atoms of the cobalt of the first region is less than 1; the ratio of the number of atoms of the nickel of the second region to the number of atoms of the cobalt of the second region is less than the ratio of the number of the atoms of the nickel of the first region to the number of the atoms of the cobalt of the first region; when the battery undergoes a nail penetration test for short-circuiting the battery without undergoing a charge and discharge cycle test, the battery does not ignite; and the nail penetration test is performed on the battery in a charged state in an environment at 25° C.

In another embodiment of the present invention, an increment ΔT of the temperature of the battery is preferably less than or equal to 50° C. when the battery undergoes the nail penetration test in which the voltage of the battery is 4.5 V, the nail diameter is 3 mm, and the nail penetration speed is 5 mm/sec.

Another embodiment of the present invention is a battery which includes a positive electrode and in which the positive electrode includes a positive electrode active material; the positive electrode active material contains cobalt, nickel, and lithium; the positive electrode active material includes a first region and a second region; the first region includes at least part of a surface of the positive electrode active material; the second region is located inward from the first region; the ratio of the number of atoms of the nickel of the first region to the number of atoms of the cobalt of the first region is less than 1; the ratio of the number of atoms of the nickel of the second region to the number of atoms of the cobalt of the second region is less than the ratio of the number of the atoms of the nickel of the first region to the number of the atoms of the cobalt of the first region; when the battery undergoes a nail penetration test for short-circuiting the battery after undergoing a charge and discharge cycle test with one to five cycles, the battery does not ignite; and the nail penetration test is performed on the battery in a charged state in an environment at 23° C.

In another embodiment of the present invention, an increment ΔT of the temperature of the battery is preferably less than or equal to 70° C. when the battery undergoes the nail penetration test in which the voltage of the battery is 4.6 V, the nail diameter is 3 mm, and the nail penetration speed is 5 mm/sec.

In another embodiment of the present invention, the battery preferably includes an electrolyte solution.

In another embodiment of the present invention, the resistance of the first region is preferably higher than that of the second region.

In another embodiment of the present invention, it is preferable that the charge and discharge cycle test be performed in an environment at 45° C., and in the charge and discharge cycle test, charging be constant current-constant voltage charging and discharging be constant current discharging.

In another embodiment of the present invention, it is preferable that the first region contain lithium, fluorine be adsorbed onto the surface, and the fluorine be capable of being bonded to the lithium of the first region.

Another embodiment of the present invention is a battery which includes a positive electrode and in which the positive electrode includes a positive electrode active material; the positive electrode active material includes a first region and a second region; the first region contains lithium, cobalt, magnesium, and oxygen; the second region contains lithium, cobalt, and oxygen; the first region is closer to a surface of the positive electrode active material than the second region is; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode and in which the positive electrode includes a positive electrode active material; the positive electrode active material includes a first region and a second region; the first region contains lithium, cobalt, magnesium, nickel, and oxygen; the second region contains lithium, cobalt, and oxygen; the first region is closer to a surface of the positive electrode active material than the second region is; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode and in which the positive electrode includes a positive electrode active material; the positive electrode active material includes a first region and a second region; the first region contains lithium, cobalt, magnesium, nickel, fluorine, and oxygen; the second region contains lithium, cobalt, and oxygen; the first region is closer to a surface of the positive electrode active material than the second region is; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode and in which the positive electrode includes a positive electrode active material; the positive electrode active material includes a first region and a second region; the first region contains lithium, cobalt, magnesium, and oxygen; the second region contains lithium, cobalt, aluminum, and oxygen; the first region is closer to a surface of the positive electrode active material than the second region is; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains lithium, cobalt, magnesium, and oxygen; the second region contains lithium, cobalt, and oxygen; the first region is closer to a surface of the positive electrode active material than the second region is; the negative electrode active material contains graphite; the electrolyte solution contains ethylene carbonate and diethyl carbonate; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains lithium, cobalt, magnesium, nickel, and oxygen; the second region contains lithium, cobalt, and oxygen; the first region is closer to a surface of the positive electrode active material than the second region is; the negative electrode active material contains graphite; the electrolyte solution contains ethylene carbonate and diethyl carbonate; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains lithium, cobalt, magnesium, nickel, fluorine, and oxygen; the second region contains lithium, cobalt, and oxygen; the first region is closer to a surface of the positive electrode active material than the second region is; the negative electrode active material contains graphite; the electrolyte solution contains ethylene carbonate and diethyl carbonate; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains lithium, cobalt, magnesium, and oxygen; the second region contains lithium, cobalt, aluminum, and oxygen; the first region is closer to a surface of the positive electrode active material than the second region is; the negative electrode active material contains graphite; the electrolyte solution contains ethylene carbonate and diethyl carbonate; in the positive electrode active material at a distance less than 2 cm from a nail hole due to a nail penetration test, the ratio of the atomic concentration of oxygen to the atomic concentration of cobalt is less than 1.3; and in the positive electrode active material at a distance more than or equal to 2 cm from the nail hole, the ratio of the atomic concentration of oxygen to the atomic concentration of cobalt is greater than or equal to 1.3.

In another embodiment of the present invention, it is preferable that in the nail penetration test, the voltage of the battery be 4.5 V, the nail diameter be 3 mm, and the nail penetration speed be 5 mm/sec.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains cobalt, magnesium, fluorine, and oxygen; the second region contains cobalt and oxygen; the first region is closer to a surface of the positive electrode active material than the second region is; the negative electrode active material contains graphite; the electrolyte solution contains a mixed organic solvent; and when the battery in a fully charged state undergoes a nail penetration test in which the nail diameter is 3 mm and the nail penetration speed is 5 mm/sec, the voltage of the battery decreases from a first voltage Vb to a second voltage Vc and then exceeds the second voltage Vc.

In another embodiment of the present invention, an increment ΔT of the temperature of the battery is preferably less than or equal to 50° C. when the battery undergoes the nail penetration test in which the voltage of the battery is 4.5 V.

Another embodiment of the present invention is a battery which includes a positive electrode, a negative electrode, and an electrolyte solution and in which the positive electrode includes a positive electrode active material; the negative electrode includes a negative electrode active material; the positive electrode active material includes a first region and a second region; the first region contains cobalt, magnesium, fluorine, and oxygen; the second region contains cobalt and oxygen; the first region is closer to a surface of the positive electrode active material than the second region is; the negative electrode active material contains graphite; the electrolyte solution contains a mixed organic solvent; and when the battery in a fully charged state undergoes a nail penetration test in which the nail diameter is 3 mm and the nail penetration speed is 5 mm/sec after undergoing a charge and discharge cycle test in an environment at 45° C., the voltage of the battery decreases to Vc and remains at the Vc.

In another embodiment of the present invention, an increment ΔT of the temperature of the battery is preferably less than or equal to 70° C. when the battery undergoes the nail penetration test in which the voltage of the battery is 4.6 V. In another embodiment of the present invention, the volume resistivity of powder of the positive electrode active material is preferably higher than or equal to 1.0×10⁵ Ω·cm under a pressure of 64 MPa.

In another embodiment of the present invention, it is preferable that the battery not ignite when the battery undergoes the nail penetration test.

According to one embodiment of the present invention, a high-safety battery can be provided. According to another embodiment of the present invention, a high-capacity and high-safety battery can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIGS. 1A and 1B illustrate a nail penetration test.

FIGS. 2A and 2B illustrate nail penetration operation.

FIG. 3 is a graph showing a change at the time of an internal temperature increase of a secondary battery in which an internal short circuit has occurred.

FIG. 4 is a graph showing a change at the time of an internal temperature increase of a secondary battery.

FIGS. 5A to 5C illustrate a change in voltage of a secondary battery and the like during a nail penetration test.

FIGS. 6A and 6B illustrate a laminated secondary battery.

FIGS. 7A to 7H are cross-sectional views of a positive electrode active material.

FIG. 8 is an example of a TEM image showing crystal orientations substantially aligned with each other.

FIG. 9A is an example of a STEM image showing crystal orientations substantially aligned with each other; FIG. 9B is an FFT pattern of a region of a rock-salt crystal RS; and FIG. 9C is an FFT pattern of a region of a layered rock-salt crystal LRS.

FIG. 10 is a phase diagram showing a relationship between temperature and compositions of lithium fluoride and magnesium fluoride.

FIG. 11 shows results of a DSC test.

FIG. 12 illustrates crystal structures of a positive electrode active material.

FIG. 13 illustrates crystal structures of a conventional positive electrode active material.

FIG. 14 shows charge depths and lattice constants of a positive electrode active material.

FIG. 15 shows XRD patterns calculated from crystal structures.

FIG. 16 shows XRD patterns calculated from crystal structures.

FIGS. 17A and 17B show XRD patterns calculated from crystal structures.

FIGS. 18A to 18C show lattice constants calculated by XRD.

FIGS. 19A and 19B are cross-sectional views of a positive electrode active material.

FIGS. 20A to 20C illustrate powder resistivity measurement.

FIGS. 21A to 21C illustrate methods for forming a positive electrode active material.

FIGS. 22A to 22C illustrate methods for forming a positive electrode active material.

FIG. 23 illustrates a method for forming a positive electrode active material.

FIGS. 24A to 24C illustrate methods for forming a positive electrode active material.

FIG. 25 illustrates a heating furnace and heating conditions.

FIGS. 26A and 26B illustrate a positive electrode active material layer.

FIGS. 27A to 27C illustrate a coin-type secondary battery.

FIGS. 28A to 28D illustrate a cylindrical secondary battery.

FIGS. 29A and 29B illustrate a wound secondary battery.

FIG. 30 illustrates a wound secondary battery.

FIGS. 31A to 31D illustrate electronic devices.

FIGS. 32A to 32C illustrate electronic devices.

FIGS. 33A to 33C illustrate vehicles.

FIGS. 34A to 34F are photographs illustrating results of a nail penetration test.

FIGS. 35A to 35F are photographs illustrating results of a nail penetration test.

FIGS. 36A to 36F are graphs illustrating results of a nail penetration test.

FIGS. 37A to 37F are graphs illustrating results of a nail penetration test.

FIGS. 38A to 38D are photographs illustrating results of a nail penetration test.

FIGS. 39A to 39E are photographs illustrating results of a nail penetration test.

FIGS. 40A to 40E are photographs illustrating results of a nail penetration test.

FIGS. 41A and 41B are photographs illustrating results of a nail penetration test.

FIGS. 42A to 42D are photographs illustrating results of a nail penetration test.

FIGS. 43A to 43C are photographs illustrating results of a nail penetration test.

FIGS. 44A and 44B are graphs illustrating results of a nail penetration test.

FIGS. 45A and 45B are graphs illustrating results of a nail penetration test.

FIGS. 46A and 46B are energy diagrams illustrating results of a nail penetration test.

FIG. 47 is a photograph illustrating results of a nail penetration test.

FIGS. 48A and 48B are graphs illustrating results of a nail penetration test.

FIG. 49 is a graph illustrating results of a nail penetration test.

FIG. 50 is a graph showing results of a DSC test.

FIG. 51A is a cross-sectional STEM image; FIG. 51B is an EDX mapping image; and FIG. 51C is a graph showing results of EDX line analysis.

FIG. 52A is a cross-sectional STEM image; FIG. 52B is an EDX mapping image; and FIG. 52C is a graph showing results of EDX line analysis.

FIG. 53A is a cross-sectional STEM image; FIG. 53B is an EDX mapping image; and FIG. 53C is a graph showing results of EDX line analysis.

FIG. 54A is a cross-sectional STEM image; and FIG. 54B is an EDX mapping image.

FIG. 55 is a graph showing results of a cycle test.

FIG. 56 is a graph showing results of powder resistivity measurement.

FIGS. 57A and 57B are graphs showing results of a cycle test.

FIG. 58 is a graph showing results of powder resistivity measurement.

FIG. 59 is a calculation model diagram.

FIG. 60A is a calculation model diagram; and FIG. 60B shows calculation results.

FIGS. 61A and 61B are calculation model diagrams.

FIGS. 62A and 62B are photographs illustrating results of a nail penetration test.

FIGS. 63A and 63B are photographs illustrating results of a nail penetration test.

FIG. 64 is a photograph illustrating results of a nail penetration test.

FIGS. 65A and 65B are graphs showing results of an impedance test; and FIG. is a diagram showing an equivalent circuit used for analysis.

FIG. 66 is a graph showing results of a DSC test.

### DETAILED DESCRIPTION OF THE INVENTION

Hereinafter, examples of embodiments of the present invention will be described with reference to the drawings and the like. Note that the present invention should not be construed as being limited to the examples of embodiments given below. Embodiments of the invention can be changed unless it deviates from the spirit of the present invention.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., LiₓMO₂. Note that M represents a transition metal and is cobalt and/or nickel unless otherwise specified in this specification and the like. In the case of a positive electrode active material in a lithium-ion secondary battery, x can be represented by (theoretical capacity−charge capacity)/theoretical capacity. For example, when a lithium-ion secondary battery that includes LiₓMO₂ as a positive electrode active material is charged to 219.2 mAh/g, the positive electrode active material can be represented by Li_{0.2}MO₂, i.e., x=0.2. Note that “x in LiₓMO₂ is small” means, for example, 0.1<x≤0.24.

Lithium cobalt oxide to be used for a positive electrode, which has been appropriately synthesized and almost satisfies the stoichiometric proportion, is LiCoO₂ with x of 1. Also in a secondary battery after its discharging ends, it can be said that lithium cobalt oxide therein is LiCoO₂ with x of 1. Here, “discharging ends” means that a voltage becomes 3.0 V or 2.5 V or lower at a discharge current of 100 mA/g or lower, for example.

Charge capacity and/or discharge capacity used for calculation of x in LiₓMO₂ are/is preferably measured under the conditions where there is no influence or small influence of a short circuit and/or decomposition of an electrolyte solution or the like. For example, data of a lithium-ion secondary battery that is measured while a sudden change in capacity that seems to be derived from a short circuit should not be used for calculation of x.

The space group of a positive electrode active material or the like is identified by XRD, electron diffraction, neutron diffraction, or the like. Thus, in this specification and the like, belonging to a space group or being a space group can be rephrased as being identified as a space group.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a transmission electron microscope (TEM) image or the like, a spot may appear in a position different from a theoretical position. For example, anions may be regarded as forming a cubic close-packed structure when a difference in orientation from a theoretical position is 5° or less or 2.5° or less.

The distribution of an element indicates the region where the element is successively detected by a successive analysis method to the extent that the detection value is no longer on the noise level.

In this specification and the like, a surface portion of a positive electrode active material is a region that extends less than or equal to 20 nm or less than or equal to 50 nm from a surface toward an inner portion in a direction perpendicular or substantially perpendicular to the surface. The surface portion can be rephrased as the vicinity of a surface or a region in the vicinity of a surface. “Perpendicular” or “substantially perpendicular” specifically means that an angle between a direction and a surface is greater than or equal to 80° and less than or equal to 100°. The inner portion refers to a region that is at a larger depth than the surface portion of a positive electrode active material. The inner portion is synonymous with a bulk or a core.

In this specification and the like, a positive electrode active material is sometimes referred to as a composite oxide, a positive electrode member, a positive electrode material, a secondary battery positive electrode member, a lithium-ion secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage applied to a positive electrode usually increases with increasing charge voltage of a secondary battery. The positive electrode active material of one embodiment of the present invention is stable when being in a charged state, which inhibits a reduction in discharge capacity due to repeated charging and discharging in a secondary battery.

An internal short circuit or an external short circuit of a secondary battery might cause not only a malfunction in charging operation and/or discharging operation of the secondary battery but also heat generation and ignition. In order to obtain a safe secondary battery, an internal short circuit or an external short circuit is preferably inhibited even at a high charge voltage. With the positive electrode active material of one embodiment of the present invention, an internal short circuit or an external short circuit is inhibited even at a high charge voltage. Thus, a secondary battery with both high discharge capacity and high safety can be obtained. Note that an internal short circuit of a secondary battery refers to contact between a positive electrode and a negative electrode in the battery. An external short circuit of a secondary battery refers to contact between a positive electrode and a negative electrode outside the battery on the assumption that the battery is misused.

In this specification and the like, ignition in a nail penetration test refers to a state where fire is observed outside an exterior body within one minute of nail penetration or a state where thermal runaway of a secondary battery has occurred within one minute of nail penetration. For example, a state where a pyrolysate(s) of a positive electrode and/or a negative electrode is observed at a position more than or equal to 2 cm away from a penetration point after a nail penetration test is finished is referred to as a state where thermal runaway has occurred. The pyrolysate(s) of the positive electrode and/or the negative electrode contains, for example, aluminum oxide formed by oxidation of aluminum of a positive electrode current collector or copper oxide formed by oxidation of copper of a negative electrode current collector.

For example, when layered rock-salt LiₓMO₂ (M is Co and/or Ni) is used as a positive electrode active material, the atomic ratio of O/the atomic ratio of M (hereinafter referred to as O/M ratio) is 2, theoretically. The O/M ratio decreases when oxygen is released from LiₓMO₂ owing to thermal runaway. Thus, a state where energy dispersive X-ray spectroscopy (EDX) analysis after a nail penetration test reveals that the O/M ratio at a position more than or equal to 2 cm away from a penetration point is less than 1.3, for example, is referred to as a state where thermal runaway has occurred. In other words, a state where EDX analysis reveals that the O/M ratio at a position more than or equal to 2 cm away from the penetration point is greater than or equal to 1.3 can be referred to as a state where no thermal runaway has occurred. A state where a battery voltage after a nail penetration test is finished decreases but increases subsequently can also be referred to as a state where no thermal runaway has occurred.

Meanwhile, a state where fire, a spark, and/or smoke that are/is observed remain(s) at a penetration point in a nail penetration test, i.e., fire does not spread, and thermal runaway of a secondary battery does not occur is not referred to as ignition. For example, a secondary battery that does not suffer from the above ignition even after undergoing a nail penetration test can be regarded as an ignition-free secondary battery.

Note that the description is made on the assumption that materials (such as a positive electrode active material, a negative electrode active material, an electrolyte solution, and a separator) of a secondary battery have not been degraded unless otherwise specified. A decrease in discharge capacity due to aging treatment and burn-in treatment during the manufacturing process of a secondary battery is not regarded as degradation. For example, a state where discharge capacity is higher than or equal to 97% of the rated capacity of a secondary battery composed of a cell or an assembled battery can be regarded as a non-degraded state. The rated capacity conforms to Japanese Industrial Standards (JIS C 8711:2019) in the case of a secondary battery for a portable device. The rated capacities of other secondary batteries conform to JIS described above, JIS for electric vehicle propulsion, industrial use, and the like, standards defined by the International Electrotechnical Commission (IEC), and the like.

In this specification and the like, in some cases, materials included in a secondary battery that have not been degraded are referred to as initial products or materials in an initial state, and materials that have been degraded (have discharge capacity lower than 97% of the rated capacity of the secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ion in the present invention, alkali metal ions or alkaline earth metal ions (specifically, sodium ions or the like) can be used. In that case, the present invention can be understood by replacing lithium ions with sodium ions or the like. In the case where there is no limitation on carrier ions, a simple term “secondary battery” is sometimes used.

In this specification and the like, the (001) plane, the (003) plane, and the like are sometimes collectively referred to as the (001) plane. In this specification and the like, the (001) plane is sometimes referred to as the C-plane, the basal plane, or the like. In lithium cobalt oxide, lithium diffuses through two-dimensional paths. In other words, lithium diffusion paths extend along a plane. In this specification and the like, a plane where a lithium diffusion path is exposed, i.e., a plane other than a plane where lithium is inserted and extracted (specifically, the (001) plane), is sometimes referred to as the edge plane.

In this specification and the like, a loading level means the active material weight per unit area of a surface of a current collector. The loading level of a negative electrode active material can be adjusted in accordance with the capacity of a positive electrode. The above loading level is preferably a loading level per one surface of a current collector in the case where a slurry containing an active material is applied onto both surfaces of the current collector. A lower loading level leads to lower discharge capacity. Thus, the loading level of a positive electrode active material is preferably higher than or equal to 8.0 mg/cm².

In this specification and the like, a secondary particle refers to a particle formed by aggregation of primary particles. In this specification and the like, a primary particle refers to a particle whose appearance shows no grain boundary. In this specification and the like, a single-particle refers to a particle whose appearance shows no grain boundary. In this specification and the like, a single crystal grain refers to a crystal grain whose inner portion does not have a grain boundary, whereas a polycrystalline grain refers to a crystal grain whose inner portion has a grain boundary. A polycrystalline grain may be regarded as a group of a plurality of crystallites, and a grain boundary may be regarded as an interface existing between two or more crystallites. Note that crystallites in a polycrystal grain are preferably in the same direction.

In this specification and the like, the phrase “A and/or B” is an example of an expression that encompasses only A, only B, and A and B.

### Embodiment 1

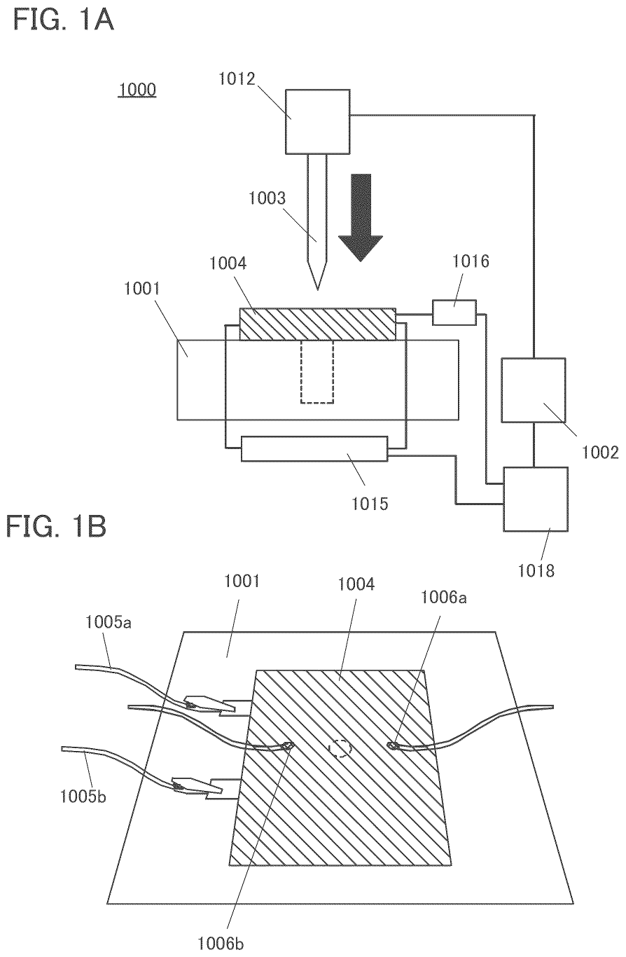

In a nail penetration test, a nail having a predetermined diameter in the range of 2 mm to 10 mm penetrates a secondary battery in a fully charged state at a predetermined speed. In this embodiment, first, a nail penetration test device is described. FIGS. 1A and 1B are respectively a side view and a perspective view of a nail penetration test device 1000.

### <Nail Penetration Test Device>

The nail penetration test device 1000 shown in FIG. 1A includes a stage 1001, a driving portion 1002, a nail 1003, a voltage measuring device 1015, a temperature measuring device 1016, and a control portion 1018. The driving portion 1002 includes a driving mechanism 1012 for moving the nail 1003 in the arrow direction indicated in the diagram. The driving mechanism 1012 is operative to make the nail 1003 pass through a secondary battery 1004 disposed over the stage 1001. Here, the secondary battery 1004 is in a fully charged state (the state of charge (SOC) of the secondary battery is 100%). This operation is referred to as nail penetration operation. The dashed line in FIG. 1A indicates a depression of the stage 1001 for holding the nail 1003 that has passed through the secondary battery in the nail penetration operation.

Data on the voltage of the secondary battery during the nail penetration operation is transmitted from the voltage measuring device 1015 to the control portion 1018. Specifically, the amount of change in voltage and the like are transmitted to the control portion 1018. Data on the temperature during the nail penetration operation is transmitted from the temperature measuring device 1016 to the control portion 1018. To control operation conditions of the nail 1003, the control portion 1018 can transmit a control signal to the driving portion 1002.

FIG. 1B is a perspective view illustrating the upper side of the stage 1001 of the nail penetration test device 1000 and the vicinity of the upper side. The secondary battery 1004 disposed over the stage 1001 is electrically connected to a wiring 1005a and a wiring 1005b. The wiring 1005a and the wiring 1005b, which belong to the voltage measuring device 1015, are electrically connected to a positive electrode side tab and a negative electrode side tab of the secondary battery 1004, so that the voltage of the secondary battery 1004 can be measured. The voltage of the secondary battery 1004 is simply referred to as a voltage, or is referred to as a voltage value between positive and negative electrodes, a battery voltage, a cell voltage, or an open-circuit voltage. In the case where a temperature sensor is used as the temperature measuring device 1016, the temperature sensor is disposed to be in contact with a surface of an exterior body of the secondary battery 1004.

In the example shown in FIG. 1B, a first temperature sensor 1006a and a second temperature sensor 1006b are disposed; alternatively, one temperature sensor or three or more temperature sensors may be disposed. In FIG. 1B, the first temperature sensor 1006a is disposed on a side where the wiring 1005a and the wiring 1005b are not disposed, and the second temperature sensor 1006b is disposed on the side where the wiring 1005a and the wiring 1005b are disposed. Two or more temperature sensors are preferably disposed to make it possible that, in the case where one temperature sensor cannot be used owing to expansion of the exterior body or the like, another of the temperature sensors is usable.

The side where the wiring 1005a and the wiring 1005b are disposed has a welded region, whereas the side where the wiring 1005a and the wiring 1005b are not disposed does not have the above welded region because the exterior body is bent at the latter side. This structure is preferable because it would inhibit expansion at the side where the wiring 1005a and the wiring 1005b are not disposed if the exterior body expands, making the first temperature sensor 1006a less likely to be peeled off than the second temperature sensor 1006b.

The dashed line ellipse in FIG. 1B indicates the region in which the nail 1003 passes through the secondary battery 1004 in the nail penetration operation. It is preferable that the first temperature sensor 1006a and the second temperature sensor 1006b be disposed in the regions that are equidistant from the region in which the nail 1003 passes through the secondary battery. Typically, the first temperature sensor 1006a and the second temperature sensor 1006b are disposed preferably less than or equal to 5 cm away from the region in which the nail 1003 passes through the secondary battery, further preferably less than or equal to 2 cm away from the region. In that case, it is possible to monitor a temperature change in the vicinity of the region in which the nail 1003 passes through the secondary battery. In the case where two or more temperature sensors are disposed, the nail penetration operation is preferably started after it is verified that the difference between the temperatures indicated by the temperature sensors is less than or equal to ±5° C., preferably less than or equal to ±2° C.

### <Secondary Battery in Nail Penetration Test>

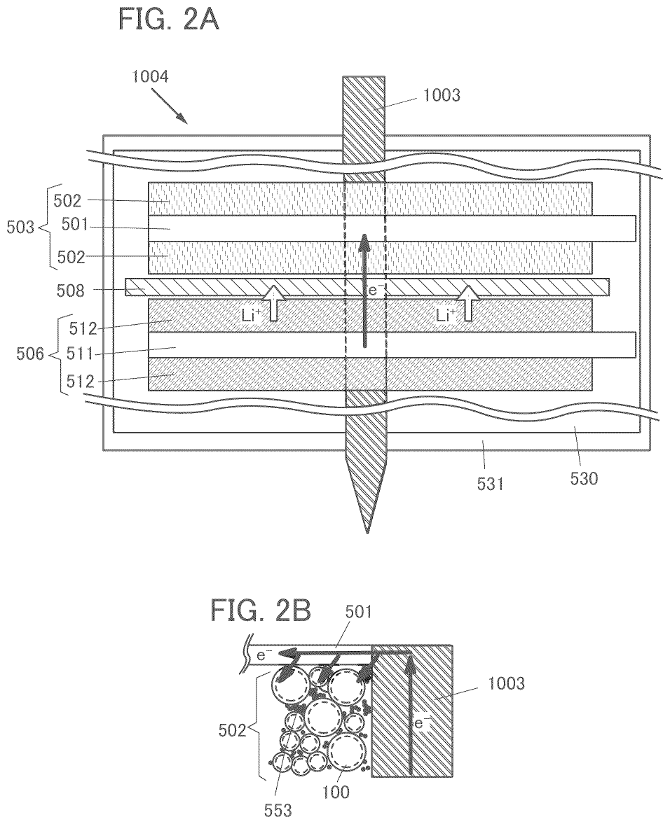

Next, the state of the secondary battery in the nail penetration test is specifically described with reference to FIGS. 2A and 2B and the like. In the nail penetration test, the nail 1003 having a predetermined diameter in the range of 2 mm to 10 mm penetrates the secondary battery 1004 in a fully charged state at a predetermined speed. FIG. 2A is a cross-sectional view showing the state where the nail 1003 penetrates the secondary battery 1004. The secondary battery 1004 has a structure in which a positive electrode 503, a separator 508, a negative electrode 506, and an electrolyte solution 530 are held in an exterior body 531. The positive electrode 503 includes a positive electrode current collector 501 and positive electrode active material layers 502 formed over both surfaces of the positive electrode current collector 501. The negative electrode 506 includes a negative electrode current collector 511 and negative electrode active material layers 512 formed over both surfaces of the negative electrode current collector 511. FIG. 2B is an enlarged view of the nail 1003, the positive electrode current collector 501, and their vicinities. The enlarged view also details a positive electrode active material 100 and a conductive material 553 of the positive electrode active material layer 502.

As shown in FIGS. 2A and 2B, when the nail 1003 penetrates the secondary battery 1004, or specifically, when the nail 1003 passes through the positive electrode 503 and the negative electrode 506, an internal short circuit occurs. This makes the potential of the nail 1003 equal to that of the negative electrode 506, so that an electron (e) flows to the positive electrode 503 through the nail 1003 and the like as indicated by the black arrows and Joule heat is generated in the portion where the internal short circuit has occurred and the vicinity of the portion. The internal short circuit causes carrier ions, typically lithium ions (Lit), to be extracted from the negative electrode 506 and to be released into the electrolyte solution as indicated by the white arrows. Note that before all the lithium ions are released from the negative electrode, reductive decomposition of the electrolyte solution starts on the negative electrode surface owing to a rapid increase in the battery temperature by the Joule heat generated by the internal short circuit. This is one of electrochemical reactions and is referred to as a reduction reaction of an electrolyte solution by a negative electrode.

In the case where the Joule heat increases the temperature of the secondary battery 1004 and the positive electrode active material is lithium cobalt oxide, the lithium cobalt oxide sometimes undergoes a phase change (i.e., a structural change) to an H1-3 type structure or an O1 type structure to further generate heat. The H1-3 type structure and the O1 type structure will be described later.

Then, as shown in FIGS. 2A and 2B, the electron (e⁻) that has flowed to the positive electrode 503 reduces Co, which is tetravalent in the lithium cobalt oxide in the charged state, to trivalent or divalent Co. This reduction reaction causes oxygen release from the lithium cobalt oxide, and an oxidation reaction due to the oxygen decomposes the electrolyte solution 530. This is one of electrochemical reactions and is referred to as an oxidation reaction of an electrolyte solution by a positive electrode. The speed at which a current flows into the positive electrode active material 100 or the like slightly varies depending on the insulating property of the positive electrode active material, and it is presumable that the speed at which a current flows affects the above electrochemical reaction.

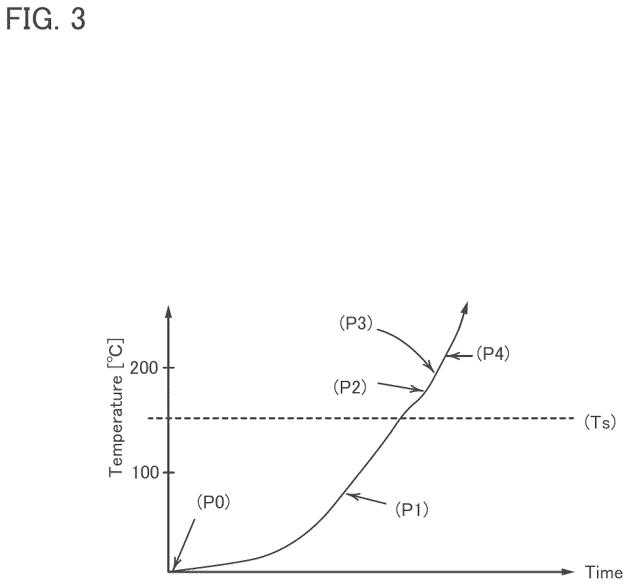

When an internal short circuit of a secondary battery occurs as described above, its temperature is presumed to change as shown in the graph of FIG. 3. FIG. 3 is the graph cited from [FIG. 2-12] on p. 70 of Non-Patent Document 13, which is partly retouched. This graph shows the temperature (specifically, the internal temperature) of a secondary battery as a function of time. Upon an internal short circuit at (P0), the temperature of the secondary battery increases over time. When the temperature of the secondary battery increases to reach approximately 100° C. as indicated by (P1) owing to heat generation due to Joule heat by the internal short circuit, the temperature sometimes further increases to exceed the threshold temperature for thermal runaway of the secondary battery, the reference temperature (Ts). Then, reduction of an electrolyte solution by a negative electrode (the negative electrode is C₆Li when graphite is used) and heat generation of the electrolyte solution are caused at (P2), oxidation of the electrolyte solution by a positive electrode and heat generation of the electrolyte solution are caused at (P3), and heat generation due to thermal decomposition of the electrolyte solution is caused at (P4). Accordingly, the secondary battery enters thermal runaway, resulting in ignition, smoking, or the like.

In a positive electrode active material at this time, a reaction occurs in which electrons rapidly flowing into the positive electrode active material reduce cobalt from Co⁴⁺ to Co²⁺ and oxygen is released from the positive electrode active material. This reaction, which is an exothermic reaction, accelerates thermal runaway. In other words, inhibiting this reaction enables a safe secondary battery that does not easily undergoes thermal runaway.

To inhibit the above reaction, for example, it is preferable that a surface portion of the positive electrode active material contain an additive element inhibiting release of oxygen and the concentration of the additive element be higher in the surface portion than in an inner portion. When no oxygen is released from the positive electrode active material, the above reduction reaction (e.g., the reaction in which Co⁴⁺ becomes Co²⁺) is inhibited. Examples of the additive element inhibiting release of oxygen include magnesium and aluminum. Magnesium is suitable as the additive element inhibiting release of oxygen because oxygen closer to magnesium requires higher energy for release. Nickel is also presumed to have an effect of inhibiting release of oxygen when present at a lithium site.

Even when cobalt or the like is reduced, insertion of lithium ions into the positive electrode active material before oxygen release would maintain electrical neutrality and thus prevent oxygen release. It can be thus said that regardless of whether electrons rapidly flow into the positive electrode active material, the crystal structure of the positive electrode active material should at least remain stable until insertion of lithium ions into the positive electrode active material from the negative electrode through the electrolyte solution is completed.

To prevent smoking, heat generation, and the like in the nail penetration test, it is probably preferable that an increase in the temperature of the secondary battery be inhibited and the negative electrode, the positive electrode, and/or the electrolyte solution have stable characteristics at high temperatures. Specifically, it is preferable that the positive electrode active material 100 have a stable structure from which no oxygen is released, or specifically, no oxygen is released even at high temperatures. Alternatively, the positive electrode active material 100 preferably has a structure such that a current flows to the positive electrode active material at a low speed. In that case, a marked effect of inhibiting thermal runaway and resultant ignition or the like may be obtained. As described later, the positive electrode active material 100 of one embodiment of the present invention can have both the above stable structure and the structure such that a current flows at a low speed.

### <Thermal Runaway of Secondary Battery>

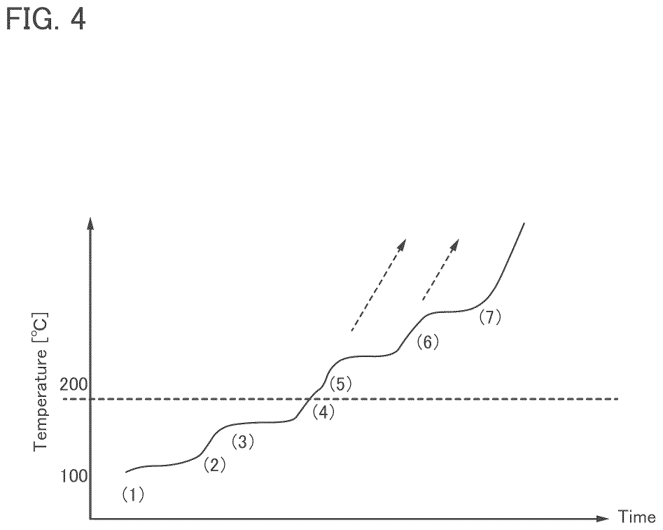

The mechanism of thermal runaway of a secondary battery is described with reference to FIG. 4 showing a graph cited from [FIG. 2-11] on p. 69 of Non-Patent Document 13, which is partly retouched. A secondary battery as described above enters thermal runaway after experiencing some states when the temperature (specifically, the internal temperature) increases during charging, for example. FIG. 4 is a graph showing the temperature of a secondary battery as a function of time. When the temperature of the secondary battery reaches 100° C. or the vicinity thereof, for example, (1) collapse of a solid electrolyte interphase (SEI) of a negative electrode and heat generation are caused. When the temperature of the secondary battery exceeds 100° C., (2) reduction of an electrolyte solution by the negative electrode (the negative electrode is C₆Li when graphite is used) and heat generation of the electrolyte solution are caused. At 150° C. and the vicinity thereof, (3) oxidation of the electrolyte solution by a positive electrode and heat generation of the electrolyte solution are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change of a positive electrode active material) are caused. Subsequently, when the temperature of the secondary battery exceeds 200° C., (6) decomposition of the negative electrode is caused, and finally, (7) the positive electrode and the negative electrode come into direct contact with each other. The secondary battery enters thermal runaway after experiencing such states, specifically the state (5), the state (6), or the state (7).

To prevent thermal runaway, it is probably preferable that an increase in the temperature of the secondary battery be inhibited and the negative electrode, the positive electrode, and/or the electrolyte solution have stable characteristics at high temperatures.

### <Feature 1 of Secondary Battery in Nail Penetration Test>

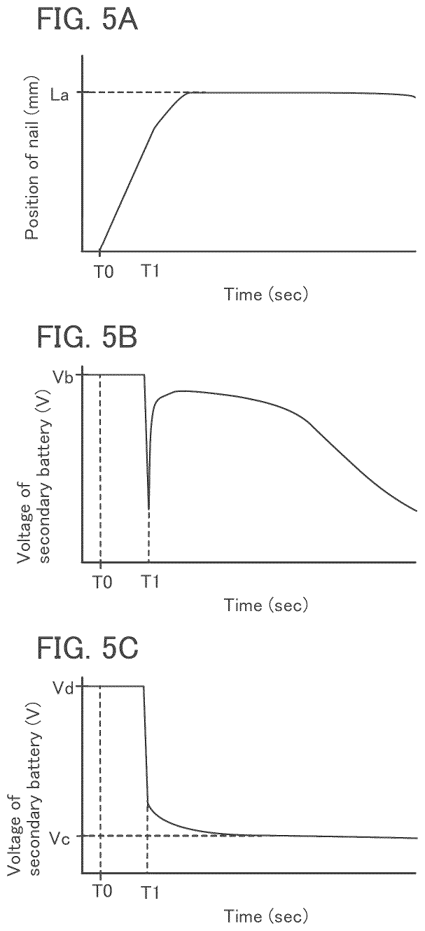

After nail penetration, the voltage of a secondary battery sometimes becomes 0 V, whereas the voltage of the secondary battery of one embodiment of the present invention decreases once and then increases, i.e., the voltage returns after decreasing, for example. Alternatively, the voltage of the secondary battery of one embodiment of the present invention decreases but not reaches 0 V, and remains low. Such voltage changes of the secondary battery are described with reference to FIGS. 5A to 5C.

FIG. 5A is an exemplary graph showing the relationship between the nail penetration operation time and the position of the nail 1003. The position of the nail 1003 means the position of the tip of the nail 1003, which may be referred to as the depth of the tip from a surface of the secondary battery 1004. In FIG. 5A, the nail 1003 can be determined to penetrate the secondary battery 1004 at Time T0, and the value of the position of the nail 1003 increases toward La. In FIG. 5A, the value of the position of the nail 1003 is constant after reaching La; the nail 1003 can be determined to pass through the secondary battery 1004 when the value reaches La.

FIG. 5B is an exemplary graph showing the voltage of the secondary battery 1004, with the x-axis representing the same nail penetration operation time as that in FIG. 5A. In FIG. 5B, Vb is the voltage of the secondary battery 1004 in a fully charged state. The nail 1003 penetrates the secondary battery 1004 at Time T0, and the voltage of the secondary battery 1004 decreases at Time T1. That is, at Time T1, the nail 1003 is presumably in contact with the positive electrode and the negative electrode, in which case the voltage often plummets. The voltage of the secondary battery of one embodiment of the present invention plummets and then increases. Such a voltage change of the secondary battery is a feature of the secondary battery of one embodiment of the present invention, and specifically, may be caused by the later-described positive electrode active material of one embodiment of the present invention.

FIG. 5C is an exemplary graph showing the voltage of the secondary battery 1004, with the x-axis representing the same nail penetration operation time as that in FIG. 5A. In FIG. 5C, the secondary battery 1004 is assumed to have been degraded by a charge and discharge cycle test or the like. Vd is the voltage of the secondary battery 1004 in a charged state. The nail 1003 penetrates the secondary battery 1004 at Time T0, and the voltage of the secondary battery 1004 decreases at Time T1. At Time T1, the nail 1003 is presumably in contact with the positive electrode and the negative electrode, in which case the voltage often plummets. The voltage of the secondary battery of one embodiment of the present invention plummets and then remains as low as Vc without reaching 0 V. Note that Vc is preferably higher than 0 V and lower than 1 V. Such a voltage change of the secondary battery is a feature of the secondary battery of one embodiment of the present invention, and specifically, may be caused by the later-described positive electrode active material of one embodiment of the present invention.

### <Feature 2 of Secondary Battery in Nail Penetration Test>

An increase in the temperature of the secondary battery when the nail penetration test is conducted, i.e., the difference between the temperature before the nail penetration test and the maximum temperature reached after the nail penetration (also referred to as an increment ΔT of temperature), is preferably less than or equal to 130° C., further preferably less than or equal to 100° C., still further preferably less than or equal to 70° C., yet still further preferably less than or equal to 50° C. The temperature is that at a position less than or equal to 5 cm away from the nail hole, preferably less than or equal to 2 cm away from the nail hole, and is specifically a value output with the use of the temperature sensor disposed less than or equal to 5 cm away from the nail hole, preferably less than or equal to 2 cm away from the nail hole. The temperature sensor is preferably disposed to be in contact with the exterior body of the secondary battery.

The maximum temperature at the time of the nail penetration test is preferably lower than or equal to 250° C., further preferably lower than or equal to 200° C., still further preferably lower than or equal to 180° C. Yet still further preferably, the maximum temperature is lower than the temperature at which oxygen release from the positive electrode and thermal decomposition of the positive electrode are caused.

The maximum temperature at the time of the nail penetration test is yet still further preferably lower than or equal to 150° C., yet still further preferably lower than or equal to 100° C., yet still further preferably lower than or equal to 80° C. Yet still further preferably, the maximum temperature is lower than the temperature at which oxidation of the electrolyte solution by the positive electrode is caused. Yet still further preferably, the maximum temperature is lower than the flash point of a mixed solvent used in the electrolyte solution. In the case where the flash point of the mixed solvent is unknown, the flash points of the solvents contained in the mixed solvent can be referred to.

### <Feature 3 of Secondary Battery in Nail Penetration Test>

The loading level of the positive electrode active material in the positive electrode of the secondary battery is preferably greater than or equal to 8 mg/cm² and less than or equal to 25 mg/cm², further preferably greater than or equal to 8 mg/cm² and less than or equal to 23 mg/cm², still further preferably greater than or equal to 7 mg/cm² and less than or equal to 21 mg/cm². The loading level in the above range makes it possible to provide a high-safety secondary battery.

In the secondary battery, the proportion of negative electrode capacity to positive electrode capacity is preferably higher than or equal to 75% and lower than or equal to 110%, further preferably higher than or equal to 75% and lower than 100%. The proportion of negative electrode capacity to positive electrode capacity in the above range makes it possible to provide a high-safety secondary battery. The proportion of negative electrode capacity to positive electrode capacity will be described later in Example.

### <Feature 4 of Secondary Battery in Nail Penetration Test>

Particles of the positive electrode active material of the secondary battery preferably have few cracks. A crack generated in the particle, which may be referred to as a slipping region caused at a crystal plane of the particle or a region in which the particle is cracked at a crystal plane, is often generated along the (001) plane. When the positive electrode active material is observed with a surface SEM or a cross-sectional SEM, for example, the number of observable cracks in one particle of the positive electrode active material is preferably greater than or equal to 0 and less than or equal to Generation of a crack is sometimes triggered by pressure application following application of a positive electrode slurry on the positive electrode current collector. Thus, in the manufacturing process of the positive electrode of the present invention, the linear pressure of a press is preferably lower than or equal to 500 kN/m, further preferably lower than or equal to 300 kN/m, still further preferably lower than or equal to 250 kN/m, for example.

### <Electrode Density>

The electrode density of the positive electrode of the secondary battery is preferably higher than or equal to 3.0 g/cm³ and lower than or equal to 4.0 g/cm³, further preferably higher than or equal to 3.0 g/cm³ and lower than or equal to 3.5 g/cm³. The electrode density can be within the above range when the linear pressure is set as described above. The positive electrode that has such an electrode density and the secondary battery that includes the positive electrode are presumably unlikely to enter thermal runaway.

### <Smooth Surface of Positive Electrode Active Material>

The positive electrode active material of the secondary battery preferably has a smooth surface on the whole. In other words, the positive electrode active material preferably has a shiny surface on the whole. Such a positive electrode active material can be regarded as having no corner or being rounded.

In addition, it is preferable that no or few ultrafine particles be attached to the surface of the positive electrode active material. In this specification and the like, an ultrafine particle refers to a metal oxide particle with a particle diameter greater than or equal to 0.001 lam and less than or equal to 0.1 lam. The ultrafine particle might be a fragment of the positive electrode active material and/or an additive element source that has not reacted, for example.

The particle diameter of the ultrafine particle is the Feret diameter or the equivalent diameter of projected area measured from a surface scanning electron microscope (SEM) image. A state where the number of the ultrafine particles in a surface SEM image of the positive electrode is less than or equal to 10/cm², preferably less than or equal to 5/cm² can be referred to as a state where there are no or few ultrafine particles.

### <Heating Performed Using Fusing Agent>

In the manufacturing process of the positive electrode active material of the secondary battery, a material serving as a fusing agent is preferably added together with the additive element source before heating. The fusing agent allows the surface of a composite oxide and the additive element source to be sufficiently melted and then, solidification starts. These steps would melt ultrafine particles if the ultrafine particles are attached to the surface of the composite oxide, in which case there are no or few ultrafine particles on the surface. In other words, the fact that there are no or few ultrafine particles on the surface of the positive electrode active material means that a material serving as a fusing agent has been added before heating in the manufacturing process of the positive electrode active material.

### <Initial Heating>

The positive electrode active material that has been subjected to the initial heating is smooth and shiny on the whole. The initial heating refers to heating performed on the composite oxide in the manufacturing process of the positive electrode active material. Performing the initial heating also reduces distortion, a crystal defect, and the like of the positive electrode active material.

### <Crystallinity>

The positive electrode active material of the secondary battery preferably has high crystallinity and is further preferably a single crystal or a polycrystal. The positive electrode active material is preferably subjected to the above initial heating to have high crystallinity. It is particularly preferable that the positive electrode active material is a single crystal, in which case a crack is not easily generated along with a volume change of the positive electrode active material due to charging and discharging. Furthermore, when the positive electrode active material that is a single crystal is used in the secondary battery, the secondary battery is presumably unlikely to ignite and can be safer.

### <Median Diameter (D50) of Positive Electrode Active Material>

The median diameter (D50) of the positive electrode active material included in the high-safety secondary battery is described. When the positive electrode active material is too small, coating might be difficult to perform in the formation of the positive electrode. Alternatively, when the positive electrode active material is too small, the surface area becomes too large, which might cause an excessive reaction between a positive electrode active material surface and the electrolyte. When the positive electrode active material is too small, a large amount of conductive material sometimes needs to be mixed, which might reduce the capacity. In view of these, the median diameter (D50) of the positive electrode active material is preferably greater than or equal to 1 μm, further preferably greater than or equal to 5 μm, still further preferably greater than or equal to 9 μm. The positive electrode active material preferably has a small median diameter (D50) to be unlikely to include a slipping region. The positive electrode active material preferably has a small median diameter (D50) to be unlikely to include a crack after a pressing step.

However, when the majority of the active material is too small, the positive electrode active material layer might have a reduced density or a side reaction with the electrolyte solution might be promoted, for example. In view of this, the median diameter (D50) of the positive electrode active material is preferably less than or equal to 20 μm, further preferably less than or equal to 18 μm, still further preferably less than or equal to 15 μm.

The above upper limits and the above lower limits of the median diameter (D50) of the positive electrode active material can be combined freely. For example, the above median diameter is greater than or equal to 1 μm and less than or equal to 20 μm, preferably greater than or equal to 1 μm and less than or equal to 18 μm, further preferably greater than or equal to 1 μm and less than or equal to 15 μm.

Note that the above-described median diameter (D50) can be, for example, measured with a particle size distribution analyzer or the like using a laser diffraction and scattering method or by observation with a SEM or a TEM. When measured with a particle size distribution analyzer or the like using a laser diffraction and scattering method, the median diameter (D50) is the corresponding particle diameter when the cumulative amount is 50% in a cumulative curve obtained as a result of the particle size distribution measurement. Note that in an example of a method for measuring the median diameter (D50) based on SEM analysis, TEM analysis, or the like, 20 or more particles are subjected to measurement to make a cumulative curve, and the corresponding diameter when the cumulative amount is 50% is used as the median diameter.

### <Laminated Secondary Battery>

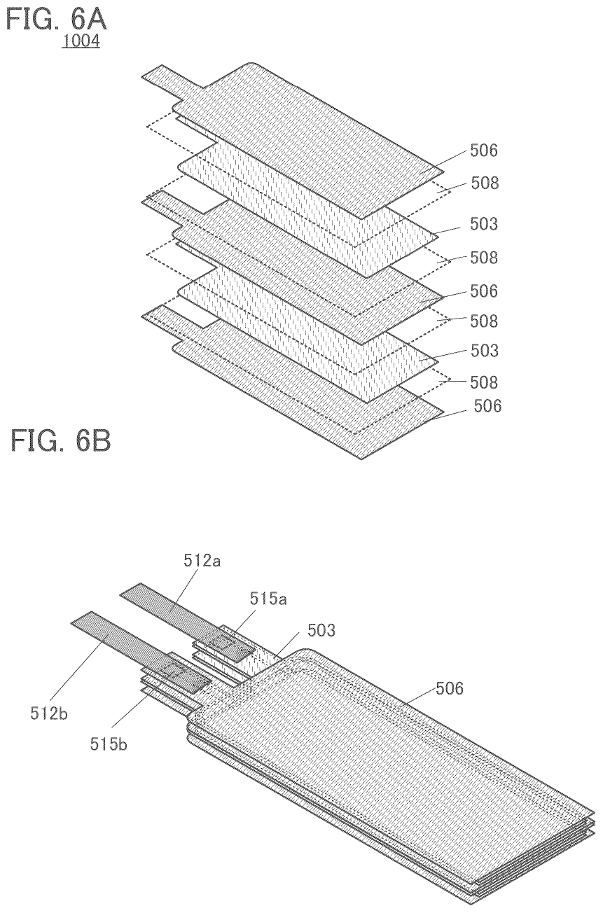

The secondary battery of one embodiment of the present invention is described. First, a typical laminated secondary battery is described with reference to FIGS. 6A and 6B and other drawings.

As shown in FIG. 6A, the secondary battery 1004 includes a plurality of the positive electrodes 503, a plurality of the negative electrodes 506, and a plurality of the separators 508. The separator 508 is provided between the positive electrode 503 and the negative electrode 506; in FIG. 6A, the separators 508 are indicated with dotted lines for clarity. In some cases, the separators 508 each include an electrolyte, or specifically, a liquid electrolyte (also referred to as an electrolyte solution). The secondary battery 1004 does not necessarily include the separators 508 when including a solid electrolyte or a semisolid electrolyte as an electrolyte.

The positive electrode 503 and the negative electrode 506 each include a protruding tab portion and a portion other than the tab portion. To the tab portions, the wiring 1005a, the wiring 1005b, and the like can be electrically connected in the nail penetration test device. The positive electrode 503 includes the positive electrode current collector and the positive electrode active material layer formed on the positive electrode current collector. It is preferable that the positive electrode active material layers be formed on both surfaces of the positive electrode current collector. The negative electrode 506 includes the negative electrode current collector and the negative electrode active material layer formed on the negative electrode current collector. It is preferable that the negative electrode active material layers be formed on both surfaces of the negative electrode current collector.

As shown in FIG. 6B, the plurality of positive electrodes 503, the plurality of negative electrodes 506, and the plurality of separators 508 are stacked, which are sometimes referred to as a stack as a whole in this specification and the like. The tab portions of the plurality of negative electrodes 506 are bonded together with a lead 512b at a bonding portion 515b and are electrically connected to each other. The tab portions of the plurality of positive electrodes 503 are bonded together with a lead 512a at a bonding portion 515a and are electrically connected to each other. The positive electrode active material layer and the negative electrode active material layer (simply referred to as active material layers) have a better insulating property than the positive electrode current collector and the negative electrode current collector (simply referred to as current collectors); thus, it is preferable that no active material layer be formed at the tab portions. The lead 512a and the lead 512b can be formed using a material selected from aluminum, nickel, copper, titanium, and an alloy thereof. Bonding at the bonding portion can be performed using ultrasonic welding. For the nail penetration test, the lead 512a and the lead 512b are optional; in the case where the nail penetration test is performed with the lead 512a and the lead 512b provided, the wiring 1005a and the wiring 1005b are electrically connected to the lead 512a and the lead 512b, respectively.

The secondary battery 1004 further includes the exterior body (now shown). The stack shown in FIG. 6A is held in the exterior body. Then, an electrolyte solution in which a lithium salt is dissolved, for example, is poured into the exterior body. That is, the electrolyte solution contains carrier ions, typically lithium ions. The secondary battery containing the lithium ions is referred to as a lithium-ion secondary battery.

The exterior body is preferably in the form of a film to have a smaller weight. The secondary battery that includes an exterior body in the form of a film is referred to as a laminated secondary battery. To achieve high cooling performance, the exterior body may be formed using a high-thermal-conductivity stack of a polymer and a metal. Specifically, it is preferable that the polymer and the metal be respectively polypropylene and aluminum, and nylon or the like may be disposed outside the exterior body. The exterior body may be alternatively a metal can case, and the secondary battery whose exterior body is a circular can case is referred to as a coin-type secondary battery.

### [Positive Electrode Active Material]

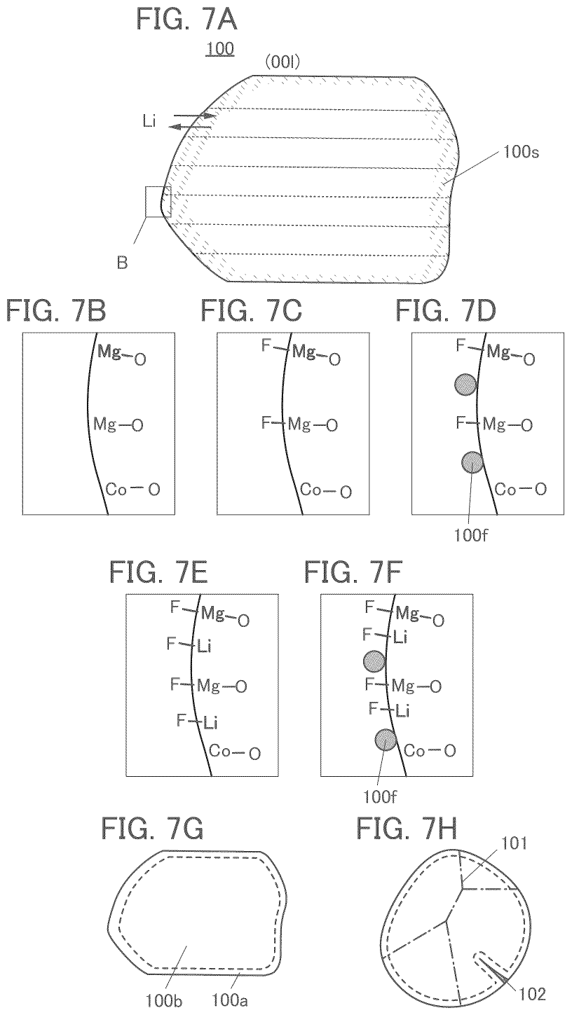

Next, the positive electrode active material 100 of one embodiment of the present invention is described with reference to FIGS. 7A to 7H. As the positive electrode active material 100, a compound which contains a transition metal and oxygen and into and from which carrier ions, typically lithium ions (Lit), can be inserted and extracted is used. As the transition metal, one or more selected from cobalt (Co), nickel (Ni), manganese (Mn), iron (Fe), and the like can be used.

### <Main Component>

It is preferable that the positive electrode active material 100 of one embodiment of the present invention contain cobalt as the main component of the transition metals M taking part in an oxidation-reduction reaction. In this specification and the like, the main component of the transition metals M refers to the component having the highest atomic ratio among the transition metals M For example, as a compound in which the transition metal is Co, lithium cobalt oxide can be used for the positive electrode active material 100. The positive electrode active material 100 preferably contains lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

The positive electrode active material 100 preferably contains nickel in addition to cobalt. Lithium cobalt nickel oxide can be used as the positive electrode active material 100. The positive electrode active material 100 preferably contains lithium cobalt nickel oxide (LiCo_{1-y}Ni_{y}O₂) to which an additive element is added. Note that the positive electrode active material 100 of one embodiment of the present invention has a crystal structure described later, and thus the composition of the lithium cobalt nickel oxide is not strictly limited to Li:(Co+Ni):O=1:1:2.

In lithium cobalt nickel oxide, the proportion of nickel in the sum of cobalt and nickel, Ni/(Co+Ni), or in other words, y in LiCo_{1-y}Ni_{y}O₂, is preferably greater than 0 and less than 0.5, further preferably greater than or equal to 0.1 and less than or equal to 0.3, still further preferably greater than 0.025 and less than or equal to 0.215.

When y in LiCo_{1-y}Ni_{y}O₂ is greater than or equal to 0.1 and less than or equal to 0.3, for example, Co:Ni may be 90:10 (atomic ratio), 80:20 (atomic ratio), or 70:30 (atomic ratio).

The positive electrode active material 100 preferably has high crystallinity. The positive electrode active material 100 is preferably a single-particle (also referred to as a primary particle) rather than a secondary particle. A particle of the positive electrode active material 100 is further preferably a single crystal.

The positive electrode active material 100 of one embodiment of the present invention preferably includes a region having an insulating property or a region having high resistance. Note that the region is sometimes referred to as a first region to be distinguished from other regions. It is preferable that the above region be thin and extend, for example, greater than or equal to 1 nm and less than or equal to 20 nm, further preferably greater than or equal to 2 nm and less than or equal to 10 nm, still further preferably greater than or equal to 2 nm and less than or equal to 5 nm in a cross-sectional view of the positive electrode active material 100; these values can each be regarded as the thickness or width of the first region in the cross-sectional view. This thin region is sometimes referred to as a “shell” in this specification and the like. As the cross-sectional view, a cross-sectional scanning transmission electron microscope (STEM) image can be used, for example. FIG. 7A shows the positive electrode active material 100 that includes a shell 100s.

The shell 100s is preferably included in a later-described surface portion 100a (see FIG. 7G) of the positive electrode active material 100. The positive electrode active material 100 preferably includes the shell 100s, in which case the speed of a current flowing into the positive electrode active material 100 in the nail penetration test can be low, inhibiting ignition, smoking, or the like. In order that the speed of a current flowing into the positive electrode active material 100 can be low, in the surface portion of the positive electrode active material 100, the shell is preferably positioned on an outer side or a surface side.

### <Additive Element>

The positive electrode active material 100 preferably contains an additive element. Examples of the additive element include magnesium (Mg), fluorine (F), nickel (Ni), aluminum (Al), titanium (Ti), zirconium (Zr), vanadium (V), iron (Fe), manganese (Mn), chromium (Cr), niobium (Nb), arsenic (As), zinc (Zn), silicon (Si), sulfur (S), phosphorus (P), boron (B), bromine (Br), and beryllium (Be).

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material 100 is substantially free from manganese, for example, advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

Magnesium is one of the elements suitable for the shell 100s. Thus, magnesium is preferably present within a thin region extending greater than or equal to 1 nm and less than or equal to 20 nm, further preferably greater than or equal to 2 nm and less than or equal to 10 nm, still further preferably greater than or equal to 2 nm and less than or equal to 5 nm from the surface in a cross-sectional view of the positive electrode active material 100.

In the case where magnesium is added to the positive electrode active material 100, magnesium fluoride can be suitably used as a magnesium source. When magnesium fluoride is used, fluorine can also be added to the positive electrode active material 100. Furthermore, a reaction between lithium and fluorine, which sometimes occurs at the time of the nail penetration test or the like in a secondary battery that includes the positive electrode active material 100, generates less heat than a reaction between lithium and oxygen. Accordingly, the positive electrode active material 100 preferably contains fluorine as the additive element. Moreover, the reaction between fluorine and lithium is presumed to occur upon an increase in the voltage of the secondary battery during the nail penetration test, meaning that fluorine is effective in terms of the safety of the secondary battery.

In the case where LCO is applied to the positive electrode active material 100 of one embodiment of the present invention, nickel and magnesium are preferably contained as the additive elements. For example, it is preferable that a region containing magnesium and a region containing nickel overlap with each other or be connected to each other on a plane where lithium can be inserted and extracted, i.e., the edge plane. In other words, it is preferable that nickel also be present in the shell. This structure makes it possible to inhibit release of oxygen from the positive electrode active material or a structural change of the positive electrode active material.

The above-described additive element may be in the shell 100s or the later-described surface portion 100a (see FIG. 7G). The additive element contributing to the stability of the crystal structure of the positive electrode active material 100 preferably exists in the surface portion 100a, in which degradation is likely to start.

Here, the resistivity of the powder to be the positive electrode active material (referred to as powder resistivity) is preferably measured to check whether the shell 100s is formed in the positive electrode active material 100. Specifically, the shell 100s is presumed to be formed in the positive electrode active material 100 when the powder resistivity of the positive electrode active material containing the additive element has a larger value than the powder resistivity of the positive electrode active material devoid of the additive element.

The shell 100s preferably contains cobalt and the additive element. When at least the shell 100s contains cobalt, the speed at which a current flows owing to an internal short circuit can be low while insertion and extraction of lithium ions (Lit) are allowed. The surface portion 100a (see FIG. 7G), which is described later, also preferably contains cobalt and the additive element.

The shell 100s described above may be provided to sufficiently cover the whole of the positive electrode active material 100 or to have a large thickness in a specific region of the positive electrode active material 100, e.g., on a plane other than the (001) plane, as shown in FIG. 7A. Oxygen release is inhibited at the position where the shell is provided, e.g., on a plane other than the (001) plane, to improve thermal stability and inhibit thermal runaway. The later-described surface portion 100a (see FIG. 7G), in which the additive element exists, may be thick in a specific region. For example, the surface portion 100a preferably has a large thickness on a plane where degradation is likely to start, i.e., a plane other than the (001) plane.

Note that the shell 100s may be at any position of the positive electrode active material 100 as long as the shell 100s can prevent ignition in the nail penetration test. Magnesium may be present in a portion other than the shell or, for example, in the whole surface portion as long as magnesium makes it possible that the speed at which a current flows owing to an internal short circuit is low while insertion and extraction of lithium ions (Li⁺) are allowed.

The concentration of the additive element is discussed. For example, the concentration of magnesium that is the additive element is preferably higher than 0 atomic % and lower than or equal to 10 atomic %, further preferably higher than 0 atomic % and lower than or equal to 5 atomic %, still further preferably higher than 0 atomic % and lower than or equal to 2 atomic % in the shell 100s of lithium cobalt oxide. The above magnesium concentration can be specified by line analysis by energy dispersive X-ray spectroscopy (EDX), for example. Magnesium existing at a high concentration in the whole surface portion would enhance the insulating property, making it difficult to achieve favorable battery characteristics in a charge and discharge cycle test or the like. By contrast, magnesium existing at an appropriate concentration in the surface portion, particularly an appropriate region such as the shell, is preferred because of being able to stabilize the lithium cobalt oxide and inhibit heat generation and smoking in the above-described nail penetration test or the like. In addition, magnesium existing at an appropriate concentration in the shell 100s is expected to increase the hardness of the lithium cobalt oxide.

FIGS. 7B to 7F are enlarged conceptual diagrams of a region B, which is denoted with a rectangle in FIG. 7A. Here, LCO containing Mg is described as an example of the positive electrode active material 100. As shown in FIG. 7B, Mg as an example of the additive element is preferably bonded to oxygen in the shell. Furthermore, the shell preferably contains Co and the Co is preferably bonded to oxygen. It is presumed that the shell shown in FIG. 7B makes it possible that the speed at which a current flows owing to an internal short circuit is low while insertion and extraction of lithium ions (Li⁺) are allowed.

Next, LCO containing Mg and F is described as an example of the positive electrode active material 100. As shown in FIG. 7C, F as an example of the additive element does not necessarily exist in the shell and is preferably adsorbed onto the surface of the positive electrode active material 100. Fluorine is known to have high electronegativity and easily form a stable compound together with any of many elements. Inside the battery, the positive electrode active material 100 is immersed in the electrolyte solution; thus, fluorine adsorbed onto the surface of the positive electrode active material 100 can react with the electrolyte solution near the fluorine, for example, which would inhibit thermal decomposition of the electrolyte solution or the like if an internal short circuit occurs.

As shown in FIG. 7D, a fluorine compound 100f may be adsorbed onto the surface of the positive electrode active material 100 that is the Mg— and F— containing LCO. Fluorine is known to have high electronegativity and easily form a stable compound together with any of many elements. The positive electrode active material 100 is immersed in the electrolyte solution; thus, the fluorine compound 100f adsorbed onto the surface of the positive electrode active material 100 can react with the electrolyte solution near the fluorine compound 100f, for example, which would inhibit thermal decomposition of the electrolyte solution or the like if an internal short circuit occurs.

The above adsorption may be chemical adsorption or physical adsorption. Chemical adsorption refers to formation of a chemical bond due to a chemical reaction between at least one of the additive elements and the surface of the positive electrode active material 100, whereas physical adsorption refers to adsorption due to intermolecular force (van der Waals force) exerted between at least one of the additive elements and the surface of the positive electrode active material 100.

Although not shown, the positive electrode active material 100 may contain fluorine forming a solid solution; for example, fluorine may be substituted for some oxygen atoms of the lithium cobalt oxide. Fluorine forming a solid solution exists in the surface portion of the lithium cobalt oxide and may exist in the shell. When the positive electrode active material 100 contains sufficient fluorine, there are both fluorine adsorbed onto the surface and fluorine substituted for some oxygen atoms.

FIGS. 7E and 7F are respectively modification examples of the conceptual diagrams in FIGS. 7C and 7D and show examples in each of which at least some of the F atoms adsorbed onto the surface of the positive electrode active material 100 are bonded to lithium (Li) existing in the shell. Since fluorine has higher electronegativity than oxygen, lithium and fluorine are bonded to each other more easily than lithium and oxygen. Bonding of fluorine to lithium can inhibit the lithium from being bonded to oxygen. In other words, combustion of lithium can be inhibited. Accordingly, adsorption of fluorine onto the surface of the positive electrode active material 100 can inhibit, for example, the secondary battery that includes the positive electrode active material 100 from igniting and smoking. For example, the adsorption of fluorine would inhibit the secondary battery that includes the positive electrode active material 100 from igniting and smoking if an internal short circuit occurs in the secondary battery. For another example, the adsorption of fluorine would inhibit the secondary battery that includes the positive electrode active material 100 from igniting and smoking if the secondary battery undergoes the nail penetration test.

The bonding of fluorine to lithium can inhibit the lithium from moving. Thus, this bonding would make the speed of a current flowing into the positive electrode active material 100 low and inhibit ignition, smoking, and the like if an internal short circuit occurs in the secondary battery that includes the positive electrode active material 100, for example. For another example, the bonding would make the speed of a current flowing into the positive electrode active material 100 low and inhibit ignition, smoking, and the like if the secondary battery that includes the positive electrode active material 100 undergoes the nail penetration test.

As described later, examples of a fluoride used in a lithium-ion secondary battery include LiPF₆ and LiBF₄ as lithium salts and poly(vinylidene fluoride) (PVDF) as a binder. Fluorine originating from such a fluoride may be adsorbed onto the surface of the positive electrode active material 100.

Examples of the positive electrode active material are shown in FIGS. 7G and 7H, where the dashed lines indicate the boundary between the surface portion 100a and an inner portion 100b. In this manner, the surface portion 100a is distinguished from the shell, and the surface portion 100a includes the surface. As already described above, the surface portion 100a includes the shell.

FIG. 7H shows an example of the positive electrode active material in FIG. 7G to which a crystal grain boundary 101 indicated by the dashed-dotted line is added. FIG. 7H shows a crack that is formed at part of the surface of the positive electrode active material and a filling portion 102 that is in contact with the part of the surface. The filling portion 102 preferably contains the additive element such as magnesium.

### <Surface of Positive Electrode Active Material>

The surface of the positive electrode active material 100 refers to the surface of a composite oxide that includes the surface portion 100a and the inner portion 100b. Such a surface can be observed in a cross section. Thus, the surface of the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material 100. The attached metal oxide refers to, for example, a metal oxide having a crystal structure different from that of the inner portion 100b.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, the position of the surface of the positive electrode active material in, for example, STEM-EDX line analysis refers to a point where the detected amount of the characteristic X-ray of the transition metal M is equal to 50% of the sum of the average value M_{AVE}, of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal M in the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE}, of the detected amounts of the characteristic X-ray of the transition metal M in the inner portion and the average value M_{BG} of the detected amounts of the characteristic X-ray of the transition metal M of the background can be employed as the position of the surface of the positive electrode active material. In the case of a positive electrode active material containing a plurality of the transition metals M, its surface can be determined using M_{AVE}, and M_{BG} of the element whose detected amount of the characteristic X-ray in the inner portion is larger than that of any other element.

The average value M_{BG} of the detected amounts of the characteristic X-ray of the transition metal M of the background can be calculated by averaging the detected amounts in the range greater than or equal to 2 nm, preferably greater than or equal to 3 nm, which is outside a portion in the vicinity of the portion at which the detected amount of the characteristic X-ray of the transition metal M begins to increase, for example. The average value M_{AVE} of the detected amounts of the characteristic X-ray of the transition metal Min the inner portion can be calculated by averaging the detected amounts in the range greater than or equal to 2 nm, preferably greater than or equal to 3 nm at the depth at which the detected amounts of the characteristic X-ray of the transition metal M and oxygen are saturated and stabilized, e.g., at a depth larger than, by greater than or equal to 30 nm, preferably greater than 50 nm, the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image.

The spatial resolution of STEM-EDX is approximately 1 nm. Thus, the peak position (also referred to as a local maximum value) of the characteristic X-ray corresponding to the additive element may be shifted by approximately 1 nm. For example, even when the peak position of the characteristic X-ray corresponding to the additive element such as magnesium is outside the surface determined in the above-described manner, it can be said that a difference between the peak and the surface is within the margin of error when the difference is less than 1 nm.

A peak in STEM-EDX line analysis refers to a local maximum value or the maximum value of the characteristic X-ray corresponding to each element. As an example of a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used to make the graph of the characteristic X-ray of each element. The number of times of scanning is not limited to six and an average of measured values obtained by performing scanning seven or more times can be used to make the graph of the characteristic X-ray of each element.

STEM-EDX line analysis can be performed as follows, for example. First, a protective film is deposited by evaporation over the surface of a positive electrode active material. For example, carbon can be deposited by evaporation with a carbon coating unit of an ion sputtering apparatus (MC1000, produced by Hitachi High-Tech Corporation).

Next, the positive electrode active material is thinned to fabricate a cross-section sample to be subjected to STEM-EDX line analysis. For example, the positive electrode active material can be thinned with an FIB-SEM apparatus (XVision 200TBS, produced by Hitachi High-Tech Corporation). Here, picking up can be performed by a micro probing system (MPS), and the acceleration voltage at final processing can be, for example, 10 kV.

The STEM-EDX line analysis can be performed using, for example, HD-2700 produced by Hitachi High-Tech Corporation as a STEM apparatus and Octane T Ultra W (Dual EDS) produced by EDAX Inc as an EDX detector. In the EDX line analysis, the acceleration voltage of the STEM apparatus is set to 200 kV and the emission current is set to be in the range of 6 μA to 10 μA, and a portion of the thinned sample, which is not positioned at a deep level and has little unevenness, is measured. The magnification is approximately 150,000 times, for example. The EDX line analysis can be performed under conditions where the beam diameter is 0.2 nm ϕ, drift correction is performed, the line width is 42 nm, the pitch is 0.2 nm, and the number of frames is 6 or more.

The crystal grain boundary 101 refers to, for example, a portion where particles of the positive electrode active material 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM image, a cross-sectional STEM image, or the like, i.e., a structure including another atom between lattices, a cavity, or the like. The crystal grain boundary 101 can be regarded as a plane defect. The vicinity of the crystal grain boundary 101 refers to a region extending less than or equal to 10 nm from the crystal grain boundary 101.

### <Continuous Change in Crystal Structure>

It is preferable that the crystal structure continuously change from the inner portion 100b toward the surface owing to the above-described concentration gradient of the additive element. Alternatively, it is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the orientations of a crystal in the surface portion 100a that has the feature of a rock-salt crystal structure or the features of both a rock-salt crystal structure and a layered rock-salt crystal structure and a crystal in the layered rock-salt inner portion 100b are preferably substantially aligned with each other.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure such as a crystal structure belonging to the space group Fm-3m is included and cations and anions are alternately arranged. Note that a cation or anion vacancy may exist.

Having features of both a layered rock-salt crystal structure and a rock-salt crystal structure can be judged by electron diffraction, a TEM image, a cross-sectional STEM image, and the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The orientations of crystals in two regions being substantially aligned with each other can be judged, for example, from a TEM image, a STEM image, a high-angle annular dark field STEM (HAADF-STEM) image, an annular bright-field STEM (ABF-STEM) image, an electron diffraction pattern, and an FFT pattern of a TEM image, a STEM image, or the like. XRD, electron diffraction, neutron diffraction, and the like can also be used for judging.

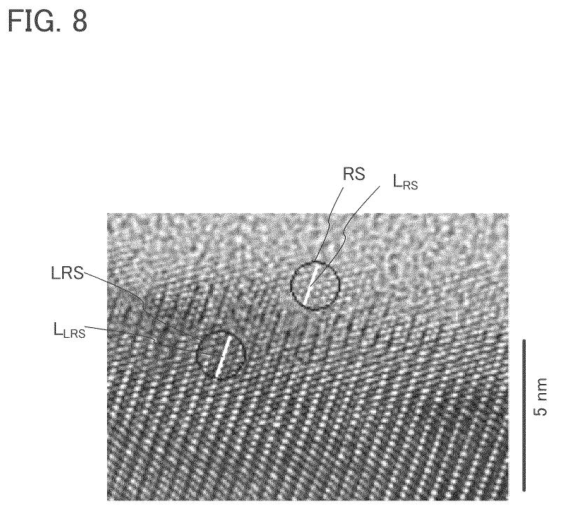

FIG. 8 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 8) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots in the direction perpendicular to the c-axis, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

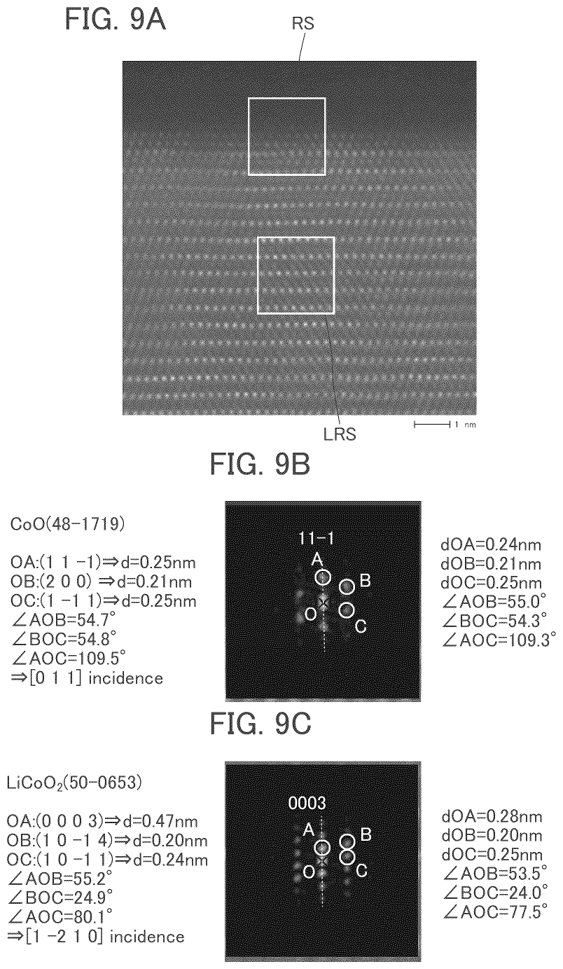

FIG. 9A shows an example of a STEM image in which orientations of the layered rock-salt crystal L_{RS} and the rock-salt crystal RS are substantially aligned with each other. FIG. 9B shows an FFT pattern of a region of the rock-salt crystal RS, and FIG. 9C shows an FFT pattern of a region of the layered rock-salt crystal L_{RS}. In FIG. 9B and FIG. 9C, the composition, the JCPDS card number, and d values and angles calculated from the JCPDS card data are shown on the left. The measured values are shown on the right. A spot denoted by O is zero-order diffraction.

A spot denoted by A in FIG. 9B is derived from 11-1 reflection of a cubic structure. A spot denoted by A in FIG. 9C is derived from 0003 reflection of a layered rock-salt crystal structure. It is found from FIG. 9B and FIG. 9C that the direction of the 11-1 reflection of the cubic structure and the direction of the 0003 reflection of the layered rock-salt crystal structure are substantially aligned with each other. That is, a straight line that passes through AO in FIG. 9B is substantially parallel to a straight line that passes through AO in FIG. 9C. Here, the terms “substantially aligned” and “substantially parallel” mean that the angle between the above straight lines is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferred that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 9C is derived from 1014 reflection of the layered rock-salt crystal structure. This is sometimes observed at a position where the difference in orientation from the reciprocal lattice point derived from the 0003 reflection of the layered rock-salt crystal structure (A in FIG. 9C) is greater than or equal to 52° and less than or equal to 56° (i.e., <AOB is 52° to 56°) and d is greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 9B is derived from 200 reflection of the cubic structure. This diffraction spot is sometimes observed at a position where the difference in orientation from the reciprocal lattice point derived from the 11-1 reflection of the cubic structure (A in FIG. 9B) is greater than or equal to 54° and less than or equal to 56° (i.e., <AOB is greater than or equal to 54° and less than or equal to 56°). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to appear as crystal planes. Thus, to observe the (0003) plane with a TEM or the like, for example, a positive electrode active material particle in which a crystal plane that is presumably the (0003) plane is observed with a SEM is preferably selected first; then, the positive electrode active material particle is preferably processed to be thin using a focused ion beam (FIB) or the like such that the (0003) plane can be observed with the TEM or the like with an electron beam thereof entering in [12-10]. To judge alignment of crystal orientations, a sample is preferably processed to be thin so that the (0003) plane of the layered rock-salt crystal structure is easily observed.

### <Crystal Structure>

The crystal structure of the positive electrode active material 100 of one embodiment of the present invention is described, being compared with that of a conventional positive electrode active material.

<<x in LiₓMO₂ is 1>>

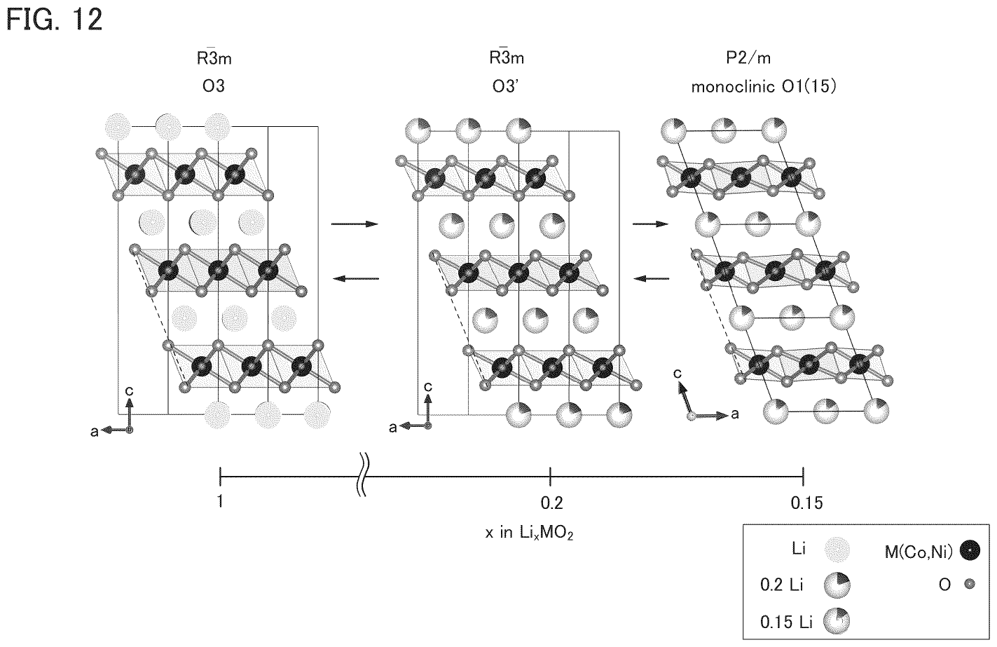

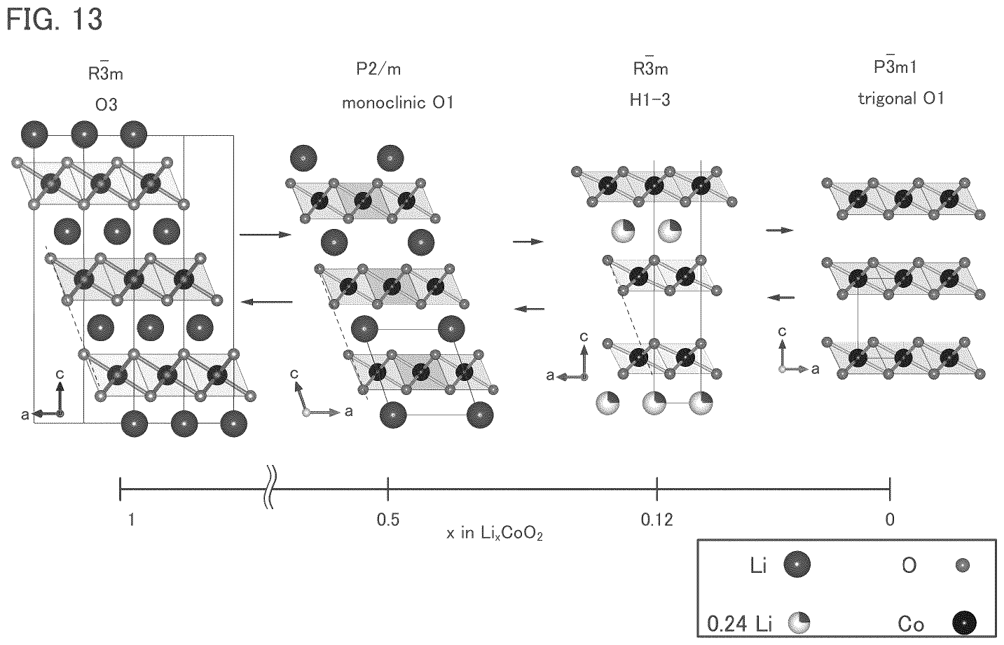

FIG. 12 shows crystal structures of the positive electrode active material 100 of one embodiment of the present invention. The positive electrode active material 100 of one embodiment of the present invention preferably has a layered rock-salt crystal structure belonging to the space group R-3m in a discharged state, i.e., a state where x in LiₓMO₂ (M is a transition metal or specifically, cobalt and/or nickel) is 1. A composite oxide having a layered rock-salt crystal structure is favorably used as a positive electrode active material of a secondary battery because it has high discharge capacity and a two-dimensional diffusion path for lithium ions and is thus suitable for insertion and extraction of lithium ions. For this reason, it is particularly preferable that the inner portion 100b, which accounts for the majority of the volume of the positive electrode active material 100, have a layered rock-salt crystal structure. In FIG. 13, the layered rock-salt crystal structure is denoted by R-3m O3. In the R-3m O3 type structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 10). In FIG. 13, “O3” is below the name of the space group. This crystal structure, in which lithium occupies octahedral sites and a unit cell includes three MO₂ layers, is sometimes referred to as an O3 type structure. Note that the MO₂ layer has a structure in which an octahedral structure with the transition metal M coordinated to six oxygen atoms continues on a plane in an edge-shared state. Such a layer is sometimes referred to as a layer formed of octahedrons of the transition metal M and oxygen. Although lithium ions are at all the lithium sites in FIG. 13, an ion of the additive element, e.g., a magnesium ion, may be positioned at a lithium site as described above.

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibiting release of oxygen, a structural change of the surface portion 100a and the inner portion 100b of the positive electrode active material 100 such as a shift in the layered structure formed of octahedrons of the transition metal M and oxygen, and/or decomposition of an organic electrolyte solution or the like on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. For example, it is presumable that a shift in the crystal structure of the layered structure formed of octahedrons of the transition metal M and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, if the surface portion 100a can have sufficient stability, the layered structure, which is formed of octahedrons of the transition metal M and oxygen, of the inner portion 100b is difficult to break even when x in LiₓCoO₂ is small, e.g., 0.24 or less. Furthermore, a shift in layers, which are formed of octahedrons of the transition metal M and oxygen, of the inner portion 100b can be inhibited.

In the inner portion 100b of the positive electrode active material 100, the density of defects such as dislocation is preferably low. In the positive electrode active material 100, the crystallite size measured by XRD is preferably large. In other words, the inner portion 100b preferably has high crystallinity. Furthermore, the positive electrode active material 100 preferably has a smooth surface. These features are important factors for assuring the reliability of the positive electrode active material 100 in a secondary battery. A secondary battery can have a high upper limit of a charge voltage when including a highly reliable positive electrode active material and thereby can have high charge and discharge capacity.

Dislocation in the inner portion 100b can be observed with a TEM, for example. Defects such as dislocation are sometimes not observed in a specific 1-μm² region of an observation sample in the case where the density of defects such as dislocation is sufficiently low. Note that dislocation is a kind of crystal defect and is different from a point defect.

The crystallite size measured by XRD is preferably larger than or equal to 300 nm, for example. The larger the crystallite size is, the more easily the O3′ type structure is maintained and contraction of the c-axis length is inhibited in the state where x in LiₓCoO₂ is small as described later.

It is presumed that the crystallite size measured by XRD is larger when less defects such as dislocation are observed with a TEM.

To obtain an XRD pattern for calculation of a crystallite size, a positive electrode that includes a positive electrode active material, a current collector, a binder, a conductive material, and the like may be subjected to XRD, although it is preferable that only the positive electrode active material be subjected to XRD. Note that the positive electrode active material particles present in the positive electrode might be oriented such that the crystal planes of the positive electrode active material particles are oriented in the same direction owing to, for example, pressure application in a formation process. When many of the positive electrode active material particles are oriented in the above manner, the crystallite size might fail to be calculated accurately; thus, it is preferable that to obtain an XRD pattern, a positive electrode active material layer be removed from the positive electrode, the binder and the like in the positive electrode active material layer be eliminated to some extent using a solvent or the like, and a sample holder be filled with the resultant positive electrode active material, for example. Alternatively, a powder sample of the positive electrode active material or the like may be attached onto a reflection-free silicon plate to which grease is applied, for example.

The crystallite size can be calculated using ICSD coll. code. 172909 as literature data of lithium cobalt oxide and a diffraction pattern that is obtained with Bruker D8 ADVANCE, for example, under the following conditions: CuKα is used as an X-ray, the range is from 15° to 90°, an increment is 0.005, and a detector is LYNXEYE XE-T. Analysis can be conducted using DIFFRAC.TOPAS ver. 6 as crystal structure analysis software, and exemplary settings are as follows.
Emission Profile: CuKα5.lam
Background: Chebychev polynomial of degree 5
Instrument
   Primary radius: 280 mm
   Secondary radius: 280 mm
   Linear PSD
      2Th angular range: 2.9
      FDS angle: 0.3
Full Axial Convolution
   Filament length: 12 mm
   Sample length: 15 mm
   Receiving Slit length: 12 mm
   Primary Sollers: 2.5
   Secondary Sollers: 2.5
Corrections
   Specimen displacement: Refine
   LP Factor: 0

A value of LVol-IB, which is a crystallite size calculated by the above method, is preferably employed as a crystallite size. Note that in a sample whose preferred orientation is calculated to be less than 0.8, too many particles are oriented in the same direction; thus, this sample is not suitable for calculation of a crystallite size in some cases.

### [Distribution]

The distribution of the additive element in the positive electrode active material 100 in a discharged state is described as an example. To obtain a stable composition and a stable crystal structure of the surface portion 100a, the surface portion 100a preferably contains the additive element, further preferably a plurality of the additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is preferable that peaks of detected amounts of the additive elements be exhibited at different depths from the surface. The peak of the detected amount here refers to a local maximum value of the detected amount, and the peak of the detected amount in the surface portion 100a refers to the maximum value of the detected amount in the surface portion 100a or a region that extends less than or equal to 50 nm from the surface. The detected amount refers to counts in EDX line analysis.

The detected amount of magnesium among the additive elements is preferably larger in the surface portion 100a than in the inner portion 100b. A peak of the detected amount of magnesium is preferably observed in a region of the surface portion 100a that is closer to the surface.

As in the case of magnesium, the detected amount of fluorine among the additive elements is preferably larger in the surface portion 100a than in the inner portion 100b. A peak of the detected amount of fluorine is preferably observed in a region of the surface portion 100a that is closer to the surface.

The detected amount of nickel among the additive elements is preferably larger in the surface portion 100a than in the inner portion 100b. A peak of the detected amount of nickel is preferably observed in a region of the surface portion 100a that is closer to the surface. For example, it is preferable that in the surface portion 100a, the detected amount of nickel in the shell be larger than that of nickel in a region located inward from the shell, and a peak of the detected amount of nickel be observed in the shell. Here, the ratio of the number of nickel (Ni) atoms to the number of cobalt (Co) atoms (Ni/Co) in the shell of the surface portion 100a is less than 1. That is, the number of nickel (Ni) atoms is smaller than that of cobalt (Co) atoms in the shell of the surface portion 100a. The ratio of the number of nickel (Ni) atoms to the number of cobalt (Co) atoms (Ni/Co) at a peak of the detected amount of nickel is less than 1. Furthermore, the ratio of the number of nickel (Ni) atoms to the number of cobalt (Co) atoms (Ni/Co) in the region located inward from the shell is less than the ratio of the number of nickel (Ni) atoms to the number of cobalt (Co) atoms (Ni/Co) in the shell. Note that the detected amount of nickel in the inner portion 100b is sometimes much smaller than that of nickel in the surface portion 100a. As described above, the number of nickel (Ni) atoms is smaller than that of cobalt (Co) atoms in each of the surface portion 100a and the inner portion 100b. The number of nickel (Ni) atoms is smaller than that of cobalt (Co) atoms in the positive electrode active material 100.

In the case where the positive electrode active material 100 contains both magnesium and nickel, the distribution of magnesium and that of nickel preferably overlap with each other. Note that in this specification and the like, the expression “the distribution of Element A and that of Element B overlap with each other” means that a peak of the detected amount of Element A and that of the detected amount of Element B are at the same depth irrespective of whether the whole peaks overlap with each other. For example, the peak of the detected amount of Element A may be closer to the surface, or the peak of the detected amount of Element B may be closer to the surface. Note that it is preferable that the difference between the depth of the peak of the detected amount of Element A and that of the peak of the detected amount of Element B be less than or equal to 3 nm. Specifically, the expression “the distribution of magnesium and that of nickel overlap with each other” means that a peak of the detected amount of magnesium and that of the detected amount of nickel are at the same depth irrespective of whether the whole peaks overlap with each other. For example, the peak of the detected amount of magnesium may be closer to the surface, or the peak of the detected amount of nickel may be closer to the surface. Note that it is preferable that the difference between the depth of the peak of the detected amount of magnesium and that of the peak of the detected amount of nickel be less than or equal to 3 nm.

The detected amount of titanium among the additive elements is also preferably larger in the surface portion 100a than in the inner portion 100b. A peak of the detected amount of titanium is preferably observed in a region of the surface portion 100a that is closer to the surface.

The detected amount(s) of silicon, phosphorus, boron, and/or calcium among the additive elements are/is also preferably larger in the surface portion 100a than in the inner portion 100b. A peak(s) of the detected amount(s) of silicon, phosphorus, boron, and/or calcium are/is preferably observed in a region of the surface portion 100a that is closer to the surface.

A peak of the detected amount of aluminum among the additive elements is preferably observed in a region that is located inward from a region in which a peak of the detected amount of magnesium is observed. The distribution of magnesium and that of aluminum may overlap with each other; alternatively, there may be almost no overlap between the distribution of magnesium and that of aluminum. A peak of the detected amount of aluminum may be observed in the surface portion 100a or a region at a larger depth than the surface portion 100a. For example, the peak is preferably observed in a region extending, toward the inner portion, from a depth from the surface of 5 nm to a depth from the surface of 30 nm.

The distribution of aluminum is not normal distribution in some cases. For example, when the curve of the distribution of aluminum is divided by the maximum value Max_{A1}, the length of the tail on the surface side is sometimes different from that of the tail on the inner portion side. When the peak width at the height (⅕ Max_{A1}) that is ⅕ of the height of the maximum value (Max_{A1}) of the detected amount of aluminum is divided into two parts by a perpendicular extending from the maximum value to the horizontal axis, the peak width (W_{c}) on the inner portion side is sometimes larger than the peak width (Wₛ) on the surface side.

Aluminum is distributed more inwardly than magnesium as described above probably because aluminum diffuses more easily than magnesium. The detected amount of aluminum is small in the region that is the closest to the surface, by contrast, presumably because aluminum is less stable in a region where magnesium or the like at a high concentration forms a solid solution than in other regions.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance between a cation and oxygen in LiAlO₂ having a layered rock-salt crystal structure, and aluminum is thus likely to be unstable. In the vicinity of cobalt, valence change due to substitution of Mg²⁺ for Li⁺ can be compensated for by Co³⁺ becoming Co²⁺, so that cation balance can be maintained. By contrast, A1 is always trivalent and is thus presumed to be unlikely to coexist with magnesium in a rock-salt or layered rock-salt crystal structure.

As in the case of aluminum, a peak of the detected amount of manganese among the additive elements is preferably observed in a region that is located inward from a region in which a peak of the detected amount of magnesium is observed.

Note that the additive elements do not necessarily have similar concentration gradients and similar distributions throughout the surface portion 100a of the positive electrode active material 100.

The distribution of the additive element at a surface of the positive electrode active material 100 having the (001) orientation may be different from that at other surfaces. For example, the detected amount(s) of one or more of the additive elements may be smaller at the surface having the (001) orientation and the surface portion 100a thereof than at a surface having an orientation other than the (001) orientation. Specifically, the detected amount of nickel may be smaller. Especially in the case of EDX or any other analysis method in which characteristic X-rays are detected, the energy of Kβ for cobalt is close to that of Kα for nickel and it is thus difficult to detect a slight amount of nickel in a material whose main element is cobalt. Alternatively, the peak(s) of the detected amount(s) of one or more of the additive elements at the surface having the (001) orientation and the surface portion 100a thereof may be positioned shallower than the peak(s) of the detected amount(s) of the one or more of the additive elements at the surface having an orientation other than the (001) orientation. Specifically, the peaks of the detected amounts of magnesium and aluminum at the surface having the (001) orientation and the surface portion 100a thereof may be positioned shallower than the peaks of the detected amounts of magnesium and aluminum at the surface having an orientation other than the (001) orientation.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus preferable to reinforce the surface having an orientation other than the (001) orientation and the surface portion 100a thereof so that the crystal structure of the whole positive electrode active material 100 is maintained.

Accordingly, in the positive electrode active material 100 of another embodiment of the present invention, attention is sometimes focused on the concentration distribution of the additive element at the surface having an orientation other than the (001) orientation and the surface portion 100a thereof. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface not having the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface not having the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method described in the following embodiment, in which mixing of the additive element is followed by heating, the additive element sometimes spreads mainly via a diffusion path of lithium ions. Thus, formation of high-purity lithium cobalt oxide preferably precedes the mixing of the additive element in order that the distribution of the additive element at the surface having an orientation other than the (001) orientation and the surface portion 100a thereof can fall within a preferred range.

### [Magnesium]

Magnesium is divalent and aluminum or nickel as the additive element is stable at cobalt sites in a layered rock-salt crystal structure; thus, magnesium ions are likely to be at lithium sites, not cobalt sites, i.e., magnesium ions are likely to enter lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Moreover, magnesium can inhibit release of oxygen therearound and thermal decomposition in a state where x in LiₓCoO₂ is, for example, 0.24 or less. Magnesium is also expected to increase the density of the positive electrode active material 100. In addition, a high magnesium concentration in the surface portion 100a probably increases the corrosion resistance to hydrofluoric acid generated by the decomposition of the organic electrolyte solution or the like.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which does not enter the lithium site or the cobalt site might be unevenly distributed at the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

### [Fluorine]

When fluorine as a monovalent anion is adsorbed onto the surface of the positive electrode active material 100, the energy required for lithium extraction from the positive electrode active material 100 is lowered. As long as this energy is lowered, fluorine may be substituted for some oxygen atoms of the surface portion 100a. This is because the oxidation-reduction potential of cobalt ions associated with lithium extraction differs depending on whether fluorine exists. That is, when fluorine is not included, cobalt ions change from a trivalent state to a tetravalent state owing to lithium extraction.

Meanwhile, when fluorine is included, cobalt ions change from a divalent state to a trivalent state owing to lithium extraction. The oxidation-reduction potential of cobalt ions differs in these cases. Accordingly, smooth extraction and insertion of lithium ions easily occur in the vicinity of fluorine. It is thus preferable that fluorine be contained at the surface or surface portion of the positive electrode active material 100. A secondary battery that includes the positive electrode active material 100 containing fluorine can have improved charge and discharge characteristics, improved large current characteristics, or the like. When fluorine exists at the surface or surface portion, which is to be in contact with an electrolyte solution, or when a fluoride is adsorbed onto or attached to the surface, an overreaction between the positive electrode active material 100 and the electrolyte solution can be inhibited. In addition, the corrosion resistance to hydrofluoric acid can be effectively increased.

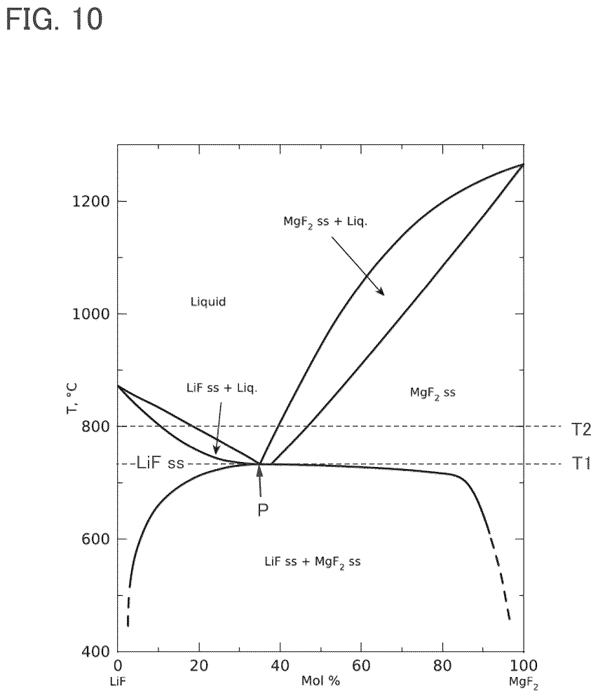

A fluorine compound (also referred to as a fluoride) such as lithium fluoride that has a lower melting point than a different additive element source can serve as a fusing agent (also referred to as a flux) for lowering the melting point of the different additive element source. In a fluorine compound containing LiF and MgF₂, the eutectic point P of LiF and MgF₂ is around 742° C. (T1) as shown in FIG. 10 (which is cited from FIG. 5 of Non-Patent Document 12 and retouched); thus, the heating temperature in the heating step following the mixing of the additive element is preferably set higher than or equal to 742° C.

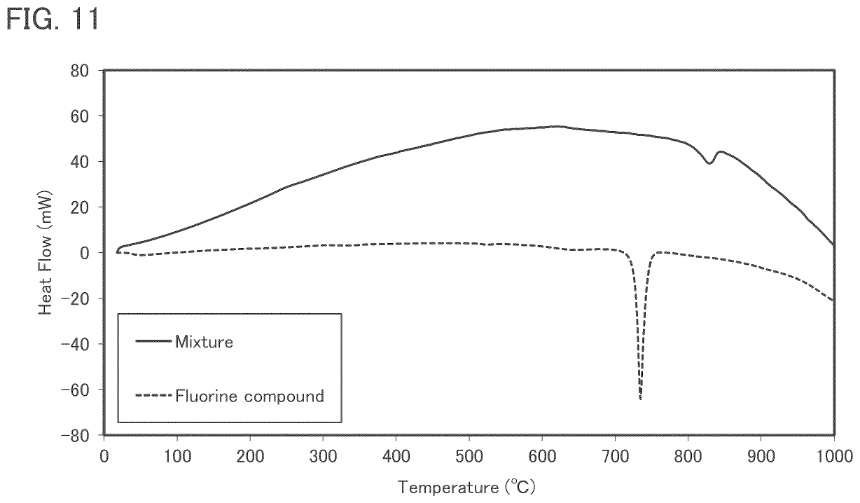

Here, a differential scanning calorimetry (DSC) test for a fluorine compound and a mixture is described with reference to FIG. 11. The mixture in FIG. 11 is obtained by mixing of lithium cobalt oxide as lithium oxide and a mixture of LiF and MgF₂ as a fluorine compound. Specifically, the mixture is obtained by mixing of lithium cobalt oxide, LiF, and MgF₂ to satisfy LiCoO₂:LiF:MgF₂=100:0.33:1 (molar ratio). The fluorine compound in FIG. 11 is a mixture of LiF and MgF₂. Specifically, the mixture is obtained by mixing of LiF and MgF₂ to satisfy LiF:MgF₂=1:3 (molar ratio). As shown in FIG. 11, the endothermic peak of the fluorine compound is observed at around 735° C. The endothermic peak of the mixture of lithium cobalt oxide, LiF, and MgF₂ is observed at around 830° C. Thus, the temperature of the heating following the mixing of the additive element is preferably higher than or equal to 742° C., further preferably higher than or equal to 830° C. Alternatively, the temperature of the heating may be higher than or equal to 800° C. (T2 in FIG. 10), which is between the above temperatures.

### [Nickel]

Nickel can exist at a cobalt site or a lithium site. Since nickel has a lower oxidation-reduction potential than cobalt, the presence of nickel at a cobalt site facilitates release of lithium during charging, for example. As a result, the charge and discharge speed is expected to be increased.

In addition, when nickel exists at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel at the lithium sites also serves as a column supporting the CoO₂ layers. Therefore, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO and CoO, and the orientations of NiO and LiCoO₂ are likely to be aligned with each other.

Ionization tendency is the lowest in nickel and higher in the order of cobalt, aluminum, and magnesium. Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is smaller than that of cobalt atoms, and is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can exist at a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to inhibit a change in the crystal structure. This would inhibit degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charging tolerance. Moreover, an Al—O bond is stronger than a Co—O bond and thus release of oxygen around aluminum can be inhibited. These effects improve thermal stability. Therefore, a secondary battery that includes the positive electrode active material 100 containing aluminum as the additive element can have higher stability. In addition, the positive electrode active material 100 having a crystal structure that is unlikely to be broken by repeated charging and discharging can be provided.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

An oxide of titanium is known to have superhydrophilicity. Accordingly, the positive electrode active material 100 that includes titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

The surface portion 100a preferably contains phosphorus, in which case a short circuit can be sometimes inhibited while a state with small x in LiₓCoO₂ is maintained. For example, a compound containing phosphorus and oxygen preferably exists in the surface portion 100a.

The positive electrode active material 100 preferably contains phosphorus, in which case phosphorus can react with hydrogen fluoride that is generated by the decomposition of the electrolyte solution or a lithium salt and the hydrogen fluoride concentration in the electrolyte solution can be reduced.

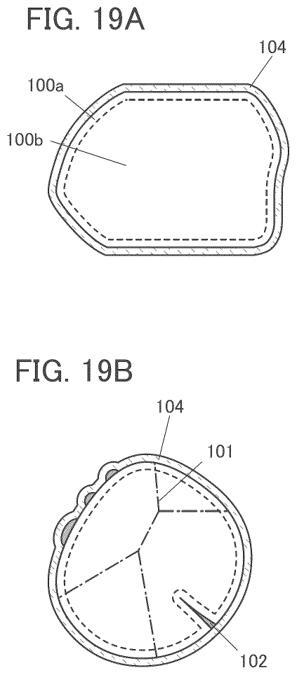

In the case where the lithium salt contains LiPF₆, hydrogen fluoride might be generated by hydrolysis. In addition, hydrogen fluoride might be generated by the reaction of poly(vinylidene fluoride) (PVDF) used as a component of the positive electrode and alkali. The decrease in hydrogen fluoride concentration in the organic electrolyte solution may inhibit corrosion of a current collector and/or separation of a coating portion 104 (see FIGS. 19A and 19B) or may inhibit a reduction in adhesion properties due to gelling and/or insolubilization of PVDF.

The positive electrode active material 100 preferably contains magnesium and phosphorus, in which case the crystal structure is extremely stable in a state with small x in LiₓCoO₂. When the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to % and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where a crack is formed at part of the surface of the positive electrode active material 100, crack development is sometimes inhibited by phosphorus (more specifically, a compound containing phosphorus and oxygen, or the like) that exists in the filling portion 102 in contact with the part of the surface (see FIG. 7H).

### [Synergistic Effect Between a Plurality of Elements]

When the surface portion 100a contains both magnesium and nickel, divalent nickel might be able to exist more stably in the vicinity of divalent magnesium. Thus, even when x in LiₓCoO₂ is small, dissolution of magnesium might be inhibited, which might contribute to stabilization of the surface portion 100a.

For a similar reason, when the additive element is added to lithium cobalt oxide in the formation process, magnesium is preferably added in a step before a step where nickel is added. Alternatively, magnesium and nickel are preferably added in the same step. The reason is as follows: magnesium has a large ion radius and thus is likely to remain in the surface portion of lithium cobalt oxide regardless of in which step magnesium is added, but nickel may be widely diffused to the inner portion of lithium cobalt oxide when magnesium does not exist. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure of a wider region can be stabilized. For example, the crystal structure can be stabilized in a wider region in the case where the positive electrode active material 100 contains all of magnesium, nickel, and aluminum, than in the case where magnesium and nickel are contained and the case where aluminum is contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region extending from a depth from the surface of 1 nm to a depth from the surface of 25 nm. Aluminum is preferably widely distributed in a region extending from a depth from the surface of 0 nm to a depth from the surface of 100 nm, further preferably a region extending from a depth from the surface of 0.5 nm to a depth from the surface of 50 nm, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, and also contain lithium in a discharged state to have the path through which lithium is inserted and extracted.

To ensure the sufficient path through which lithium is inserted and extracted, the concentration of cobalt is preferably higher than that of magnesium in the surface portion 100a. For example, when measurement by X-ray photoelectron spectroscopy (XPS) is performed from the surface of the positive electrode active material 100, the ratio of the number of magnesium (Mg) atoms to the number of cobalt (Co) atoms (Mg/Co) is preferably less than or equal to 0.62. In addition, the concentration of cobalt is preferably higher than those of nickel, aluminum, and fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist at the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of the transition metal M and oxygen can be inhibited in a manner similar to the above. Also in the case where both magnesium and nickel are contained, a synergistic effect of inhibiting dissolution of magnesium can be expected in a manner similar to the above.

<<x in LiₓMO₂ is Small>>

Since the positive electrode active material 100 of one embodiment of the present invention has the above-described additive element distribution and/or crystal structure, the positive electrode active material 100 is different from a conventional positive electrode active material in the crystal structure in a state where x in LiₓMO₂ is small, i.e., a high-voltage charged state. Here, “x is small” means 0.1<x≤0.24. A high voltage in a charged state means a voltage higher than or equal to 4.5 V, preferably higher than or equal to 4.6 V, further preferably higher than or equal to 4.8 V.

A conventional positive electrode active material and the positive electrode active material 100 of one embodiment of the present invention are compared, and changes in the crystal structures owing to a change in x in LiₓMO₂ will be described with reference to FIG. 12 and FIG. 13.

A change in the crystal structure of the conventional positive electrode active material is shown in FIG. 13. The conventional positive electrode active material shown in FIG. 13 is lithium cobalt oxide (LiCoO₂) containing no additive element. A change in the crystal structure of lithium cobalt oxide containing no additive element is described in Non-Patent Documents 1 to 3 and the like.

In FIG. 13, the crystal structure of the lithium cobalt oxide in a discharged state, i.e., with x in LiₓCoO₂ of 1, is denoted by R-3m O3. In the discharged state, the conventional lithium cobalt oxide has the same crystal structure as the positive electrode active material 100 of one embodiment of the present invention.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or, as indicated in the drawing, a monoclinic O1 type structure in some cases.

A positive electrode active material with x of 0 has the trigonal crystal structure belonging to the space group P-3m1 and includes one CoO₂ layer in a unit cell. Hence, this crystal structure is referred to as an O1 type structure or, as indicated in the drawing, a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure as indicated in the drawing. Note that since insertion and extraction of lithium do not necessarily uniformly occur in the positive electrode active material in reality, the lithium concentrations can vary in the positive electrode active material. Thus, the H1-3 type structure is started to be observed when x is approximately 0.25 in practice. The number of cobalt atoms per unit cell in the actual H1-3 type structure is twice that in other structures. However, in this specification including FIG. 13, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, Note that O1 and O2 are each an oxygen atom. A preferred unit cell for representing a crystal structure in a positive electrode active material can be selected by Rietveld analysis of XRD patterns, for example. For example, a unit cell such that the value of goodness of fit (GOF) is close to 1 is employed.

When charging making x in LiₓCoO₂ be 0.24 or less, which enables experimental observation of the H1-3 type structure, and discharging are repeated, the crystal structure of conventional lithium cobalt oxide repeatedly changes between the H1-3 type structure and the R-3m O3 type structure in a discharged state (i.e., an unbalanced phase change).

There is a large shift in the CoO₂ layers between these two crystal structures. As denoted by the dotted lines in FIG. 13, the CoO₂ layer in the H1-3 type structure largely shifts from that in the R-3m O3 type structure in a discharged state. Such a dynamic structural change can adversely affect the stability of the crystal structure.

A difference in volume between the two crystal structures is also large. When the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

Meanwhile, in the positive electrode active material 100 of one embodiment of the present invention shown in FIG. 12, a change in the crystal structure between a discharged state with x in LiₓMO₂ of 1 and a state with x of 0.24 or less is smaller than that in a conventional positive electrode active material. Specifically, a shift in the MO₂ layers between the state with x of 1 and the state with x of 0.24 or less can be small. Furthermore, when the positive electrode active material 100 and the conventional positive electrode active material that have the same number of atoms of the transition metal M are compared, the positive electrode active material 100 changes in volume less than the conventional positive electrode active material. Thus, in the positive electrode active material 100 of one embodiment of the present invention, the crystal structure is unlikely to be broken and the site at which lithium can be stable is maintained even when charging that makes x be 0.24 or less and discharging are repeated; accordingly, the positive electrode active material 100 enables excellent cycle performance.

In addition, the positive electrode active material 100 of one embodiment of the present invention with x in LiₓMO₂ of 0.24 or less can have a more stable crystal structure than a conventional positive electrode active material with x in LiₓMO₂ of 0.24 or less. Thus, in the positive electrode active material 100 of one embodiment of the present invention, oxygen is not easily released even when the state where x in LiₓMO₂ is 0.24 or less is maintained, which can inhibit a thermal decomposition reaction. In other words, a secondary battery preferably includes the positive electrode active material 100 of one embodiment of the present invention to have improved safety.

FIG. 12 shows crystal structures of the inner portion 100b of the positive electrode active material 100 in a state where x in LiₓMO₂ is 1, approximately 0.2, and approximately 0.15. The inner portion 100b, accounting for the majority of the volume of the positive electrode active material 100, largely contributes to charging and discharging and is accordingly a portion where a shift in MO₂ layers and a volume change matter most.

As already described above, the positive electrode active material 100 has the R-3m O3 type structure in a state where x is 1, like conventional lithium cobalt oxide. However, in a state where x is 0.24 or less, e.g., approximately 0.2 or approximately 0.15, the positive electrode active material 100 has a crystal structure different from the H1-3 type structure whereas conventional lithium cobalt oxide has the H1-3 type structure.

The positive electrode active material 100 of one embodiment of the present invention with x of approximately 0.2 has a trigonal crystal structure belonging to the space group R-3m. The symmetry of the MO₂ layers of this structure is the same as that of the O3 type structure. Thus, this crystal structure is referred to as an O3′ type structure. A crystal structure that is not a spinel structure but exhibits an XRD pattern similar to that of a spinel structure is referred to as a pseudo-spinel structure in some cases. In FIG. 12, this crystal structure is denoted by R-3m O3′. As will be described later, the positive electrode active material 100 sometimes has the H1-3 type structure after having the O3′ type structure. However, it is presumed that the positive electrode active material 100 that has once had the O3′ type structure can have the effect of inhibiting oxygen release even when having the H1-3 type structure, for example, so that a lithium-ion secondary battery that includes the positive electrode active material 100 is less likely to ignite even when undergoing a nail penetration test.

Note that in the unit cell of the O3′ type structure where M is cobalt, the coordinates of cobalt and oxygen can be represented by Co (0, 0, 0.5) and O (0, 0, x) within the range of 0.20≤x≤0.25. In the unit cell, the lattice constant of the a-axis is preferably 2.797×10⁻¹⁰≤a≤2.837×10⁻¹ (m), further preferably 2.807×10⁻¹⁰≤a≤2.827×10⁻¹⁰ (m), typically a=2.817×10⁻¹⁰ (m). The lattice constant of the c-axis is preferably 13.681×10⁻¹⁰≤c≤13.881×10⁻¹⁰ (m), further preferably 13.751×10⁻¹⁰≤c≤13.811×10⁻¹⁰ (m), typically, c=13.781×10⁻¹⁰ (m).

When x is approximately 0.15, the positive electrode active material 100 of one embodiment of the present invention has a monoclinic crystal structure belonging to the space group P2/m. In this structure, a unit cell includes one CoO₂ layer. The expression “x is approximately 0.15” may mean that lithium in the positive electrode active material 100 is approximately 15 atomic % of that in a discharged state. Thus, this crystal structure is referred to as a monoclinic O1(15) type structure. In FIG. 12, this crystal structure is denoted by P2/m monoclinic O1(15).

In the unit cell of the monoclinic O1(15) type structure where M is cobalt, the coordinates of cobalt and oxygen can be represented by Col (0.5, 0, 0.5), Co2 (0, 0.5, 0.5) O1 (X_{O1}, 0, Z_{O1}) within the range of 0.23≤X_{O1}≤0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants a=0.4880±0.005 nm, b=0.2817±0.005 nm, c=0.4839±0.005 nm, α=90°, β=109.6±0.1°, and γ=90°.

Note that this crystal structure can have the lattice constants even when belonging to the space group R-3m if a certain error is allowed in Rietveld analysis or the like. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants a=0.2817±0.002 nm and c=1.368±0.01 nm.

In each of the O3′ type structure and the monoclinic O1(15) type structure, an ion of cobalt, nickel, magnesium, or the like occupies a site coordinated to six oxygen atoms. Note that a light element such as lithium or magnesium sometimes occupies a site coordinated to four oxygen atoms.

As denoted by the dotted lines in FIG. 12, the MO₂ layers hardly shift between the R-3m O3 type structure in a discharged state, the O3′ type structure, and the monoclinic O1(15) type structure.

The R-3m O3 type structure in a discharged state and the O3′ type structure that contain the same number of cobalt atoms have a difference in volume of 2.5% or less, specifically 2.2% or less, typically 1.8%.

The R-3m O3 type structure in a discharged state and the monoclinic O1(15) type structure that contain the same number of cobalt atoms have a difference in volume of 3.3% or less, specifically 3.0% or less, typically 2.5%.

Table 1 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, ICSD coll. code. 172909 and 88721 can be referred to. For the lattice constants of the H1-3 type structure, Non-Patent Document 3 can be referred to. The lattice constants of the O3′ type structure and the monoclinic O1(15) type structure can be calculated from the experimental values of XRD.

TABLE 1

| | | | | | Volume of | Volume per | Volume |
|---|---|---|---|---|---|---|---|
| | Lattice constant | | | | unit cell | Co atom | change rate |
| Crystal structure | a (Å) | b (Å) | c (Å) | β (°) | (Å³) | (Å³) | (%) |
| R-3m O3 | 2.8156 | 2.8156 | 14.0542 | 90 | 96.49 | 32.16 | — |
| (LiCoO₂) | | | | | | | |
| O3' | 2.818 | 2.818 | 13.78 | 90 | 94.76 | 31.59 | 1.8 |
| Monoclinic | 4.881 | 2.817 | 4.839 | 109.6 | 62.69 | 31.35 | 2.5 |
| O1(15) | | | | | | | |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, when the positive electrode active material 100 and the conventional positive electrode active material having the same number of cobalt atoms are compared, the positive electrode active material 100 changes in volume less than the conventional positive electrode active material. Thus, the crystal structure of the positive electrode active material 100 is less likely to break even when charging that makes x be 0.24 or less and discharging are repeated. Therefore, a decrease in charge and discharge capacity of the positive electrode active material 100 in charge and discharge cycles is inhibited. Furthermore, the positive electrode active material 100 can stably use a large amount of lithium than a conventional positive electrode active material and thus has high discharge capacity per weight and per volume. Thus, with the use of the positive electrode active material 100, a secondary battery with high discharge capacity per weight and per volume can be fabricated.

Note that the positive electrode active material 100 actually has the O3′ type structure in some cases when x in LiₓMO₂ is greater than or equal to 0.15 and less than or equal to 0.24, and is assumed to have the O3′ type structure even when x is greater than and less than or equal to 0.27. In addition, the positive electrode active material 100 actually has the monoclinic O1(15) type structure in some cases when x in LiₓMO₂ is greater than 0.1 and less than or equal to 0.2, typically greater than or equal to 0.15 and less than or equal to 0.17. However, the crystal structure is affected by not only x in LiₓMO₂ but also the number of charge and discharge cycles, a charge current and a discharge current, temperature, an electrolyte solution, and the like, so that the range of x is not limited to the above.

Thus, when x in LiₓMO₂ is greater than 0.1 and less than or equal to 0.24, the positive electrode active material 100 may have the O3′ type structure and/or the monoclinic O1(15) type structure. Not all the particles contained in the inner portion 100b of the positive electrode active material 100 necessarily have the O3′ type structure and/or the monoclinic O1(15) type structure. Some of the particles may have another crystal structure or be amorphous.

In order to make x in LiₓMO₂ small, charging at a high charge voltage is necessary in general. Therefore, the state where x in LiₓMO₂ is small can be rephrased as a state where charging at a high charge voltage has been performed. For example, when CC/CV charging is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

That is, the positive electrode active material 100 of one embodiment of the present invention is preferable because the positive electrode active material 100 can maintain the R-3m O3 type structure having symmetry even when charging at a high charge voltage, e.g., 4.6 V or higher at 25° C., is performed. Moreover, the positive electrode active material 100 of one embodiment of the present invention is preferable because the positive electrode active material 100 can have the O3′ type structure when charging at a higher charge voltage, e.g., a voltage higher than or equal to 4.65 V and lower than or equal to 4.7 V at 25° C., is performed. Furthermore, the positive electrode active material 100 of one embodiment of the present invention is preferable because the positive electrode active material 100 can have the monoclinic O1(15) type structure when charging at a much higher charge voltage, e.g., a voltage higher than 4.7 V and lower than or equal to 4.8 V at 25° C., is performed.

At a far higher charge voltage, the H1-3 type structure is eventually observed in the positive electrode active material 100 of one embodiment of the present invention in some cases. As described above, the crystal structure is affected by the number of charge and discharge cycles, a charge current and a discharge current, temperature, an electrolyte solution, and the like, so that the positive electrode active material 100 of one embodiment of the present invention sometimes has the O3′ type structure even at a lower charge voltage, e.g., a charge voltage higher than or equal to 4.5 V and lower than 4.6 V at 25° C. Similarly, the positive electrode active material 100 sometimes has the monoclinic O1(15) type structure when charging is performed at a voltage higher than or equal to 4.65 V and lower than or equal to 4.7 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a crystal structure similar to the above-described crystal structure is obtained at a voltage corresponding to a difference between the above-described voltage and the potential of the graphite.

Although a chance of the existence of lithium at all lithium sites is the same in the O3′ type structure and the monoclinic O1(15) type structure in FIG. 12, the present invention is not limited thereto. Lithium may exist unevenly at only some of the lithium sites. For example, lithium may symmetrically exist as in the monoclinic O1 type structure (Li_{0.5}CoO₂) in FIG. 13. The distribution of lithium can be analyzed by neutron diffraction, for example.

Each of the O3′ type structure and the monoclinic O1(15) type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

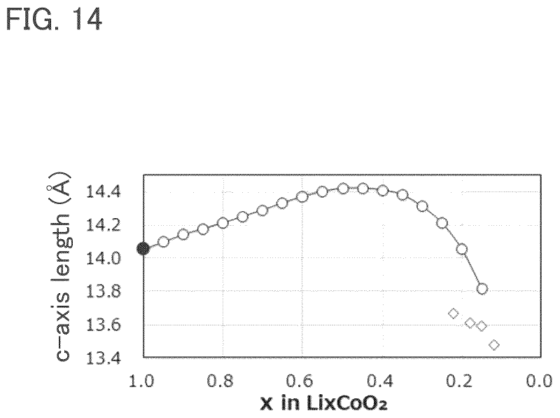

As already described above, the crystal structure of each of conventional lithium cobalt oxide and the positive electrode active material 100 of one embodiment of the present invention changes in accordance with a change in charge depth, i.e., a change in x in LiₓCoO₂. FIG. 14 shows a change in c-axis length of conventional lithium cobalt oxide described in Non-Patent Document 12. A circle indicates a hexagonal phase and a rhombus indicates a monoclinic phase.

A change in c-axis length of lithium cobalt oxide corresponds to a change in the angle at which a peak of, for example, the (003) plane of lithium cobalt oxide appears in an XRD pattern. It is known that a peak of the (003) plane of lithium cobalt oxide appears at around 2θ=19° to 20° in XRD using CuKα1 radiation.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution refers to a state where the concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b. In addition, the nickel concentration at the crystal grain boundary 101 and the vicinity thereof is preferably higher than that in the other regions in the inner portion 100b. In addition, the aluminum concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the positive electrode active material 100, which enables high-voltage charging, has too large a particle diameter, there are problems such as difficulty in lithium diffusion and large surface roughness of an active material layer at the time when the material is applied to a current collector. By contrast, too small a particle diameter causes problems such as an overreaction with the electrolyte solution. Therefore, the median diameter (D50) is preferably greater than or equal to 1 μm and less than or equal to 100 lam, further preferably greater than or equal to 2 μm and less than or equal to 40 lam, still further preferably greater than or equal to 5 μm and less than or equal to 30 lam. Alternatively, the median diameter (D50) is preferably greater than or equal to 1 μm and less than or equal to 40 lam, greater than or equal to 1 μm and less than or equal to 30 lam, greater than or equal to 2 μm and less than or equal to 100 lam, greater than or equal to 2 lam and less than or equal to 30 lam, greater than or equal to 5 μm and less than or equal to 100 lam, or greater than or equal to 5 μm and less than or equal to 40 lam.

A positive electrode is preferably formed using a mixture of particles having different particle diameters to have an increased electrode density and enable a high energy density of a secondary battery. The positive electrode active material 100 with a relatively small particle diameter is expected to enable favorable charge and discharge rate characteristics. A secondary battery that includes the positive electrode active material 100 having a relatively particle diameter is expected to have high charge and discharge cycle performance and maintain high discharge capacity.

In the case where a positive electrode is formed using a mixture of particles having different median diameters (D50), the speed at which x in LiₓCoO₂ decreases is higher in the positive electrode active material 100 with a relatively small particle diameter than in the positive electrode active material 100 with a relatively large particle diameter, on the assumption that extraction of lithium starts from the surface of the positive electrode active material. Thus, both the O3′ type structure and the monoclinic O1(15) type structure are sometimes detected when powder XRD measurement is performed on a positive electrode active material formed using a mixture of particles having different particle diameters.

### <Analysis Method>

Whether or not a given positive electrode active material is the positive electrode active material 100 of one embodiment of the present invention, which has the 03′ type structure and/or the monoclinic O1(15) type structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. The peaks appearing in the powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the adverse effect of orientation of the positive electrode active material particles due to pressure application or the like is eliminated. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material 50% or more of which has the crystal structure that will be largely changed by high-voltage charging is not preferable because the material cannot withstand repetition of high-voltage charging and discharging.

It should be noted that the O3′ type structure or the monoclinic O1(15) type structure is not obtained in some cases only by addition of the additive element. For example, in a state with x in LiₓCoO₂ of 0.24 or less, lithium cobalt oxide containing magnesium and fluorine or lithium cobalt oxide containing magnesium and aluminum has the O3′ type structure and/or the monoclinic O1(15) type structure at 60% or more in some cases, and has the H1-3 type structure at 50% or more in other cases, depending on the concentration and distribution of the additive element.

In addition, in a state where x is too small, e.g., 0.1 or less, or a charge voltage is higher than 4.9 V, the positive electrode active material 100 of one embodiment of the present invention sometimes has the H1-3 type structure or the trigonal O1 type structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed with exposure to the air. For example, the O3′ type structure and the monoclinic O1(15) type structure change into the H1-3 type structure in some cases. For that reason, all samples subjected to analysis of the crystal structure are preferably handled in an inert atmosphere such as an argon atmosphere.

Whether the additive element contained in a positive electrode active material has the above-described distribution can be judged by analysis using XPS, EDX, electron probe microanalysis (EPMA), or the like.

The crystal structure of the surface portion 100a, the crystal grain boundary 101, or the like can be analyzed by electron diffraction of a cross section of the positive electrode active material 100, for example.

### <<Powder Resistivity Measurement>>

The volume resistivity of powder of the positive electrode active material 100 of one embodiment of the present invention is described.

In one embodiment of the present invention, the volume resistivity of powder of the positive electrode active material 100 is preferably higher than or equal to 1.0×4 Ω·cm, further preferably higher than or equal to 1.0×10⁵ Ω·cm, still further preferably higher than or equal to 1.0×10⁶ Ω·cm under a pressure of 64 MPa. The volume resistivity of the powder of the positive electrode active material 100 is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa. When fluorine is adsorbed onto the surface of the positive electrode active material 100 and at least some of the fluorine atoms are bonded to lithium contained in the positive electrode active material 100, the lithium can be inhibited from moving. This increases the volume resistivity of the powder of the positive electrode active material 100 to, specifically, any of the above values. For example, the volume resistivity of the powder of the positive electrode active material 100 can be higher than or equal to 1.0×10⁵ Ω·cm under a pressure of 64 MPa.

The positive electrode active material 100 with the above volume resistivity has a stable crystal structure at a high voltage. Thus, the volume resistivity of the powder of the positive electrode active material 100 falling within the above-described range can indicate the favorable formation of the surface portion 100a, which is an important factor for a stable crystal structure of the positive electrode active material in a charged state. In other words, it is preferable that at least the shell 100s have high resistance in the positive electrode active material 100.

Note that a battery reaction might be hindered in the case where a high-resistance region extends from the surface of the positive electrode active material 100 toward the inner portion thereof to have a large thickness. It is thus further preferable that only a thin region near the surface of the surface portion 100a have high resistance. That is, a high-resistance region preferably extends from the surface toward the inner portion to have a small thickness in the surface portion 100a. For example, a region with a high concentration of Mg in the surface portion 100a can have high resistance. It is thus preferable that Mg be in the surface portion 100a.

A method for measuring the volume resistivity of the powder of the positive electrode active material 100 of one embodiment of the present invention is described.

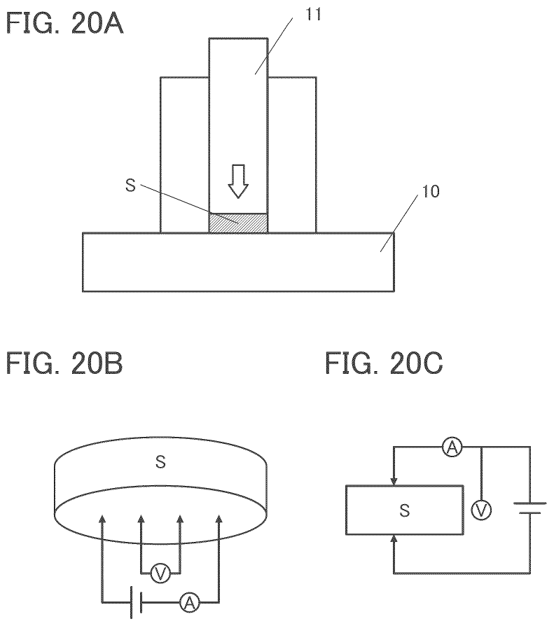

The volume resistivity of the powder is preferably measured using a measurement device that includes, as shown in FIG. 20A, a first mechanism 10 provided with a resistance measurement terminal and a second mechanism 11 for applying pressure to a powder sample S subjected to the measurement. The second mechanism 11 preferably includes a cylinder into which the powder sample S is to be put and a piston which is configured to move up and down in the cylinder. A spring or the like is connected to the piston, so that pressure can be applied to the sample in the cylinder. The first mechanism 10 preferably includes a measurement electrode that is in contact with the bottom surface of the cylinder. As such a measurement device that includes the measurement electrode and the mechanism for applying pressure to powder subjected to the measurement, for example, MCP-PD51 produced by Mitsubishi Chemical Analytech Co., Ltd. can be used. As a resistance meter, Loresta-GP or Hiresta-UP can be used. Loresta-GP can be used for the measurement for a low-resistance sample by a four point probe method as shown in FIG. 20B, whereas Hiresta-UP can be used for the measurement for a high-resistance sample by a two-terminal method as shown in FIG. 20C. The measurement is preferably performed in a stable environment such as an environment of a dry room but may be performed in an environment of a common laboratory. In the environment of a dry room, the temperature is preferably higher than or equal to 20° C. and lower than or equal to 25° C. and the dew point is preferably lower than or equal to −40° C., for example. In the environment of a common laboratory, the temperature may be higher than or equal to 15° C. and lower than or equal to 30° C. and the humidity may be higher than or equal to 30% and lower than or equal to 70%.

The measurement of the volume resistivity of powder using the above-described measurement device is described. First, a powder sample is set in the second mechanism 11. The second mechanism 11 includes a measurement unit. In the measurement unit, the bottom surface of the cylinder in which the sample is put is in contact with the measurement electrode, and the piston or the like capable of applying pressure to the sample is provided. The measurement unit also includes a structure for measuring the thickness of the sample.

In the measurement of the volume resistivity of powder, the electric resistance and thickness of the powder under pressure are measured. The pressure applied to the powder can be varied. For example, the electric resistance and thickness of the powder can be measured under pressures of 13 MPa, 25 MPa, 38 MPa, 51 MPa, and 64 MPa. The volume resistivity of the powder can be calculated from the measured electric resistance and thickness of the powder.

A calculation method of volume resistivity is described. In the case where the measurement is performed by a two-terminal method using Hiresta-UP, the volume resistivity can be calculated by multiplying the electric resistance of the powder by the area of the measurement electrode in contact with the powder and then dividing the product by the thickness of the powder. In the case where the measurement is performed by a four point probe method using Loresta-GP, the volume resistivity can be calculated by multiplying the electric resistance of the powder, a correction coefficient, and the thickness of the powder. The correction coefficient is a value that depends on the sample shape, the sample size, and the measurement position and can be calculated using calculation software incorporated in Loresta-GP.

The volume resistivity of the powder of the positive electrode active material 100 of one embodiment of the present invention obtained by the above-described measurement is preferably higher than or equal to 1.0×10⁴ Ω·cm, further preferably higher than or equal to 1.0×10⁵ Ω·cm, still further preferably higher than or equal to 1.0×10⁶ Ω·cm under a pressure of 64 MPa. The volume resistivity of the powder of the positive electrode active material 100 of one embodiment of the present invention obtained by the above-described measurement is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa. A battery that includes the positive electrode active material 100 with such volume resistivity achieves favorable cycle performance in a charge and discharge cycle test at a high voltage. Moreover, the battery does not easily ignite in an internal short circuit test such as a nail penetration test.

### <<Charging Method>>

Whether or not a composite oxide is the positive electrode active material 100 of one embodiment of the present invention can be determined by charging a CR2032 coin cell (with a diameter of 20 mm and a height of 3.2 mm) that is formed using the composite oxide and a lithium metal respectively for a positive electrode and a counter electrode, for example. The coin cell includes an electrolyte solution, a separator, a positive electrode can, and a negative electrode can.

More specifically, the positive electrode can be formed by application of a slurry in which the composite oxide as a positive electrode active material, a conductive material, and a binder are mixed to a positive electrode current collector made of aluminum foil.

A lithium metal can be used for the counter electrode as described above, but a material other than a lithium metal may be alternatively used. In a secondary battery whose counter electrode is formed using a material other than a lithium metal, the potential of the secondary battery differs from the potential of its positive electrode. Unless otherwise specified, the voltage and the potential in this specification and the like refer to the potential of a positive electrode.

The electrolyte solution can contain lithium hexafluorophosphate (LiPF₆) as a lithium salt at 1 mol/L. As the electrolyte solution, a solution in which ethylene carbonate (EC) and diethyl carbonate (DEC) at a volume ratio of 3:7 and vinylene carbonate (VC) at 2 wt % are mixed can be used.

As the separator, a 25-μm-thick polypropylene porous film can be used.

Stainless steel (SUS) can be used for the positive electrode can and the negative electrode can.

The coin cell fabricated with the above conditions is charged to a freely selected voltage (e.g., 4.5 V, 4.55 V, 4.6 V, 4.65 V, 4.7 V, 4.75 V, or 4.8 V). The charge conditions are not particularly limited as long as charging can be performed for enough time to a freely selected voltage. In the case of CCCV charging, for example, CC charging can be performed with a current higher than or equal to 20 mA/g and lower than or equal to 100 mA/g, and CV charging can be ended with a current higher than or equal to 2 mA/g and lower than or equal to 10 mA/g. To observe a phase change of the positive electrode active material, charging with such a small current value is preferably performed. The temperature is set to 25° C., since it is difficult to perform XRD measurement at a temperature lower than or equal to 0° C. Note that 25° C. is an exemplary temperature. After the charging is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere in performing various analyses later. For example, XRD measurement can be performed on the positive electrode active material enclosed in an airtight container with an argon atmosphere. After the charging is completed, the positive electrode is preferably taken out immediately and subjected to the analysis. Specifically, the positive electrode is preferably subjected to the analysis within one hour after the completion of the charging, further preferably 30 minutes after the completion of the charging.

In the case where the crystal structure in a charged state after charging and discharging are performed multiple times is analyzed, the conditions of the charging and discharging which are performed multiple times may be different from the above-described charge conditions. For example, the charging can be performed in the following manner: constant current charging to a freely selected voltage (e.g., 4.6 V, 4.65 V, 4.7 V, 4.75 V, or 4.8 V) at a current value higher than or equal to 20 mA/g and lower than or equal to 100 mA/g is performed and then, constant voltage charging is performed until the current value becomes higher than or equal to 2 mA/g and lower than or equal to 10 mA/g. As the discharging, constant current discharging can be performed at higher than or equal to 20 mA/g and lower than or equal to 100 mA/g until the discharge voltage reaches 2.5 V.

Also in the case where the crystal structure in a discharged state after charging and discharging are performed multiple times is analyzed, the discharging can be constant current discharging at a current value higher than or equal to 20 mA/g and lower than or equal to 100 mA/g until the discharge voltage reaches 2.5 V, for example.

### <<XRD>>

The apparatus and conditions adopted in the XRD measurement are not particularly limited as long as appropriate adjustment and calibration are performed. The measurement can be performed with the apparatus and conditions as described below, for example.

XRD apparatus: D8 ADVANCE produced by Bruker AXS
X-ray: Cu Kα1
Output: 40 kV, 40 mA
Angle of divergence: Div. Slit, 0.5°
Detector: LynxEye
Scanning method: 2θ/θ successive scanning
Measurement range (2θ): from 15° to 90°
Step width (2θ): 0.01°
Counting time: one second/step
Rotation of sample stage: 15 rpm

In the adjustment and calibration, a standard sintered alumina plate SRM 1976 from National Institute of Standards and Technology (NIST) can be used as a standard sample, for example.

In the case where the measurement sample is powder, the powder can be set by, for example, being put on a glass sample holder or being sprinkled on a reflection-free silicon plate to which grease is applied. In the case where the measurement sample is a positive electrode, the positive electrode can be set by being attached to a substrate with a double-sided adhesive tape such that the heights of the positive electrode active material layer and the measurement plane required by the apparatus are aligned.

Characteristic X-rays may be monochromatized with the use of a filter or the like or may be monochromatized with XRD data analysis software after an XRD pattern is obtained. For example, a peak due to CuKα₂ radiation can be eliminated and only a peak due to CuKα₁ radiation can be extracted by using DIFFRAC.EVA (XRD data analysis software produced by Bruker Corporation). This software can also be used to eliminate the background, for example.

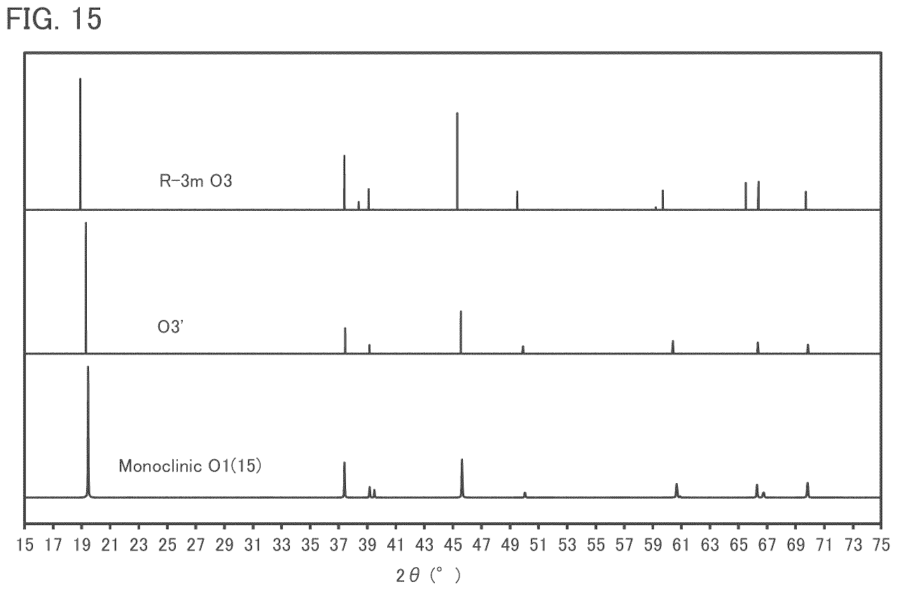

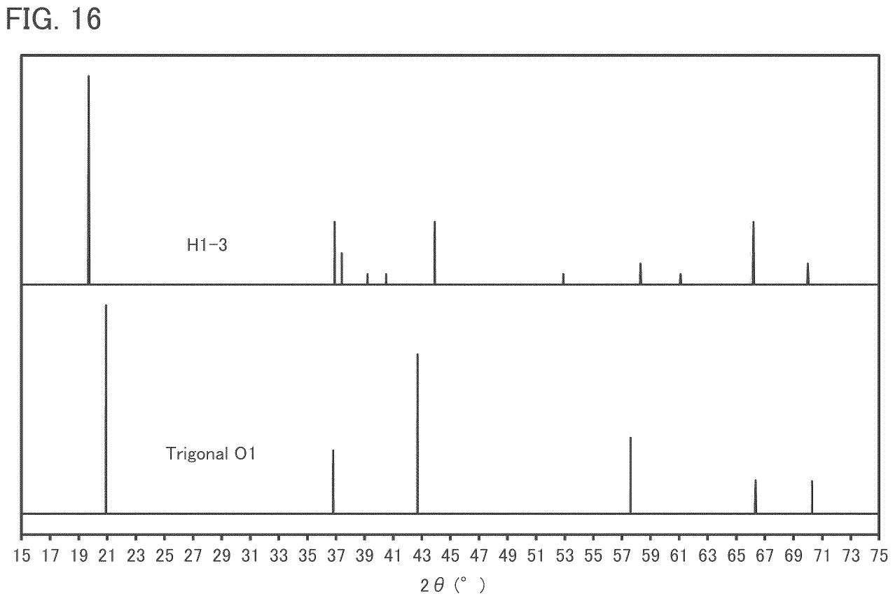

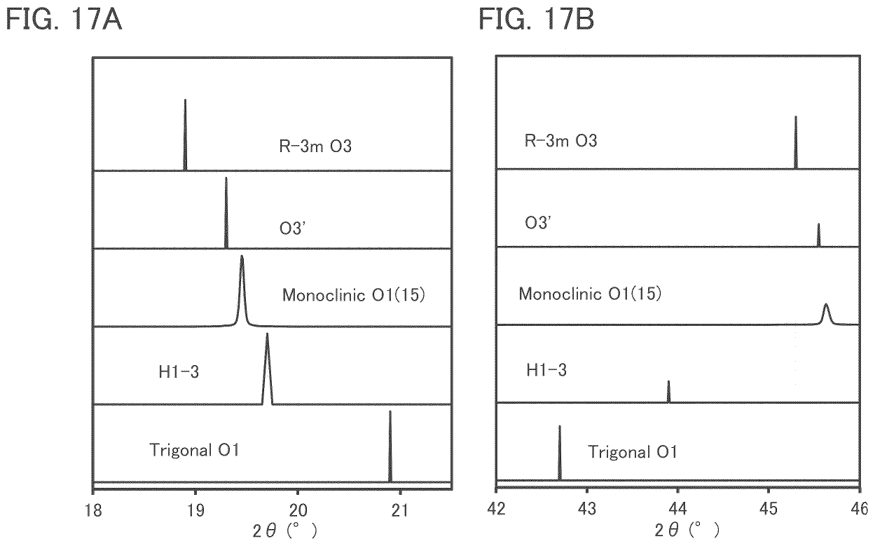

Data processing for a 20 value of a diffraction peak in this specification and the like is described. First, a calculation model is fitted for an XRD pattern with the use of crystal structure analysis software to obtain a pattern after calculation. Then, the 20 value at which a peak top of the diffraction peak appears in the pattern after the calculation is defined as the 2θ value of the diffraction peak. There is no particular limitation on the crystal structure analysis software used for the fitting; for example, it is possible to use TOPAS ver. 3 (crystal structure analysis software produced by Bruker Corporation). FIG. 15 shows XRD patterns corresponding to the O3 type structure, the O3′ type structure, and the monoclinic O1(15) type structure of the case where CuKα1 is used as an X-ray. FIG. 16 shows an ideal powder XRD pattern with CuKα1 radiation calculated from a model of the H1-3 type structure and an ideal XRD pattern with CuKα1 radiation calculated from the trigonal O1 type structure with x of 0. FIG. 17A shows all of the above-described XRD patterns in the 20 range of 18° to 21° and FIG. 17B shows those in the 20 range of 42° to 46°. Note that the patterns of LiCoO₂ (O3) and CoO₂ (O1) are made from crystal structure data obtained from the Inorganic Crystal Structure Database (ICSD) (see Non-Patent Document 5) with Reflex Powder Diffraction, which is a module of Materials Studio (BIOVIA). The 20 range is from 15° to 75°, the step size is 0.01, the wavelength λ is 1.54×10⁻¹⁰ m, and a single monochromator is used. The pattern of the H1-3 type structure is similarly made from the crystal structure data disclosed in Non-Patent Document 3. The patterns of the O3′ type structure and the monoclinic O1(15) type structure are obtained in the following manner: the crystal structures are estimated from the XRD pattern of the positive electrode active material 100 of one embodiment of the present invention and fitting is performed with TOPAS ver. 3 (crystal structure analysis software produced by Bruker Corporation).

As shown in FIG. 15 and FIGS. 17A and 17B, the O3′ type structure exhibits diffraction peaks at 2θ of 19.25±0.12° (greater than or equal to 19.13° and less than) 19.37° and 2θ of 45.47±0.10° (greater than or equal to 45.37° and less than 45.57°).

The monoclinic O1(15) type structure exhibits diffraction peaks at 2θ of 19.47±0.10° (greater than or equal to 19.37° and less than or equal to 19.57°) and 2θ of (greater than or equal to 45.57° and less than or equal to 45.67°).

However, as shown in FIG. 16 and FIGS. 17A and 17B, the H1-3 type structure and the trigonal O1 type structure do not exhibit peaks at these positions. Thus, exhibiting the peak at 2θ of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 of one embodiment of the present invention.

It can be said that the position of an XRD diffraction peak exhibited by the crystal structure with x of 1 is close to that of an XRD diffraction peak exhibited by the crystal structure with x of 0.24 or less. More specifically, it can be said that in the 20 range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure and/or the monoclinic O1(15) type structure when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1(15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to %, preferably greater than or equal to 60%, further preferably greater than or equal to 66% enables sufficiently good cycle performance.

Furthermore, even after 100 or more cycles of charging and discharging after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed. Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 20 value. In the case of the above-described measurement conditions, the peak observed in the 20 range of 43° to 46° preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charging.

The crystallite size of the O3′ type structure and the monoclinic O1(15) type structure of the positive electrode active material 100 is decreased to approximately 1/20 of that of LiCoO₂ (O3) in a discharged state. Thus, the peak of the O3′ type structure and/or the monoclinic O1(15) type structure can be clearly observed when x in LiₓCoO₂ is small even under the same XRD measurement conditions as those of a positive electrode before charging and discharging. By contrast, conventional LiCoO₂ has a small crystallite size and exhibits a broad and small peak although it can partly have a structure similar to the O3′ type structure and/or the monoclinic O1(15) type structure. The crystallite size can be calculated from the half width of the XRD peak.

As described above, the influence of the Jahn-Teller effect is preferably small in the positive electrode active material 100 of one embodiment of the present invention. The positive electrode active material 100 of one embodiment of the present invention may contain a transition metal such as nickel or manganese as the additive element in addition to cobalt as long as the influence of the Jahn-Teller effect is small.

The proportions of nickel and manganese and the range of the lattice constants with which the influence of the Jahn-Teller effect is presumed to be small in the positive electrode active material are examined by XRD analysis.

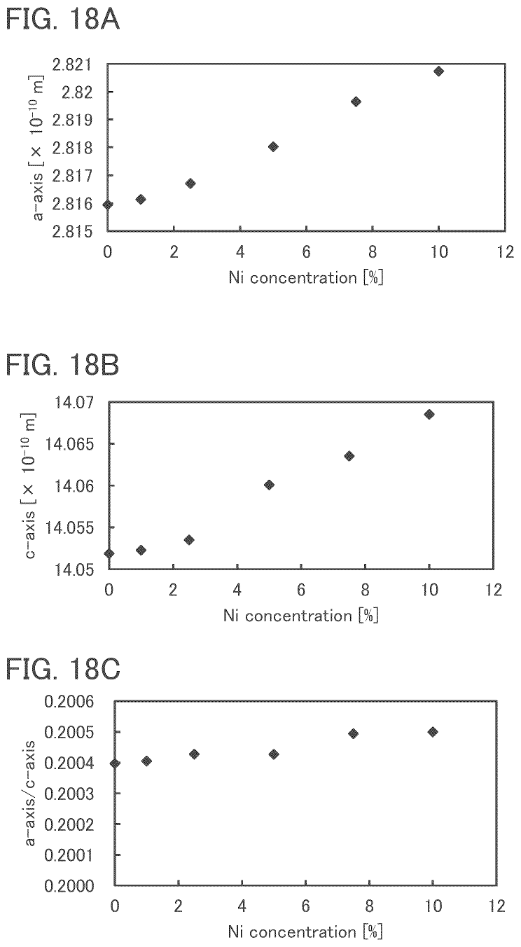

FIGS. 18A to 18C show the calculation results of the lattice constants of the a-axis and the c-axis by XRD in the case where the positive electrode active material 100 of one embodiment of the present invention has a layered rock-salt crystal structure and contains cobalt and nickel. FIG. 18A shows the results of the a-axis, and FIG. 18B shows the results of the c-axis. Note that the XRD patterns of powder after the synthesis of the positive electrode active material before incorporation into a positive electrode were used for the calculation. The nickel concentration on the horizontal axis represents a nickel concentration with the sum of the number of cobalt atoms and the number of nickel atoms regarded as 100%.

FIG. 18C shows values obtained by dividing the lattice constants of the a-axis by the lattice constants of the c-axis (a-axis/c-axis) in the positive electrode active material, whose results of the lattice constants are shown in FIGS. 18A and 18B.

As shown in FIG. 18C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration lower than 7.5%.

Note that the nickel concentration in the surface portion 100a is not limited to the above range. In other words, the nickel concentration in the surface portion 100a may be higher than the above concentration.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charging and discharging are not performed may be the state of powder before the formation of a positive electrode of a secondary battery.

Alternatively, in the layered rock-salt crystal structure of the positive electrode active material 100 in a discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in a discharged state or the state where charging and discharging are not performed is subjected to XRD analysis, a first peak is observed in the 20 range of 18.50° to 19.30° and a second peak is observed in the 20 range of 38.00° to 38.80°, in some cases.

### <<XP S>>

In an inorganic oxide, a region that extends from the surface to a depth of approximately 2 nm to 8 nm (normally, less than or equal to 5 nm) can be analyzed by XPS using monochromatic aluminum Kα radiation as an X-ray; thus, the concentrations of elements in a region extending to approximately half the depth of the surface portion 100a can be quantitatively analyzed by XPS. The bonding states of the elements can be analyzed by narrow scanning.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive element(s) in the entire positive electrode active material 100, which is measured by ICP-MS, GD-MS, or the like. For example, the concentration of magnesium of at least part of the surface portion 100a, which is measured by XPS or the like, is preferably higher than the concentration of magnesium of the entire positive electrode active material 100. In addition, the concentrations of nickel, aluminum, and fluorine of at least part of the surface portion 100a are preferably higher than the concentrations of nickel, aluminum, and fluorine of the entire positive electrode active material 100, respectively.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt enables comparison while inhibiting the influence of a carbonate or the like which is chemically adsorbed after formation of the positive electrode active material. For example, in the XPS analysis, the ratio of the number of magnesium atoms to the number of cobalt atoms (Mg/Co) is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentrations of cobalt and lithium in at least part of the surface portion 100a, which are measured by XPS or the like, are preferably higher than those of magnesium, nickel, aluminum, and fluorine in at least part of the surface portion 100a, which are measured by XPS or the like.

It is further preferable that the additive element such as aluminum be widely distributed in a deep region such as a region extending from a depth from the surface of nm to a depth from the surface of 50 nm. Therefore, the concentration of the detected additive element such as aluminum found out by analysis on the entire positive electrode active material 100 by ICP-MS, GD-MS, or the like may be different from the concentration of the additive element found out by XPS analysis or the like on a region extending from the surface to a depth of approximately 5 nm.

Moreover, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.1 times and less than or equal to 1.1 times, further preferably greater than or equal to 0.3 times and less than or equal to 0.9 times the number of cobalt atoms. When the atomic ratio is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray, for example. An extraction angle is, for example, 45°. For example, the measurement can be performed using the following apparatus and conditions.
Measurement device: Quantera II produced by PHI, Inc.
X-ray: monochromatic Al Kα (1486.6 eV)
Detection area: 100 μm ϕ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This value is different from the bonding energy of lithium fluoride (685 eV) and that of magnesium fluoride (686 eV).

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### <<EDX>>

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using an FIB or the like and analyzing the cross section using EDX, EPMA, or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of the additive element such as magnesium in the surface portion 100a is higher than that in the inner portion 100b.

For example, EDX area analysis or EDX point analysis of the positive electrode active material 100 containing magnesium as the additive element preferably reveals that the magnesium concentration in the surface portion 100a is higher than that in the inner portion 100b. In the EDX line analysis, a peak of the magnesium concentration in the surface portion 100a is preferably observed in a region extending, toward the center of the positive electrode active material 100, from the surface thereof to a depth of 3 nm, further preferably 1 nm, still further preferably 0.5 nm. In addition, the magnesium concentration preferably attenuates, at a depth of 1 nm from the point where the concentration reaches the peak, to less than or equal to 60% of the peak concentration. In addition, the magnesium concentration preferably attenuates, at a depth of 2 nm from the point where the concentration reaches the peak, to less than or equal to 30% of the peak concentration. Here, “a peak of concentration” refers to the local maximum value of concentration.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a is preferably observed in a region extending, toward the center of the positive electrode active material 100, from the surface thereof to a depth of 3 nm, further preferably 1 nm, still further preferably 0.5 nm. It is further preferable that a peak of the fluorine concentration be exhibited slightly closer to the surface side than a peak of the magnesium concentration is, which increases resistance to hydrofluoric acid. For example, it is preferable that a peak of the fluorine concentration be exhibited closer to the surface side than a peak of the magnesium concentration is by 0.5 nm or more, further preferably 1.5 nm or more.

In the positive electrode active material 100 containing nickel as the additive element, a peak of the nickel concentration in the surface portion 100a is preferably observed in a region extending, toward the center of the positive electrode active material 100, from the surface thereof to a depth of 3 nm, further preferably 1 nm, still further preferably 0.5 nm. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

In the case where the positive electrode active material 100 contains aluminum as the additive element, in the EDX line analysis, the peak of the magnesium concentration, the nickel concentration, or the fluorine concentration is preferably closer to the surface than the peak of the aluminum concentration is in the surface portion 100a. For example, the peak of the aluminum concentration is preferably observed in a region extending, toward the center of the positive electrode active material 100, from a depth from the surface of 0.5 nm to a depth from the surface of 50 nm, further preferably from a depth from the surface of 5 nm to a depth from the surface of 50 nm.

EDX line, area, or point analysis of the positive electrode active material 100 preferably reveals that the ratio of the number of magnesium (Mg) atoms to the number of cobalt (Co) atoms (Mg/Co) at a peak of the magnesium concentration is less than 1, preferably greater than or equal to 0.05 and less than or equal to 0.6, further preferably greater than or equal to 0.1 and less than or equal to 0.4. The ratio of the number of aluminum (Al) atoms to the number of cobalt (Co) atoms (Al/Co) at a peak of the aluminum concentration is less than 1, preferably greater than or equal to 0.05 and less than or equal to 0.6, further preferably greater than or equal to 0.1 and less than or equal to 0.45. The ratio of the number of nickel (Ni) atoms to the number of cobalt (Co) atoms (Ni/Co) at a peak of the nickel concentration is less than 1, preferably greater than or equal to 0 and less than or equal to 0.2, further preferably greater than or equal to 0.01 and less than or equal to 0.1. Alternatively, Ni/Co is preferably greater than or equal to and less than or equal to 0.5. The ratio of the number of cobalt (Co) atoms to the number of nickel (Ni) atoms (Co:Ni) preferably ranges from 90:10 to 80:20 or 70:30. The ratio of the number of fluorine (F) atoms to the number of cobalt (Co) atoms (F/Co) at a peak of the fluorine concentration is less than 1, preferably greater than or equal to 0 and less than or equal to 1.6, further preferably greater than or equal to 0.1 and less than or equal to 1.4.

According to results of the EDX line analysis, where the surface of the positive electrode active material 100 is can be estimated in the following manner. A point where the detected amount of an element which uniformly exists in the inner portion 100b of the positive electrode active material 100, e.g., oxygen or cobalt, is ½ of the detected amount thereof in the inner portion 100b is assumed as the surface.

Since the positive electrode active material 100 is a composite oxide, the detected amount of oxygen can be used to estimate where the surface is. Specifically, an average value Oₐᵥₑ of the oxygen concentration of a region of the inner portion 100b where the detected amount of oxygen is stable is calculated first. At this time, in the case where oxygen O_{bg} which is probably led from chemical adsorption or the background is detected in a region that is obviously outside the surface, O_{bg} is subtracted from the measurement value to obtain the average value Oₐᵥₑ of the oxygen concentration. The measurement point where the measurement value which is closest to ½ of the average value Oₐᵥₑ, or Oₐᵥₑ/2, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is unlikely to be affected by chemical adsorption and is thus suitable for the estimation of where the surface is.

When the positive electrode active material 100 is subjected to line analysis or area analysis, the ratio of the number of atoms of an additive element A to the number of cobalt (Co) atoms (A/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.03.

In the case where the additive element is magnesium, for example, when the positive electrode active material 100 is subjected to line analysis or area analysis, the ratio of the number of magnesium atoms to the number of cobalt atoms (Mg/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted by EPMA. In area analysis, the distribution of each element can be analyzed.

EPMA area analysis of a cross section of the positive electrode active material 100 of one embodiment of the present invention preferably reveals that one or two selected from the additive elements have a concentration gradient, as in the EDX analysis. It is further preferable that the additive elements exhibit concentration peaks at different depths from the surface. The preferred ranges of the concentration peaks of the additive elements are the same as those in the case of EDX.

In EPMA, a region from a surface to a depth of approximately 1 μm is analyzed. Thus, the quantitative value of each element is sometimes different from measurement results obtained by other analysis methods. For example, when EPMA surface analysis is performed on the positive electrode active material 100, the concentration of the additive element existing in the surface portion 100a might be lower than the concentration obtained in XPS.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a HAADF-STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to cobalt can be observed in some cases. Furthermore, since Raman spectroscopy can measure a range with a several square micrometers and a depth of approximately 1 μm of a surface portion, a Co—O bond that exists only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that the surface portion 100a of the positive electrode active material 100 has a rock-salt crystal structure in an appropriate range.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a region extending to a depth of 1 nm from the surface). This is because a diffusion path of lithium can be ensured and a function of stabilizing a crystal structure can be increased in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region that extends from the surface to a depth less than or equal to 1 nm and a nanobeam electron diffraction pattern of a region that extends from a depth from the surface of 3 nm to a depth from the surface of 10 nm are obtained, a difference between lattice constants calculated from the patterns is preferably small.

For example, a difference between lattice constants calculated from a measured portion that is at a depth less than or equal to 1 nm from the surface and a measured portion that is at a depth greater than or equal to 3 nm and less than or equal to 10 nm from the surface is preferably less than or equal to 0.01 nm (a-axis) and less than or equal to 0.1 nm (c-axis). The difference is further preferably less than or equal to 0.005 nm (a-axis) and less than or equal to 0.06 nm (c-axis), still further preferably less than or equal to 0.004 nm (a-axis) and less than or equal to 0.03 nm (c-axis).

### <Additional Features>

The positive electrode active material 100 has a depression, a crack, a concave, a V-shaped cross section, or the like in some cases. These are examples of defects, and when charging and discharging are repeated, dissolution of cobalt, breakage of a crystal structure, cracking of the positive electrode active material 100, release of oxygen, or the like might be derived from these defects. However, when there is the filling portion 102 in FIG. 7H that fills such defects, dissolution of cobalt or the like can be inhibited. Thus, a secondary battery that includes the positive electrode active material 100 can have improved reliability and improved cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charging and discharging with a large amount of current such as charging and discharging at 400 mA/g or more.

In the positive electrode active material 100 including the region where the additive element is unevenly distributed, addition of excess additive elements to some extent in the formation process is acceptable. This is preferable because the margin of production can be increased.

A coating portion may be attached to at least part of the surface of the positive electrode active material 100. FIGS. 19A and 19B respectively show the positive electrode active material 100 in FIG. 7G and that in FIG. 7H to which the coating portion 104 is attached.

The coating portion 104 is preferably formed by deposition of decomposition products of a lithium salt, an organic electrolyte solution, and the like due to charging and discharging, for example. A coating portion originating from an organic electrolyte solution, which is formed on the surface of the positive electrode active material 100, is expected to improve charge and discharge cycle performance particularly when charging making x in LiₓCoO₂ be 0.24 or less is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100. In a portion without the coating portion 104, fluorine may be adsorbed onto the surface of the positive electrode active material 100.

This embodiment can be implemented in combination with any of the other embodiments.

### Embodiment 2

In this embodiment, an example of a method for forming the positive electrode active material 100 which is one embodiment of the present invention is described.

A way of adding an additive element is important in forming the positive electrode active material 100 having the distribution of the additive element, the composition, and/or the crystal structure that were/was described in the above embodiment. Favorable crystallinity of the inner portion 100b is also important.

In the formation process of the positive electrode active material 100 using one method, lithium cobalt oxide is synthesized first, an additive element source is then mixed, and heat treatment is performed. In a different method, an additive element source may be mixed together with a cobalt source and a lithium source to synthesize lithium cobalt oxide containing the additive element. It is preferable that heating be performed in addition to mixing of lithium cobalt oxide and the additive element source to make the additive element form a solid solution in the lithium cobalt oxide. Sufficient heating is preferably performed to enable favorable distribution of the additive element. The heat treatment after the mixing of the additive element source is thus important. The heat treatment after the mixing of the additive element source may be referred to as baking or annealing.

However, heating at an excessively high temperature may cause cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed as the additive element source or together with the additive element source. As the material functioning as a fusing agent, a substance having a lower melting point than lithium cobalt oxide can be used. For example, a fluorine compound such as lithium fluoride is preferably used as a fusing agent. Addition of a fusing agent lowers the melting points of the additive element source and lithium cobalt oxide. Lowering the melting points makes it easier to distribute the additive element favorably at a temperature at which cation mixing is less likely to occur.

### [Initial Heating]

It is further preferable that heat treatment be performed between the synthesis of the lithium cobalt oxide and the mixing of the additive element. This heating is referred to as initial heating in some cases.

Since lithium is extracted from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to form a solid solution and is diffused to the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me—O distance) tends to be longer than that in a layered rock-salt crystal structure.

For example, Me—O distance is 2.09×10⁻¹⁰ m and 2.11×10⁻¹⁰ m in Ni_{0.5}Mg_{0.5}O having a rock-salt crystal structure and MgO having a rock-salt crystal structure, respectively. Even when a spinel phase is formed in part of the surface portion 100a, Me—O distance is 2.0125×10⁻¹⁰ m and 2.02×10⁻¹⁰ m in NiAl₂O₄ having a spinel structure and MgAl₂O₄ having a spinel structure, respectively. In each case, Me—O distance is longer than 2×10⁻¹⁰ m.

Meanwhile, in a layered rock-salt crystal structure, the bond distance between oxygen and a metal other than lithium is shorter than the above-described distance. For example, Al—O distance is 1.905×10⁻¹⁰ m (Li—O distance is 2.11×10⁻¹⁰ m) in LiAlO₂ having a layered rock-salt crystal structure. In addition, Co—O distance is 1.9224×10⁻¹⁰ m (Li—O distance is 2.0916×10⁻¹⁰ m) in LiCoO₂ having a layered rock-salt crystal structure.

According to Non-Patent Document 15 describing Shannon's ionic radii, the ion radius of hexacoordinated aluminum and the ion radius of hexacoordinated oxygen are 0.535×10⁻¹⁰ m and 1.4×10⁻¹⁰ m, respectively, and the sum of these values is 1.935×⁻¹⁰ m.

From the above, aluminum is considered to exist at a site other than a lithium site more stably in a layered rock-salt crystal structure than in a rock-salt crystal structure. Thus, in the surface portion 100a, aluminum is more likely to be distributed in, than in a region having a rock-salt phase that is close to the surface, a region having a layered rock-salt phase at a larger depth and/or the inner portion 100b.

Moreover, the initial heating is expected to increase the crystallinity of the layered rock-salt crystal structure of the inner portion 100b.

For this reason, the initial heating is preferably performed in order to form the positive electrode active material 100 that has the monoclinic O1(15) type structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, the positive electrode active material 100 that has the O3′ type structure and/or the monoclinic O1(15) type structure when x in LiₓCoO₂ is small can be formed.

### <<Formation Method 1 of Positive Electrode Active Material>>

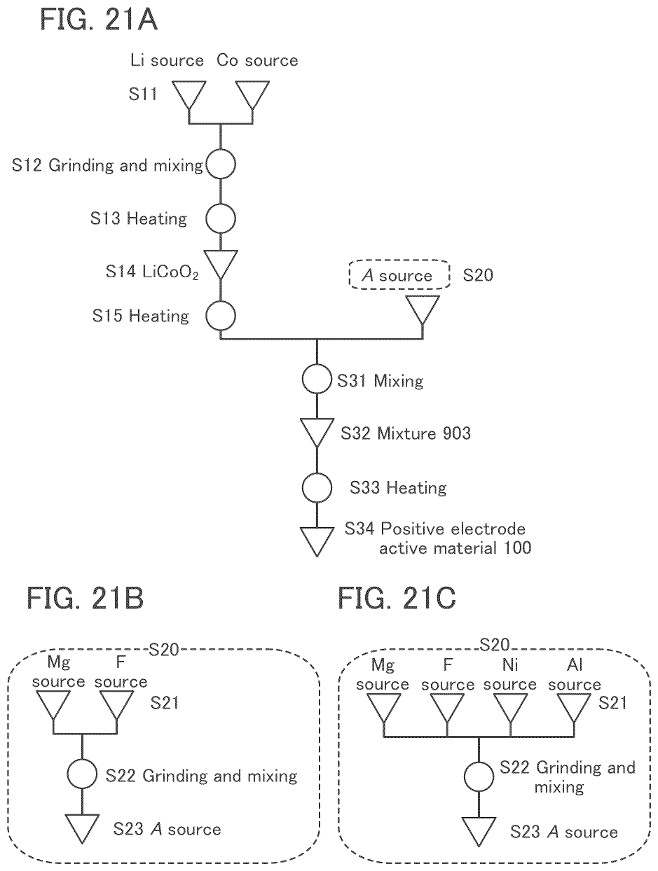

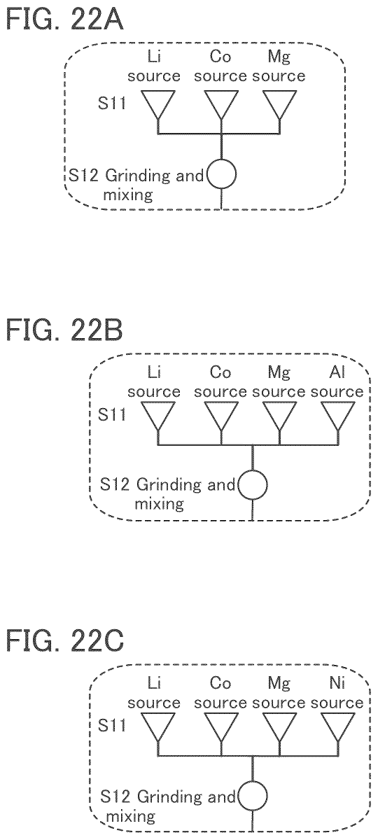

A formation method 1 of the positive electrode active material 100, in which the initial heating is performed, is described with reference to FIGS. 21A to 22C.

### <Step S11>

In Step S11 shown in FIG. 21A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used and for example, cobalt hydroxide, cobalt oxide such as tricobalt tetroxide, or the like can be used. The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be obtained.

Furthermore, the cobalt source preferably has high crystallinity and for example, the cobalt source preferably includes single crystal grains. The crystallinity of the cobalt source can be evaluated with a TEM image, an STEM image, a HAADF-STEM image, or an ABF-STEM image or by XRD, electron diffraction, neutron diffraction, or the like.

Note that the above methods for evaluating crystallinity can also be employed to evaluate the crystallinity of materials other than the cobalt source.

### <Step S12>

Next, in Step S12 shown in FIG. 21A, the lithium source and the cobalt source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 21A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to one hour and shorter than or equal to 100 hours, further preferably longer than or equal to two hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and the exit of the oxygen from the reaction chamber is prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours; for example, the temperature falling rate (hereinafter also referred to as cooling rate) is preferably higher than or equal to 80° C./h and low than or equal to 250° C./h, further preferably higher than or equal to 180° C./h and lower than or equal to 210° C./h. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization or sublimation of a material can be prevented. A lid at least prevents volatilization or sublimation of a material at the time when the temperature is raised and lowered in this step, and does not necessarily seal off a crucible. For example, this step can be performed without sealing off the crucible in the case where the reaction chamber is filled with oxygen as described above.

A used crucible is preferable to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger. Lost of some materials due to such phenomena increases a concern that an element is not distributed in a preferred range particularly in the surface portion of the positive electrode active material. In contrast, such a risk is low in the case of a used crucible.

The heated material is ground as needed and may be made to pass through a sieve. Before collection of the heated material, the material may be moved from the crucible to a mortar. As the mortar, an aluminum oxide mortar or a zirconium oxide mortar can be suitably used. An aluminum oxide mortar is made of a material that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 21A. In the case where a median diameter (D50) is employed as the particle diameter of the lithium cobalt oxide, the lithium cobalt oxide is preferably ground in order that the positive electrode active material 100 with a relatively small median diameter (D50) can be obtained.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, as Step S15 shown in FIG. 21A, the lithium cobalt oxide is heated. The heating in Step S15 is the first heating performed on the lithium cobalt oxide and thus, this heating is sometimes referred to as the initial heating. The heating is performed before Step S20 described below and thus is sometimes referred to as preheating or pretreatment. The crucible, lid, and/or the like used in this step are/is similar to those used in Step S13. Although the initial heating is expected to have the following effects, the initial heating is optional in obtaining the positive electrode active material of one embodiment of the present invention.

By the initial heating, lithium is extracted from part of the surface portion 100a of the lithium cobalt oxide as described above. In addition, an effect of increasing the crystallinity of the inner portion 100b can be expected. The lithium source and/or cobalt source prepared in Step S11 and the like might contain impurities. The initial heating can reduce impurities in the lithium cobalt oxide obtained in Step S14.

Furthermore, through the initial heating, the surface of the lithium cobalt oxide becomes smooth. The composite oxide having a smooth surface refers to the composite oxide having little unevenness and rounded as a whole with its corner portion rounded. A smooth surface refers to a surface to which few foreign substances are attached. Foreign substances are deemed to cause unevenness and are preferably not attached to a surface.

For the initial heating, a lithium compound source is not needed. Alternatively, an additive element source is not needed. Alternatively, a material functioning as a fusing agent is not needed.

When the heating time in this step is too short, an efficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C. and lower than or equal to 1000° C. for longer than or equal to two hours and shorter than or equal to 20 hours.

The effect of increasing the crystallinity of the internal portion 100b is, for example, an effect of reducing distortion, a shift, or the like derived from differential shrinkage or the like of the lithium cobalt oxide formed in Step S13.

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth, or “surface improvement is achieved”. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charging and discharging is suppressed and cracking of the positive electrode active material can be prevented.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIGS. 21B and 21C.

### <Steps S21 to S23>

The steps of preparing an additive element A source (A source) are described with reference to FIGS. 21B and 21C. A lithium source may be prepared in addition to the additive element A source.

As the additive element A, the additive element described in the above embodiment, e.g., one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

### <Step S21>

Step S21 shown in FIG. 21B is described. When magnesium is selected as the additive element, the additive element source can be referred to as a magnesium source (Mg source). As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source (F source). As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as both the fluorine source and the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O3F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 21B, the magnesium source and the fluorine source are ground and mixed. Any of the conditions for the grinding and mixing that are described for Step S12 can be selected to perform Step S22.

### <Step S23>

Next, in Step S23 shown in FIG. 21B, the materials ground and mixed in the above step are collected to give the additive element A source (A source). Note that the additive element A source in Step S23 contains a plurality of starting materials and can be referred to as a mixture.

As for the particle diameter of the mixture, its median diameter (D50) is preferably greater than or equal to 600 nm and less than or equal to 10 lam, further preferably greater than or equal to 1 μm and less than or equal to 5 μm. Also when one kind of material is used as the additive element source, the median diameter (D50) is preferably greater than or equal to 600 nm and less than or equal to 10 lam, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion 100a of the composite oxide after heating.

### <Step S21>

A process different from that in FIG. 21B is described with reference to FIG. 21C. In Step S21 shown in FIG. 21C, four kinds of additive element sources to be added to the lithium cobalt oxide are prepared. In other words, FIG. 21C is different from FIG. 21B in the kinds of the additive element sources. A lithium source may be prepared together with the additive element sources.

As the four kinds of additive element sources, a magnesium source (Mg source), a fluorine source (F source), a nickel source (Ni source), and an aluminum source (A1 source) are prepared. Note that the magnesium source and the fluorine source can be selected from the compounds and the like described with reference to FIG. 21B. As the nickel source, nickel oxide, nickel hydroxide, or the like can be used. As the aluminum source, aluminum oxide, aluminum hydroxide, or the like can be used.

### <Steps S22 and S23>

Step S22 and Step S23 shown in FIG. 21C are similar to the steps described with reference to FIG. 21B.

### <Step S31>

Next, in Step S31 shown in FIG. 21A, the lithium cobalt oxide and the additive element A source (A source) are mixed. The ratio of the number of cobalt (Co) atoms in the lithium cobalt oxide to the number of magnesium (Mg) atoms in the additive element A source (Co:Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for one hour. The mixing is performed in a dry room the dew point of which is higher than or equal to −100° C. and lower than or equal to −10° C.

### <Step S32>

Next, in Step S32 in FIG. 21A, the materials mixed in the above step are collected, whereby a mixture 903 is obtained. At the time of the collection, the materials may be crushed as needed and made to pass through a sieve.

Note that although FIGS. 21A to 21C show the formation method in which the addition of the additive element is performed after the initial heating, the present invention is not limited to the above-described method. The addition of the additive element may be performed at another timing or may be performed a plurality of times. The timing of the addition may be different between the additive elements.

For example, the additive element may be added to the lithium source and the cobalt source in Step S11, i.e., at the stage of the starting materials of the composite oxide, as shown in FIGS. 22A to 22C. FIG. 22A shows a process of adding the magnesium source to the lithium source and the cobalt source. FIG. 22B shows a process of adding the magnesium source and the aluminum source to the lithium source and the cobalt source. FIG. 22C shows a process of adding the magnesium source and the nickel source to the lithium source and the cobalt source. The additive element sources shown in FIGS. 22A to 22C are merely examples.

The process is followed by Steps S12 and S13, and the lithium cobalt oxide containing the additive element can be obtained in Step S14. The distribution of the additive element can be controlled by changing the timing of the addition of the additive element. The additive element added as shown in any of FIGS. 22A to 22C is expected to be located in the inner portion of the positive electrode active material 100. Steps S21 to S23 described above do not need to be performed separately from Steps S11 to S14 described above in the case where any of the processes shown in FIGS. 22A to 22C is employed, so that the method is simplified and enables increased productivity. Needless to say, another additive element may be added in Step S20 also in the case where any of the processes shown in FIGS. 22A to 22C is employed.

Alternatively, lithium cobalt oxide that contains some of the additive elements in advance may be used. When lithium cobalt oxide to which magnesium and fluorine are added is used, for example, part of the processes in Steps S11 to S14 and Step S20 can be skipped, so that the method is simplified and enables increased productivity.

Alternatively, after the heating in Step S15, to lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 shown in FIG. 21A, the mixture 903 is heated. Any of the heating conditions described for Step S13 can be selected for this heating. The heating time is preferably longer than or equal to two hours. Here, the pressure in a furnace may be higher than atmospheric pressure to make the oxygen partial pressure of the heating atmosphere high. An insufficient oxygen partial pressure of the heating atmosphere might cause reduction of cobalt or the like and prevent the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 650° C.

Needless to say, the reaction more easily proceeds at a temperature higher than or equal to the temperature at which one or more selected from the materials contained in the mixture 903 are melted. For example, in the case where LiF and MgF₂ are included as the additive element sources, the lower limit of the heating temperature in Step S33 is preferably higher than or equal to 742° C. because the eutectic point of LiF and MgF₂ is around 742° C. (see the eutectic point P in FIG. 10).

The mixture 903 obtained by mixing such that LiCoO₂:LiF:MgF₂=100:0.33:1 (molar ratio) exhibits an endothermic peak at around 830° C. in a DSC test. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C. Note that the heating temperature in Step S33 is preferably lower than that in Step S13.

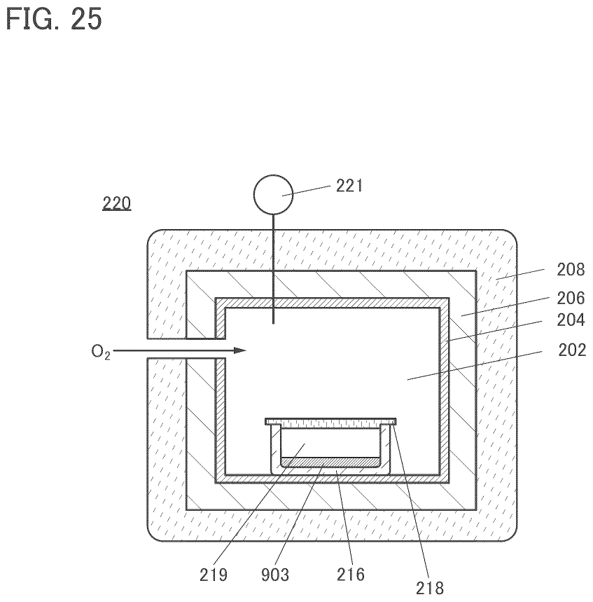

An example of the heating furnace used in Step S33 is described with reference to FIG. 25.

A heating furnace 220 illustrated in FIG. 25 includes a space 202 in the heating furnace, a hot plate 204, a pressure gauge 221, a heater unit 206, and a heat insulator 208. The heating is preferably performed with a container 216, which corresponds to a crucible or a sagger, covered with a lid 218. With this structure, the atmosphere in a space 219 enclosed by the container 216 and the lid 218 can contain a fluoride. During the heating, the state of the space 219 is maintained with the lid put on so that the concentration of the gasified fluoride inside the space 219 can be constant or cannot be reduced, in which case fluorine and magnesium can be contained in the vicinity of the particle surface of the mixture 903. The atmosphere in the space 219, which is smaller in capacity than the space 202 in the heating furnace, can contain a fluoride through volatilization of a smaller amount of fluoride. This means that the atmosphere in the reaction system can contain a fluoride without a significant reduction in the amount of fluoride included in the mixture 903. In addition, the use of the lid 218 allows heating of the mixture 903 in an atmosphere containing a fluoride to be simply and inexpensively performed.

Thus, before the heating in the space 202 in the heating furnace is performed, the step of providing an atmosphere containing oxygen in the space 202 in the heating furnace and the step of placing the container 216 in which the mixture 903 is placed in the space 202 in the heating furnace are performed. The steps in this order enable the mixture 903 to be heated in an atmosphere containing oxygen and a fluoride. For example, flowing of a gas is performed during the heating (flowing). The gas can be introduced from below the space 202 in the heating furnace and exhausted to above the space 202 in the heating furnace. During the heating, the space 202 in the heating furnace may be sealed off to be a closed space so that the gas is not transferred to the outside (purging).

Although there is no particular limitation on a method for providing an atmosphere containing oxygen in the space 202 in the heating furnace, examples of the method include a method in which air is exhausted from the space 202 in the heating furnace and an oxygen gas or a gas containing oxygen such as dry air is then introduced, and a method in which an oxygen gas or a gas containing oxygen such as dry air is fed into the space 202 in the heating furnace for a certain period of time. In particular, introducing an oxygen gas after exhausting air from the space 202 in the heating furnace (oxygen replacement) is preferably performed. Note that the air in the space 202 in the heating furnace may be regarded as an atmosphere containing oxygen.

The fluoride or the like attached to the inner walls of the container 216 and the lid 218 can be fluttered again by the heating to be attached to the mixture 903.

There is no particular limitation on the step of heating the heating furnace 220. The heating may be performed using a heating mechanism included in the heating furnace 220.

Although there is no particular limitation on the way of placing the mixture 903 in the container 216, as illustrated in FIG. 25, the mixture 903 is preferably placed such that the top surface of the mixture 903 is flat with respect to the bottom surface of the container 216, in other words, the level of the top surface of the mixture 903 is uniform.

The heating in Step S33 described above is preferably performed with the pressure in the furnace controlled using the pressure gauge 221. The furnace is preferably in an atmospheric pressure state or a pressurized state. Under pressure, for example, the surface of lithium cobalt oxide is probably melted. Accordingly, the surface of lithium cobalt oxide heated together with LiF and MgF₂ may be melted under pressure.

Cooling after the heating in Step S33 above can be performed by letting the mixture stand to cool, and the time it takes for the temperature to decrease to room temperature from a predetermined temperature is preferably longer than or equal to 10 hours and shorter than or equal to 50 hours; for example, the temperature falling rate is preferably higher than or equal to 80° C./h and low than or equal to 250° C./h, further preferably higher than or equal to 180° C./h and lower than or equal to 210° C./h. The cooling rate in Step S33 is preferably higher than that in Step S13. Cooling at a high cooling rate is referred to as rapid cooling. Performing rapid cooling after the above-described melting makes it possible to form a shell adequately. Specifically, it is possible to form a thin shell. Note that as long as the temperature becomes acceptable to the next step, the cooling is not necessarily continued until room temperature is reached.

In addition, at the time of heating the mixture 903, the partial pressure of fluorine or a fluorine compound originating from the fluorine source or the like is preferably controlled to be within an appropriate range. The partial pressure may be controlled by performing the heating in this step with the crucible covered with the lid. As described above, the lid can prevent volatilization or sublimation of a material. In other words, at the time when the temperature is raised and lowered in this step, the crucible is not necessarily sealed off with the lid as long as volatilization or sublimation of a material is prevented. For example, this step can be performed without sealing off the crucible in the case where the reaction chamber in which the crucible is put is filled with oxygen. A positive electrode active material containing fluorine or a fluorine compound in an appropriate manner is preferable because the positive electrode active material would inhibit ignition and smoking if an internal short circuit occurs.

In the formation method described in this embodiment, some of the materials, e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluorine compound having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The crucible is preferably covered with the lid so that volatilization of LiF is inhibited.

The heating in this step is preferably performed such that the particles of the mixture 903 are not adhered to each other. Adhesion of the particles of the mixture 903 during the heating might decrease the area of contact with oxygen in the atmosphere and block a path of diffusion of the additive element (e.g., fluorine), thereby hindering distribution of the additive element (e.g., magnesium and fluorine) in the surface portion. In order that a reaction with oxygen in the atmosphere can be promoted, the heating may be performed with the crucible not sealed off with the lid.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid in a manner similar to that of the crucible covered with the lid.

A supplementary explanation of the heating time is provided. The heating time depends on conditions such as the heating temperature and the particle size and composition of the lithium cobalt oxide obtained in Step S14. The heating may be preferably performed at a lower temperature or for a shorter time in the case where the particle size of the lithium cobalt oxide is small than in the case where the particle size is large.

In the case where the lithium cobalt oxide obtained in Step S14 in FIG. 21A has a median diameter (D50) of approximately 12 lam, the heating temperature is preferably higher than or equal to 650° C. and lower than or equal to 950° C., for example. The heating time is preferably longer than or equal to three hours and shorter than or equal to 60 hours, further preferably longer than or equal to 10 hours and shorter than or equal to hours, still further preferably approximately 20 hours, for example. Note that the time for lowering the temperature after the heating is preferably longer than or equal to hours and shorter than or equal to 50 hours, for example.

In the case where the lithium cobalt oxide obtained in Step S14 has a median diameter (D50) of approximately 5 μm, the heating temperature is preferably higher than or equal to 650° C. and lower than or equal to 950° C., for example. The heating time is preferably longer than or equal to one hour and shorter than or equal to 10 hours, further preferably approximately five hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 21A, in which crushing is performed as needed; thus, the positive electrode active material 100 is obtained. Here, the collected particles may be made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

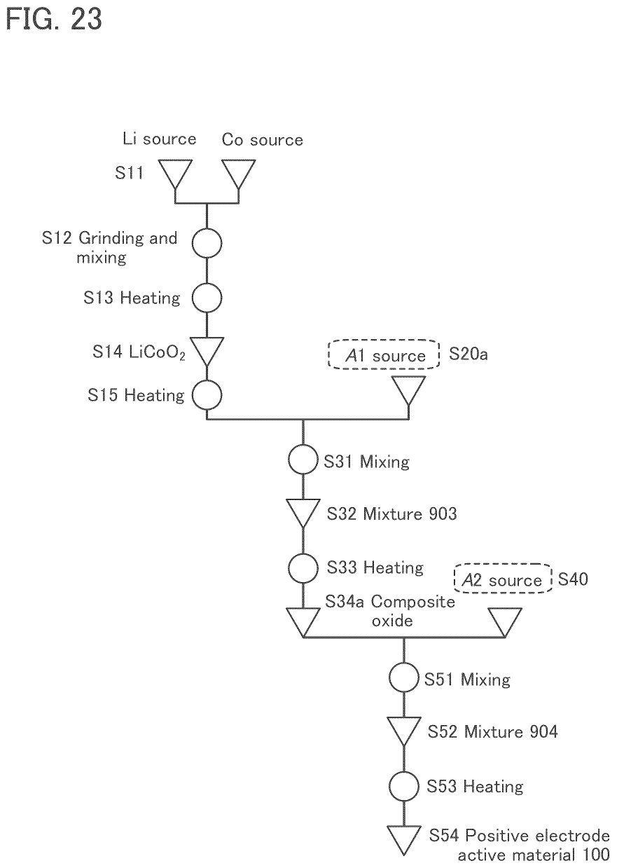

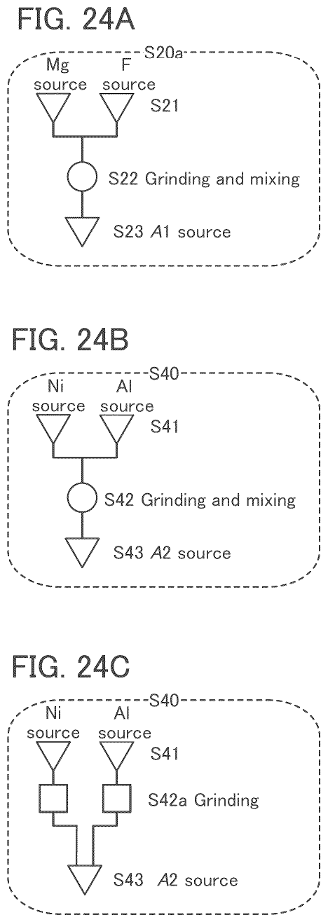

Next, as one embodiment of the present invention, a formation method 2 of a positive electrode active material, which is different from the formation method 1 of a positive electrode active material, is described with reference to FIG. 23 and FIG. 24A to 24C. The formation method 2 of a positive electrode active material is different from the formation method 1 mainly in the number of times of adding the additive element and a mixing method. For the description except for the above, the description of the formation method 1 of a positive electrode active material can be referred to.

Steps S11 to S15 in FIG. 23 are performed as in FIG. 21A to prepare lithium cobalt oxide that has been subjected to the initial heating.

### <Step S20a>

Next, in Step S20a, an additive element A1 source used to add an additive element A1 to the lithium cobalt oxide that has been subjected to the initial heating is prepared. The steps of preparing the additive element A1 source are described with reference to FIG. 24A.

### <Step S21>

Step S21 shown in FIG. 24A is described. The additive element A1 can be selected from the elements that are given as the examples of the additive element A described for Step S21 with reference to FIG. 21B. For example, one or more elements selected from magnesium, fluorine, and calcium can be suitably used as the additive element A1. FIG. 24A shows an example in which magnesium and fluorine are selected as the additive elements A1 and a magnesium source (Mg source) and a fluorine source (F source) are prepared in Step S21.

Steps S21 to S23 shown in FIG. 24A can be performed under conditions similar to those of Steps S21 to S23 shown in FIG. 21B, whereby the additive element A1 source (A1 source) can be obtained in Step S23.

Steps S31 to S33 shown in FIG. 23 can be performed in a manner similar to that of Steps S31 to S33 shown in FIG. 21A.

### <Step S34a>

Next, the material heated in Step S33 is collected to give lithium cobalt oxide containing the additive element A1. This composite oxide is called a second composite oxide to be distinguished from the composite oxide in Step S14.

### <Step S40>

In Step S40 shown in FIG. 23, an additive element A2 source used to add an additive element A2 to the second composite oxide is prepared. The steps of preparing the additive element A2 source are described with reference to FIGS. 24B and 24C.

### <Step S41>

Step S41 shown in FIG. 24B is described. The additive element A2 can be selected from the elements that are given as the examples of the additive element A described for Step S21 with reference to FIG. 21C. For example, one or more elements selected from nickel, titanium, boron, zirconium, and aluminum can be suitably used as the additive element A2. FIG. 24B shows an example in which nickel and aluminum are selected as the additive elements A2 and a nickel source (Ni source) and an aluminum source (A1 source) are prepared.

Steps S41 to S43 shown in FIG. 24B can be performed under conditions similar to those of Steps S21 to S23 shown in FIG. 21B, whereby the additive element A2 source (A2 source) can be obtained in Step S43.

FIG. 24C shows a modification example of the steps of preparing the additive element A2 source which are described with reference to FIG. 24B. A nickel source (Ni source) and an aluminum source (A1 source) are prepared in Step S41 shown in FIG. 24C and are separately ground in Step S42a. Accordingly, a plurality of the additive element A2 sources (A2 sources) are prepared in Step S43. FIG. 24C is different from FIG. 24B in separately grinding the additive elements in Step S42a.

### <Steps S51 to S54>

Next, Steps S51 to S54 shown in FIG. 23 can be performed under conditions similar to those of Steps S31 to S34 shown in FIG. 21A. In Step S52, a mixture 904 is obtained. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 23 and FIGS. 24A to 24C, in the formation method 2, introduction of the additive elements to the lithium cobalt oxide is separated into introduction of the additive element A1 and that of the additive element A2. When the additive elements are separately introduced, the additive elements can be at different positions in the depth direction, for example. The additive element A1 can be positioned such that its concentration is higher in the surface portion than in the inner portion, and the additive element A2 can be positioned such that its concentration is higher in the inner portion than in the surface portion, for example.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. Such an order of steps is preferred in order to maintain the smoothness of the surface achieved by the initial heating.

The positive electrode active material 100, whose surface is smooth, may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

This embodiment can be implemented in combination with any of the other embodiments.

### Embodiment 3

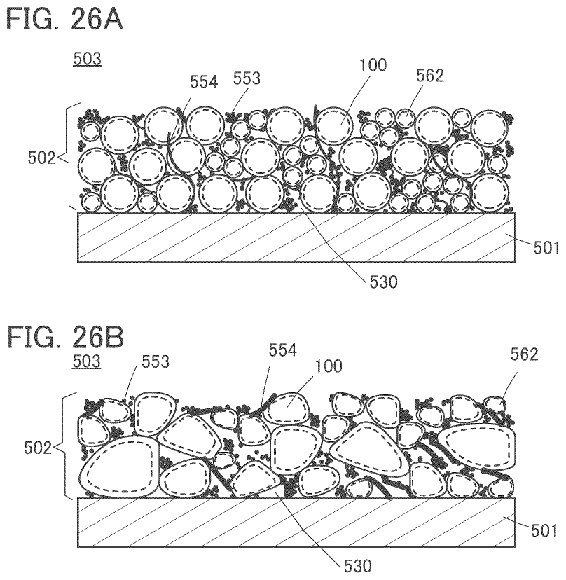

In this embodiment, examples of a secondary battery of one embodiment of the present invention are described with reference to FIGS. 26A and 26B.

### <Structure Example of Secondary Battery>

Hereinafter, a secondary battery in which a positive electrode, a negative electrode, and an electrolyte solution are stored in an exterior body is described as an example.

### [Positive Electrode]

FIG. 26A shows an example of a cross-sectional view of the positive electrode 503 included in the secondary battery 1004 or the like. The positive electrode 503 includes the positive electrode active material layer 502 over the positive electrode current collector 501. The positive electrode active material layer 502 includes the positive electrode active material 100, a positive electrode active material 562, the conductive material 553, a conductive material 554, and the electrolyte solution 530. The positive electrode active material layer 502 also includes a binder (not shown). In the secondary battery, either the conductive material 553 or the conductive material 554 may be omitted.

The median diameter (D50) of the positive electrode active material 100 is greater than or equal to 1 μm and less than or equal to 50 lam, preferably greater than or equal to 5 μm and less than or equal to 30 lam. To increase the filling density, the positive electrode active material 562 with a different median diameter (D50) is preferably added. The median diameter (D50) of the positive electrode active material 562 is preferably 1/10 to ⅙ of the median diameter (D50) of the positive electrode active material 100. When particle size distribution measurement is performed on an active material in which the positive electrode active material 100 and the positive electrode active material 562 are mixed, two peaks with different local maximum values are observed. Needless to say, two or more peaks may be observed. Note that the filling density can be increased without the positive electrode active material 562.

Each of the positive electrode active material 100 and the positive electrode active material 562 preferably includes a shell. A positive electrode active material that includes a shell can have a good insulating property and inhibits thermal runaway. Although the boundary between a surface portion and an inner portion is indicated by a dotted line in FIG. 26A, the boundary is not always as clear as that in FIG. 26A. The shell can have the structure shown in FIGS. 7A to 7H or the like. The positive electrode active materials are not limited to those shown in FIG. 26A and for example, a structure may be employed in which either the positive electrode active material 100 or the positive electrode active material 562 includes the shell.

The positive electrode active material 100 and the positive electrode active material 562 may have the same composition or different compositions. In the case where the above positive electrode active materials have the same composition, they have common main components but may be different from each other in the presence or absence of an additive element or the like. In the case where the above positive electrode active materials have different compositions, the positive electrode active materials may be different from each other in their main components.

As already described above, it is preferable that the positive electrode active material 100 and the positive electrode active material 562 contain an additive element, and it is particularly preferable that their shells contain an additive element. The additive element may be unevenly distributed in the shell or distributed in the inner portion to have a low concentration. The uneven distribution means uneven or localized presence of the additive element. A state where the concentration of the additive element increases from an inner portion toward a shell is sometimes described as uneven distribution of the additive element in the shell. The uneven distribution may be described as segregation or precipitation.

The additive element may be in the surface portion. The concentration of the additive element in the surface portion is preferably different from the concentration of the additive element in the inner portion. The concentration of the additive element in the surface portion is preferably higher than the concentration of the additive element in the inner portion. This state is sometimes described as uneven distribution of the additive element in the surface portion.

Although sometimes referred to as positive electrode active material particles, the positive electrode active material 100 and the positive electrode active material 562 may be in any of a variety of forms other than a particulate form. In FIG. 26B, the positive electrode 503 includes a positive electrode active material in a form other than a particulate form, unlike in FIG. 26A. The positive electrode active material in FIG. 26B is the same as that in FIG. 26A except for its form and is thus not further described.

Although illustrated as primary particles in FIG. 26A and FIG. 26B, the positive electrode active material 100 and the positive electrode active material 562 may be secondary particles. In this specification, the primary particle refers to a particle (lump) as a minimum unit in which no grain boundary is observed at a magnification of 5000 times, for example, with a scanning electron microscope (SEM) or the like. That is, the primary particle is a particle as a minimum unit. The secondary particle refers to a particle in which the primary particles aggregate, partially sharing the grain boundary (the circumference of the primary particle or the like), and which is independent of another particle. That is, the secondary particle has a grain boundary. The surface portion of the secondary particle may be the surface portion of the entire secondary particle or the surface portion of a primary particle constituting the secondary particle.

A positive electrode includes a positive electrode active material layer and a positive electrode current collector. The positive electrode active material layer includes a positive electrode active material, and may include a conductive material (which can be rephrased as a conductive additive) and a binder. As the positive electrode active material, the positive electrode active material formed by the formation method described in the above embodiment can be used, and for example, a mixture of a positive electrode active material having a relatively small median diameter (D50) and a positive electrode active material having a relatively large median diameter (D50) may be used.

The positive electrode active material described in any of the above embodiments and another positive electrode active material may be mixed to be used.

Examples of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, a mixture of lithium nickel oxide (LiNiO₂ or LiNi₁₋ₓMₓO₂ (0<x<1) (M=Co, Al, or the like)) and a lithium-containing material with a spinel crystal structure which contains manganese such as LiMn₂O₄ is preferably used, because the characteristics of the secondary battery including such a material can be improved.

As the another positive electrode active material, a lithium-manganese composite oxide that can be represented by a compositional formula LiₐMn_{b}McO_{d} can be used. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26≤(b+c)/d<0.5. Note that the proportions of metals, silicon, phosphorus, and other elements in the whole particles of a lithium-manganese composite oxide can be measured by, for example, ICP-MS. The proportion of oxygen in the whole particle of a lithium-manganese composite oxide can be measured by, for example, EDX. Alternatively, the proportion of oxygen can be measured by ICP-MS combined with fusion gas analysis and valence evaluation of X-ray absorption fine structure (XAFS) analysis. Note that the lithium-manganese composite oxide is an oxide containing at least lithium and manganese, and may contain one or more elements selected from chromium, cobalt, aluminum, nickel, iron, magnesium, molybdenum, zinc, indium, gallium, copper, titanium, niobium, silicon, phosphorus, and the like.

### [Conductive Material]

The conductive material has a function of giving aid to, for example, a current path between the active material and the current collector or a current path between a plurality of the active materials. In order to have such a function, the conductive material preferably contains a material having lower resistance than the active material. The conductive material is also referred to as a conductive additive or a conductivity-imparting agent because of its function.

As the conductive material, a carbon material or a metal material is typically used. The conductive material is in a particulate form; examples of the particulate conductive material include carbon black (e.g., furnace black, acetylene black, or graphite). Carbon black often has a smaller particle diameter than a positive electrode active material. Some conductive materials are in a fibrous form; examples of the fibrous conductive material include carbon nanotube (CNT) and VGCF (registered trademark). Other conductive materials are in a sheet form; examples of the sheet-shaped conductive material include multilayer graphene. The sheet-shaped conductive material sometimes looks like a thread in observation of a cross section of a positive electrode.

The particulate conductive material can enter a gap between, for example, positive electrode active materials, and easily aggregates. Thus, the particulate conductive material can give aid to a conductive path between positive electrode active materials provided close to each other. Although having a bent region, the fibrous conductive material is larger than a positive electrode active material. The fibrous conductive material can thus give aid to not only a conductive path between adjacent positive electrode active materials but also a conductive path between positive electrode active materials that are apart from each other. Conductive materials in two or more forms as described above are preferably mixed.

In the case where multilayer graphene as a sheet-shaped conductive material and carbon black as a particulate conductive material are used, the weight of the carbon black is preferably greater than or equal to 1.5 times and less than or equal to 20 times, further preferably greater than or equal to twice and less than or equal to 9.5 times that of the multilayer graphene in a slurry in which the carbon black and the multilayer graphene are mixed.

When the mixing ratio between the multilayer graphene and the carbon black is in the above range, the carbon black does not aggregate and is easily dispersed. When the mixing ratio between the multilayer graphene and the carbon black is in the above range, the electrode density can be higher than when only the carbon black is used as a conductive material. A higher electrode density leads to higher capacity per unit weight.

Moreover, when the mixing ratio between the multilayer graphene and the carbon black is in the above range, rapid charging is possible.

Graphene in this specification and the like includes multilayer graphene. In other words, graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. Examples of a graphene compound include graphene oxide, multilayer graphene oxide, reduced graphene oxide, reduced multilayer graphene oxide, and graphene quantum dots. In other words, a graphene compound may include a functional group. Graphene or a graphene compound is preferably bent. Graphene or a graphene compound may be rolled and rolled graphene is sometimes referred to as carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

As a graphene compound, fluorine-containing graphene may be used. The fluorine-containing graphene can be formed by making graphene and a fluorine compound contact each other (which is called fluoridation treatment). The fluoridation treatment is preferably performed using fluorine (F₂) or a fluorine compound. The fluorine compound is preferably hydrogen fluoride, a halogen fluoride (e.g., ClF₃ or IF₅), a gaseous fluoride (BF₃, NF₃, PF₅, SiF₄, or SF₆), a metal fluoride (LiF, NiF₂, AlF₃, or MgF₂), or the like. The fluoridation treatment is preferably performed using a gaseous fluoride, which may be diluted with an inert gas. The fluoridation treatment is preferably performed in the temperature range of 0° C. to 250° C., which includes room temperature. Performing the fluoridation treatment at higher than or equal to 0° C. enables adsorption of fluorine onto the surface of graphene.

A graphene compound sometimes has excellent electrical characteristics of high conductivity and excellent physical properties of high flexibility and high mechanical strength. A graphene compound has a sheet-like shape. A graphene compound has a curved surface in some cases, thereby enabling low-resistance surface contact. Furthermore, a graphene compound sometimes has extremely high conductivity even with a small thickness, and thus a small amount of a graphene compound allows a conductive path to be efficiently formed in an active material layer. Hence, the use of the graphene compound as a conductive material can increase the area where the active material and the conductive material are in contact with each other. The graphene compound preferably covers 80% or more of the area of the active material. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. A graphene compound may have a hole.

In the case where active material particles with a small diameter (e.g., 1 μm or less) are used, more conductive paths for the active material particles are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to be rapidly charged and discharged in some cases. In addition, a mobile electronic device or the like is required to have fast charge characteristics in some cases. Fast charging and discharging are referred to as charging and discharging at, for example, 200 mA/g, 400 mA/g, or 1000 mA/g or more.

As illustrated in FIG. 26B, in a longitudinal cross section of the positive electrode active material layer 502, sheet-shaped graphene or a sheet-shaped graphene compound is substantially uniformly dispersed in the positive electrode active material layer 502. The graphene or the graphene compound is schematically shown by the thick line in FIG. 26B but is actually a thin film having a thickness corresponding to the thickness of a single layer or a multi-layer of carbon molecules. A plurality of sheets of the graphene or graphene compound are formed to partly coat or adhere to surfaces of a plurality of particles of the positive electrode active material 100, so that the plurality of sheets of the graphene or graphene compound make surface contact with the particles of the positive electrode active material 100.

Here, the plurality of sheets of the graphene or graphene compound can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the discharge capacity of the secondary battery can be increased.

Here, it is preferable to perform reduction after a layer to be the positive electrode active material layer 502 is formed by using graphene oxide as the graphene or the graphene compound and mixing the graphene oxide with an active material. That is, the formed active material layer preferably contains reduced graphene oxide. When graphene oxide with extremely high dispersibility in a polar solvent is used for the formation of the graphene or the graphene compound, the graphene or the graphene compound can be substantially uniformly dispersed in the positive electrode active material layer 502. The solvent is removed by volatilization from a dispersion medium in which the graphene oxide is uniformly dispersed, and the graphene oxide is reduced; hence, the sheets of the graphene or graphene compound remaining in the positive electrode active material layer 502 partly overlap with each other and are dispersed such that surface contact is made, thereby forming a three-dimensional conductive path. Note that the graphene oxide can be reduced by heat treatment or with the use of a reducing agent, for example.

Unlike a particulate conductive material, such as acetylene black, which makes point contact with an active material, the graphene and the graphene compound are capable of making low-resistance surface contact; accordingly, the amount of conductive material necessary for certain electrical conduction between the particles of the positive electrode active material 100 and the conductive material is smaller when the graphene or the graphene compound is used as the conductive material than when a normal conductive material is used. Thus, the use of the graphene or the graphene compound allows increasing the proportion of the positive electrode active material 100 in the positive electrode active material layer 502, resulting in increased discharge capacity of the secondary battery.

Alternatively, the graphene compound as the conductive material can be formed in advance with a spray dry apparatus as a coating portion to cover the whole of the active material, and a conductive path between the active material particles can be formed using the graphene compound.

A material used in the formation of the graphene compound may be mixed in the positive electrode active material layer 502 together with the graphene compound. For example, particles used as a catalyst in the formation of the graphene compound may be mixed with the graphene compound. As an example of the catalyst in the formation of the graphene compound, particles containing any of silicon oxide (SiO₂ or SiO), (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

As the conductive material, acetylene black (referred to as AB) can be used instead of graphene. Furthermore, fluorine-containing acetylene black may be used. The fluorine-containing acetylene black can be formed by making acetylene black and a fluorine compound contact each other (which is called fluoridation treatment). The description of the fluoridation treatment for graphene can be applied to the fluoridation treatment for acetylene black.

As the conductive material, a carbon fiber material (referred to as carbon nanotube or CNT) can be used instead of graphene and acetylene black. Furthermore, fluorine-containing carbon nanotube may be used. The fluorine-containing carbon nanotube can be formed by making carbon nanotube and a fluorine compound contact each other (which is called fluoridation treatment). The description of the fluoridation treatment for graphene can be applied to the fluoridation treatment for carbon nanotube.

### [Binder]

The binder, which does not cover the entire surface of the active material, is necessary for enhancing adhesion of the active material in powder form. The binder needs to have a property of adhering to the current collector. In other words, the binder is preferably a material containing an adhering component. Furthermore, it is preferable that the binder be sufficiently flexible and resilient to a change in the state of the active material, in view of expansion of the active material. The binder also needs to be compatible with the electrolyte solution. Moreover, since a secondary battery involves an extremely strong oxidation reaction and an extremely strong reduction reaction, it is desirable that the binder not be degraded by the reactions or be less reactive to the reactions.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, a water-soluble polymer is preferably used. As the water-soluble polymer, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as the binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of the electrolyte solution at a potential at which a battery reaction occurs when the passivation film is formed on the active material surface, for example. It is preferred that the passivation film can conduct lithium ions while suppressing electrical conduction.

### [Current Collector]

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 lam.

### [Negative Electrode]

The negative electrode includes a negative electrode active material layer and a negative electrode current collector. The negative electrode active material layer may contain a conductive material and a binder.

### [Negative Electrode Active Material]

As the negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or more selected from silicon, tin, gallium, aluminum, germanium, lead, antimony, bismuth, silver, zinc, cadmium, indium, and the like can be used. Such elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably is 1 or an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into the graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Still alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N is preferable because of its high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorine compounds such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

As one mode of an electrolyte, an electrolyte solution containing a solvent and an electrolyte dissolved in the solvent (also referred to as an organic electrolyte) can be used. The electrolyte solution contains the solvent and a lithium salt. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used, or two or more of these solvents can be used in an appropriate combination at an appropriate ratio.

As an organic solvent containing ethylene carbonate (EC) and diethyl carbonate (DEC) in the electrolyte solution, it is possible to use a mixed organic solvent in which the volume ratio between EC and DEC is x:100−x (where 20≤x≤40) on the assumption that EC and DEC account for 100 vol %. More specifically, a mixed organic solvent containing EC and DEC at EC:DEC=30:70 in a volume ratio can be used.

As an organic solvent containing ethylene carbonate (EC), ethyl methyl carbonate (EMC), and dimethyl carbonate (DMC) in the electrolyte solution, it is possible to use a mixed organic solvent in which the volume ratio between EC, EMC, and DMC is x:y:100−x−y (where 5≤x≤35 and 0<y<65) on the assumption that EC, EMC, and DMC account for 100 vol %. More specifically, a mixed organic solvent containing EC, EMC, and DMC at EC:EMC:DMC=30:35:35 in a volume ratio can be used.

As the organic solvent contained in the electrolyte solution, a mixed organic solvent containing a fluorinated cyclic carbonate or a fluorinated linear carbonate can be used. The above mixed organic solvent preferably contains both a fluorinated cyclic carbonate and a fluorinated linear carbonate. A fluorinated cyclic carbonate and a fluorinated linear carbonate are preferred because they each include a substituent with an electron-withdrawing property and thereby lower the solvation energy of a lithium ion. Accordingly, a fluorinated cyclic carbonate and a fluorinated linear carbonate are suitable for the electrolyte solution and a mixed organic solvent containing these carbonates are preferable.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low.

Structural Formula (H10) below represents FEC. The substituent with an electron-withdrawing property in FEC is an F group.

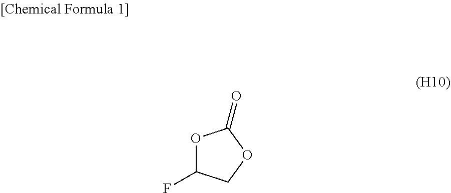

An example of the fluorinated linear carbonate is methyl 3,3,3-trifluoropropionate. Structural Formula (H22) below represents methyl 3,3,3-trifluoropropionate. An abbreviation of methyl 3,3,3-trifluoropropionate is MTFP. The substituent with an electron-withdrawing property in MTFP is a CF₃ group.

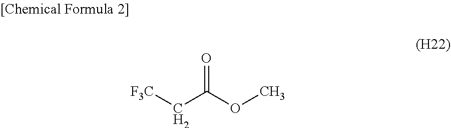

FEC, which is a cyclic carbonate, has a high dielectric constant and thus has an effect of promoting dissociation of a lithium salt when used in an organic solvent. Moreover, because of including the substituent with an electron-withdrawing property, FEC is readily bonded to a lithium ion by coulomb force or the like. Specifically, the solvation energy of a lithium ion is lower in FEC than in ethylene carbonate (EC), which does not include a substituent with an electron-withdrawing property; thus, FEC easily solvates a lithium ion. In addition, FEC is presumed to have a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or preventing the viscosity at room temperature (typically, 25° C.) from increasing even at low temperatures (typically, 0° C.). Furthermore, the solvation energy is lower in MTFP than in methyl propionate (abbreviation: MP), which does not include a substituent with an electron-withdrawing property, and thus, MTFP may solvate a lithium ion when used for the electrolyte solution.

FEC and MTFP having the above-described physical properties are preferably mixed such that the volume ratio between FEC and MTFP is x:100−x (where 5≤x≤30, preferably 10×20) on the assumption that a mixed organic solvent containing FEC and MTFP accounts for 100 vol %. In other words, MTFP and FEC are preferably mixed such that the amount of MTFP is larger than that of FEC in the mixed organic solvent.

Alternatively, the use of one or more ionic liquids (room temperature molten salts) that are unlikely to burn and volatize as the solvent of the electrolyte solution can prevent the secondary battery from exploding and/or igniting even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### [Lithium Salt]

As the lithium salt (also referred to as electrolyte) dissolved in the above-described solvent, one of lithium salts such as LiPF₆, LiClO₄, LiAsF₆, LiBF₄, LiAlCl₄, LiSCN, LiBr, LiT, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio. The lithium salt is preferably at greater than or equal to 0.5 mol/L and less than or equal to 3.0 mol/L with respect to the solvent. Using a fluoride such as LiPF₆ or LiBF₄ enables a lithium-ion secondary battery to have improved safety.

The above electrolyte solution is preferably highly purified and contains a small number of dust particles or elements other than the constituent elements of the electrolyte solution (hereinafter, also simply referred to as impurities). Specifically, the weight ratio of impurities to the electrolyte solution is less than or equal to 1 wt %, preferably less than or equal to 0.1 wt %, further preferably less than or equal to 0.01 wt %.

### [Additive Agent]

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the material to be added in the whole solvent is, for example, higher than or equal to 0.1 wt % and lower than or equal to 5 wt %. VC and LiBOB are particularly preferable because they facilitate formation of a favorable coating portion.

### [Gel Electrolyte]

A polymer gel obtained by swelling a polymer with an electrolyte solution may be used as a gel electrolyte. When a polymer gel electrolyte is used, a semisolid electrolyte layer can be obtained, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Solid Electrolyte]

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may alternatively be used. When the solid electrolyte is used, a separator and/or a spacer is/are not necessary. Furthermore, the battery can be entirely solidified; therefore, there is no possibility of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator in high-voltage charging can be suppressed and thus the reliability of the secondary battery can be improved. When the separator is coated with the fluorine-based material, the separator is easily brought into close contact with the electrode, resulting in high output characteristics. When the separator is coated with the polyamide-based material, in particular, aramid, heat resistance is improved; thus, the safety of the secondary battery is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the discharge capacity per volume of the secondary battery can be increased because the safety of the secondary battery can be maintained even when the total thickness of the separator is small.

### [Exterior Body]

For the exterior body of the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. An aluminum-containing film having a three-layer structure is sometimes referred to as an aluminum laminate film.

This embodiment can be implemented in combination with any of the other embodiments.

### Embodiment 4

This embodiment specifically describes examples of a secondary battery with a shape different from that of the laminated secondary battery described in the above embodiment.

### <Coin-Type Secondary Battery>

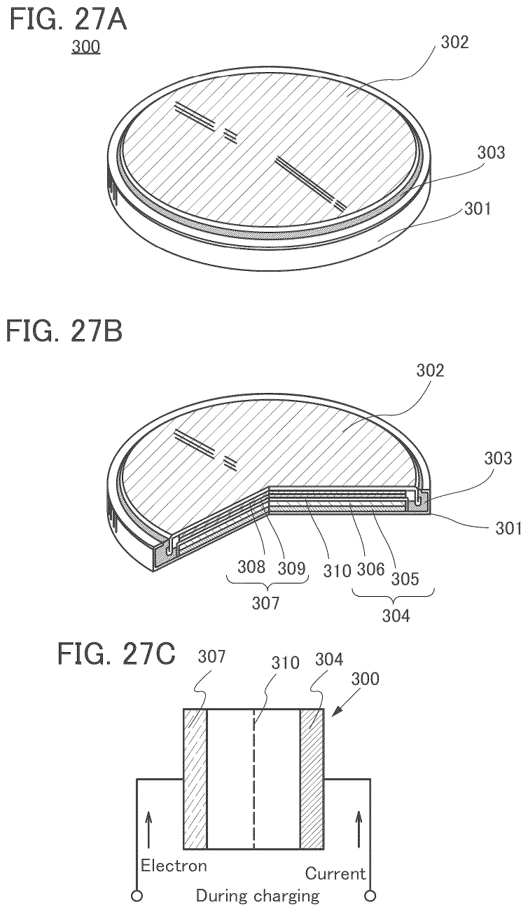

First, an example of a coin-type secondary battery is described. FIG. 27A is an external view of a coin-type (single-layer flat-type) secondary battery, and FIG. 27B is a cross-sectional view thereof. Coin-type secondary batteries are mainly used in small electronic devices. In this specification and the like, coin-type batteries include button-type batteries.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. Between the positive electrode 304 and the negative electrode 307 is provided a separator 310.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, and/or an alloy of such a metal and another metal (e.g., stainless steel) can be used. The positive electrode can 301 and the negative electrode can 302 are preferably covered with nickel and/or aluminum, for example, in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 27B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In this manner, the coin-type secondary battery 300 is fabricated.

When the positive electrode active material described in the above embodiment is used in the positive electrode 304, the coin-type secondary battery 300 can have high discharge capacity and excellent cycle performance.

Here, a current flow in charging a secondary battery is described with reference to FIG. 27C. When a secondary battery including lithium is regarded as a closed circuit, lithium ions move and a current flows in the same direction. Note that in the secondary battery including lithium, an anode and a cathode change places in charging and discharging, and an oxidation reaction and a reduction reaction occur on the corresponding sides; hence, an electrode with a high reaction potential is called a positive electrode and an electrode with a low reaction potential is called a negative electrode. For this reason, in this specification, the positive electrode is referred to as a “positive electrode” or a “plus electrode” and the negative electrode is referred to as a “negative electrode” or a “minus electrode” in all the cases where charging is performed, discharging is performed, a reverse pulse current is supplied, and a charge current is supplied. The use of the terms “anode” and “cathode”, which are related to an oxidation reaction and a reduction reaction, might cause confusion because the anode and the cathode change places at the time of charging and discharging. Therefore, the terms “anode” and “cathode” are not used in this specification. If the term “anode” or “cathode” is used, whether it is at the time of charging or discharging is noted, as well as whether the term corresponds to a positive (plus) electrode or a negative (minus) electrode.

A charger is connected to the two terminals in FIG. 27C, and the secondary battery 300 is charged. As the charging of the secondary battery 300 proceeds, a potential difference between the electrodes increases.

### <Cylindrical Secondary Battery>

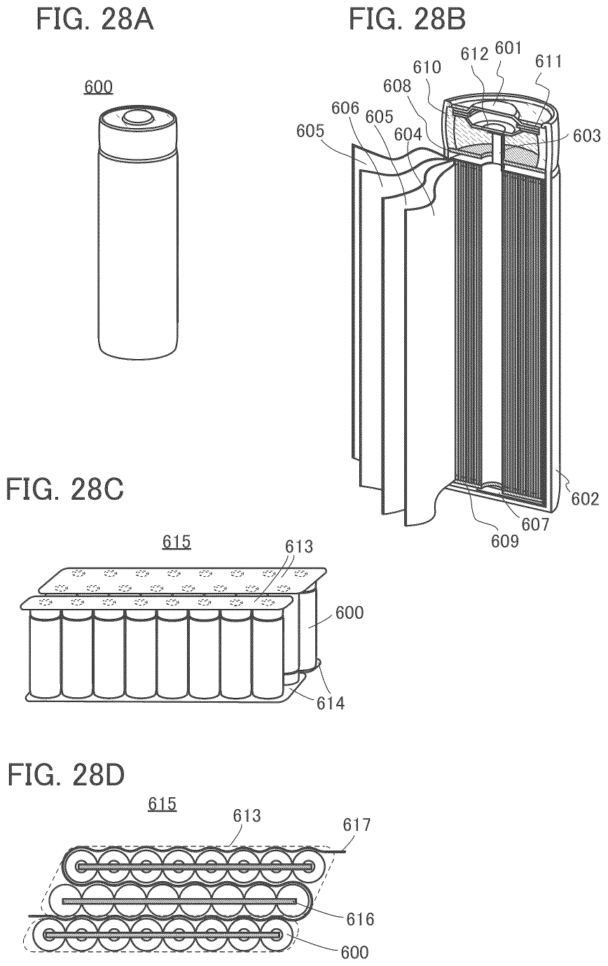

Next, an example of a cylindrical secondary battery is described with reference to FIGS. 28A to 28D. FIG. 28A is an external view of a cylindrical secondary battery 600. FIG. 28B is a schematic cross-sectional view of the cylindrical secondary battery 600. As illustrated in FIG. 28B, the cylindrical secondary battery 600 includes a positive electrode cap (battery lid) 601 on the top surface and a battery can (outer can) 602 on the side and bottom surfaces. The positive electrode cap 601 and the battery can 602 are insulated from each other by a gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a center pin. One end of the battery can 602 is close and the other end thereof is open. For the battery can 602, a metal having corrosion resistance to an electrolyte solution, such as nickel, aluminum, or titanium, an alloy of such a metal, and/or an alloy of such a metal and another metal (e.g., stainless steel) can be used. The battery can 602 is preferably covered with nickel and/or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

As illustrated in FIG. 28C, a plurality of the secondary batteries 600 may be sandwiched between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 28D is a top view of the module 615. The conductive plate 613 is shown by the dotted line for clarity of the drawing. As illustrated in FIG. 28D, the module 615 may include a conductive wire 616 that electrically connects the plurality of secondary batteries 600 to each other. The conductive plate 613 can be provided over and overlap with the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is unlikely to be influenced by the outside temperature. A heating medium included in the temperature control device 617 preferably has an insulating property and incombustibility.

When the positive electrode active material described in the above embodiment is used in the positive electrode 604, the cylindrical secondary battery 600 can have high discharge capacity and excellent cycle performance.

### <Wound Secondary Battery>

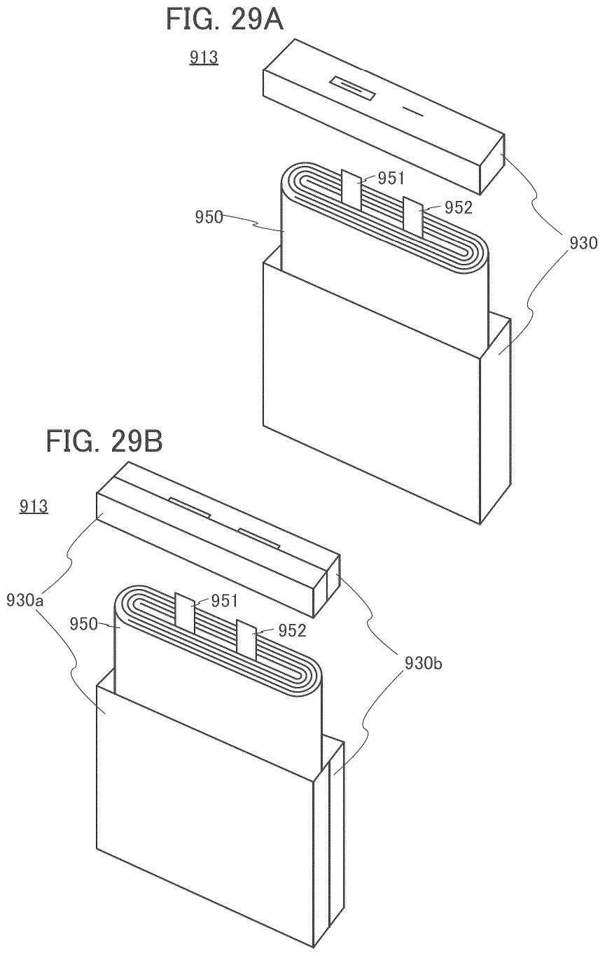

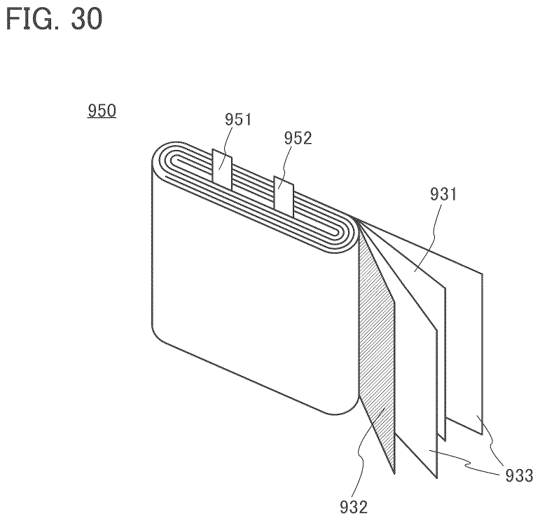

A structure example of a wound secondary battery 913 is described with reference to FIGS. 29A and 29B and FIG. 30.

The secondary battery 913 illustrated in FIG. 29A includes a wound body 950 provided with the terminals 951 and 952 inside a housing 930. The wound body 950 is immersed in an electrolyte solution inside the housing 930. The terminal 952 is in contact with the housing 930. An insulator or the like prevents contact between the terminal 951 and the housing 930. Note that in FIG. 29A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 29B, the housing 930 in FIG. 29A may be formed using a plurality of materials. For example, in the secondary battery 913 in FIG. 29B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 30 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be overlaid.

When the positive electrode active material described in the above embodiment is used in the positive electrode 932, the secondary battery 913 can have high discharge capacity and excellent cycle performance.

This embodiment can be implemented in appropriate combination with any of the other embodiments.

### Embodiment 5

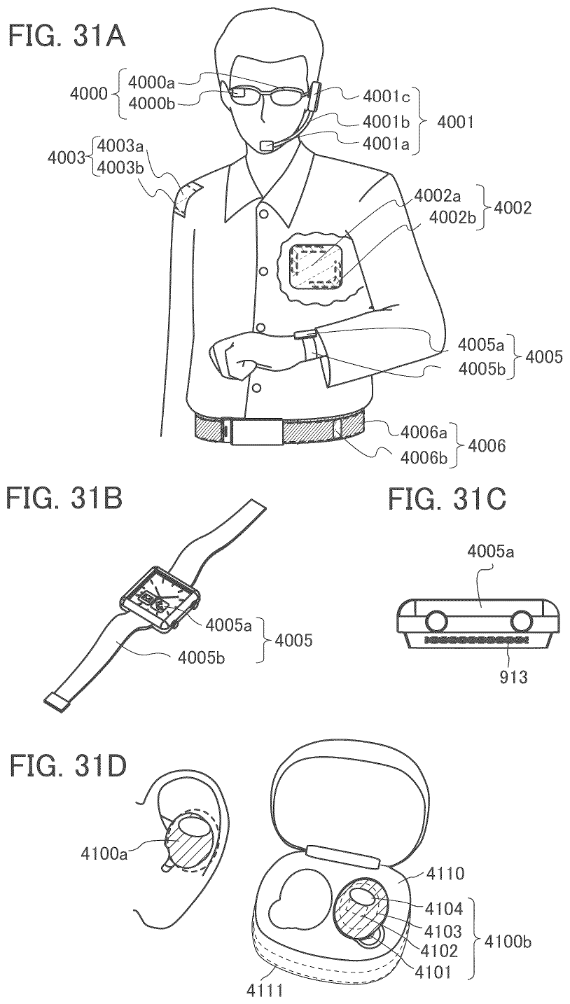

In this embodiment, examples of electronic devices each including the secondary battery described in the above embodiment are described with reference to FIGS. 31A to 31D, FIGS. 32A to 32C, and FIGS. 33A to 33C.

FIG. 31A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 31A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 31B is a perspective view of the watch-type device 4005 that is detached from an arm.

FIG. 31C is a side view. FIG. 31C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 31D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charging, and the like. Each of the earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charging. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in each of the earphone body 4100a and the earphone body 4100b can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

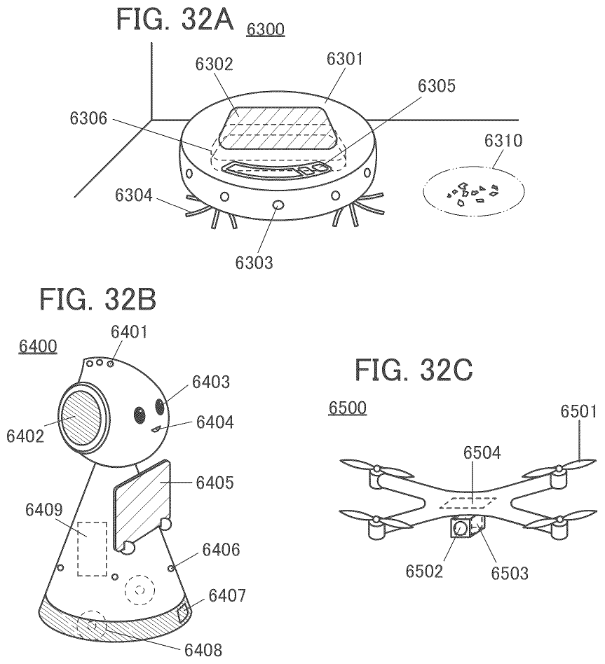

FIG. 32A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 32B illustrates an example of a robot. A robot 6400 illustrated in FIG. 32B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 32C illustrates an example of a flying object. A flying object 6500 illustrated in FIG. 32C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 6

In this embodiment, examples of vehicles each including the secondary battery of one embodiment of the present invention are described.

The use of secondary batteries in vehicles enables production of next-generation clean energy vehicles such as hybrid vehicles (HV), electric vehicles (EV), and plug-in hybrid vehicles (PHV).

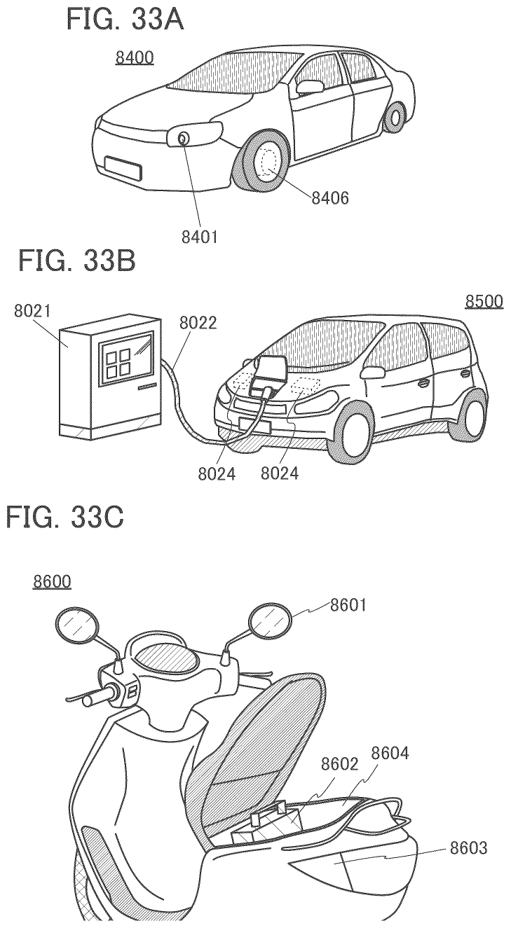

FIGS. 33A to 33C each illustrate an example of a vehicle including the secondary battery of one embodiment of the present invention. An automobile 8400 illustrated in FIG. 33A is an electric vehicle that runs on the power of an electric motor. Alternatively, the automobile 8400 is a hybrid vehicle capable of driving using either an electric motor or an engine as appropriate. The use of one embodiment of the present invention allows fabrication of a high-mileage vehicle. The automobile 8400 includes the secondary battery. As the secondary battery, the modules of the secondary batteries illustrated in FIGS. 28C and 28D can be arranged to be used in a floor portion in the automobile. Alternatively, a battery pack in which a plurality of the secondary batteries each of which is illustrated in FIGS. 29A and 29B are combined may be placed in the floor portion in the automobile. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 33B illustrates an automobile 8500 including the secondary battery. The automobile 8500 can be charged when the secondary battery is supplied with electric power from external charging equipment by a plug-in system and/or a contactless power feeding system, for example. In FIG. 33B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from the outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 33C shows an example of a motorcycle including the secondary battery of one embodiment of the present invention. A motor scooter 8600 illustrated in FIG. 33C includes a secondary battery 8602, side mirrors 8601, and indicators 8603. The secondary battery 8602 can supply electric power to the indicators 8603.

In the motor scooter 8600 illustrated in FIG. 33C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

### [Nail Penetration Test]

A nail penetration test as a safety test was conducted on a battery including the positive electrode active material of one embodiment of the present invention. A method for fabricating the battery subjected to the test is described below.

### <Formation 1 of Positive Electrode Active Material>

The positive electrode active material (Sample 1-1) formed in this example is described with reference to the formation method in FIG. 23 and FIGS. 24A to 24C.

As the LiCoO₂ in Step S14 in FIG. 23, commercially available lithium cobalt oxide (Cellseed C-10N produced by NIPPON CHEMICAL INDUSTRIAL CO., LTD.) containing cobalt as the transition metal M and no additive element was prepared and sieved by an automatic sieving machine. As the initial heating in Step S15, heating was performed on this lithium cobalt oxide put in a sagger covered with a lid, in a roller hearth kiln simulator furnace (produced by NORITAKE CO., LIMITED) as a baking furnace at 850° C. for two hours. Air (compressed air which was sufficiently dried) was made to flow in the furnace at 10 L/min. Specifically, the width of an opening of an outlet was adjusted such that a differential pressure gauge read 5 Pa. Cooling in the furnace was performed at a rate of 200° C./h, with the air keeping on flowing until the temperature reached 200° C.

In this example, Mg, F, Ni, and A1 were separately added as the additive elements in accordance with Step S21 and Step S41 shown in FIG. 24A and FIG. 24C. First, in accordance with Step S21 shown in FIG. 24A, LiF and MgF₂ were prepared as the F source and the Mg source, respectively. The LiF and MgF₂ were weighed such that LiF:MgF₂=1:3 (molar ratio), and sieved by an automatic sieving machine. Then, the LiF and MgF₂ were mixed in dehydrated acetone at a rotational speed of 500 rpm for hours to give an additive element source (A1 source).

Then, in Step S31, the A1 source and the lithium cobalt oxide subjected to the initial heating were weighed such that the magnesium of the A1 source was 1 mol % with respect to the cobalt, and were mixed by a dry method. The resulting mixture was stirred using a picobond (produced by HOSOKAWA MICRON CORPORATION) at a rotational speed of 3000 rpm for 10 minutes and sieved by an automatic sieving machine to give the mixture 903 (Step S32).

Subsequently, in Step S33, the mixture 903 was heated. The heating was performed at 900° C. for 20 hours. During the heating, the mixture 903 was in a sagger covered with a lid. Covering the sagger with the lid makes it possible that the sagger is filled with an atmosphere containing oxygen and the leakage of the oxygen is blocked (O2 purging). During the heating performed at the above heating temperature, the sagger was in a roller hearth kiln simulator furnace (produced by NORITAKE CO., LIMITED). Oxygen was made to flow at 10 L/min in the furnace (O2 flowing). Specifically, the width of an opening of an outlet was adjusted such that a differential pressure gauge read 5 Pa (the pressure in the furnace was positive). Cooling in the furnace was performed at a rate of 200° C./h, with oxygen keeping on flowing until the temperature reached 200° C. Accordingly, a composite oxide containing Mg and F was obtained (Step S34a).

Then, in Step S51, the composite oxide and the additive element sources (the A2 sources) were mixed. Nickel hydroxide on which a grinding step was performed was prepared as the nickel source and aluminum hydroxide on which a grinding step was performed was prepared as the aluminum source in accordance with Steps S41 to S43 shown in FIG. 24C, so that the additive element sources (the A2 sources) were obtained. The nickel hydroxide, the aluminum hydroxide, and the composite oxide were weighed such that the nickel in the nickel hydroxide and the aluminum in the aluminum hydroxide were each 0.5 mol % with respect to the cobalt, and the nickel hydroxide, the aluminum hydroxide, and the composite oxide were mixed by a dry method. The resulting mixture was stirred using a picobond (produced by HOSOKAWA MICRON CORPORATION) at a rotational speed of 3000 rpm for 10 minutes to give the mixture 904 (Step S52).

Subsequently, in Step S53, the mixture 904 was heated. The heating was performed at 850° C. for 10 hours. During the heating, the mixture 904 was in a sagger covered with a lid. During the heating performed at the above heating temperature, the sagger was in a roller hearth kiln simulator furnace (produced by NORITAKE CO., LIMITED). Oxygen was made to flow at 10 L/min in the furnace (O2 flowing). The width of an opening of an outlet was adjusted such that a differential pressure gauge read 5 Pa. Cooling in the furnace was performed at a rate of 200° C./h, with oxygen keeping on flowing until the temperature reached 200° C. Thus, lithium cobalt oxide containing Mg, F, Ni, and A1 was obtained (Step S54). This positive electrode active material (composite oxide), which was obtained through the above steps, was used as Sample 1-1.

### <Formation of Reference Positive Electrode Active Material>

As Sample 2, which was a reference, lithium cobalt oxide (Cellseed C-10N produced by NIPPON CHEMICAL INDUSTRIAL CO., LTD.) not subjected to any treatment was used.

### <Formation of Positive Electrode>

Sample 1-1 described above, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) with the weight ratio of PVDF to NMP being 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the application of the slurry on the positive electrode current collector, the solvent was volatilized. After that, pressing was performed with a roller press machine to increase the density of the positive electrode active material layer over the positive electrode current collector. The pressing was performed with a linear pressure of 210 kN/m. Note that the temperature of each of an upper roll and a lower roll of the roller press machine was 120° C., at which PVDF will melt.

Through the above steps, the positive electrode that included Sample 1-1 was obtained.

The positive electrode that included Sample 2 was formed by a method that is the same as the above-described method except for the use of Sample 2 above as a positive electrode active material.

### <Formation of Negative Electrode>

Graphite was prepared as a negative electrode active material. SBR and CMC were prepared as a binder and a thickener, respectively. Carbon fiber (VGCF (registered trademark) produced by Showa Denko K.K.) was prepared as a conductive material. Then, the graphite, VGCF, CMC, and SBR were mixed at a weight ratio of 97:1:1:1 to form a slurry, and the slurry was applied on a copper negative electrode current collector. As a solvent of the slurry, water was used.

After the application of the slurry on the negative electrode current collector, the solvent was volatilized. Through the above steps, the negative electrode was obtained. The pressing for the negative electrode was performed with a pressure of 36 kN/mm, which was lower than that for the positive electrode.

### <Electrolyte Solution>

Electrolyte Solution A, Electrolyte Solution B, and Electrolyte Solution C were prepared as described below.

As Electrolyte Solution A, an organic electrolyte solution was prepared by dissolving lithium hexafluorophosphate (LiPF₆) in a mixed organic solvent containing ethylene carbonate (EC) and diethyl carbonate (DEC) at a volume ratio of EC:DEC=30:70 in such a manner that LiPF₆ was at 1 mol/L with respect to the mixed organic solvent. Note that no additive agent was used.

As Electrolyte Solution B, an organic electrolyte solution was prepared by dissolving lithium hexafluorophosphate (LiPF₆) in a mixed organic solvent containing fluoroethylene carbonate (FEC) and methyl 3,3,3-trifluoropropionate (MTFP) at a volume ratio of FEC:MTFP=20:80 in such a manner that LiPF₆ was at 1 mol/L with respect to the mixed organic solvent. Note that no additive agent was used.

As Electrolyte Solution C, an organic electrolyte solution was prepared by dissolving lithium hexafluorophosphate (LiPF₆) in a mixed organic solvent containing ethylene carbonate (EC), ethyl methyl carbonate (EMC), and dimethyl carbonate (DMC) at a volume ratio of EC:EMC:DMC=30:35:35 in such a manner that LiPF₆ was at 1 mol/L with respect to the mixed organic solvent. Note that no additive agent was used.

The table below lists the names, structures, flash points, boiling points, and melting points of the solvents used for Electrolyte Solution A to Electrolyte Solution C. There is not much difference between the flash point of DEC in Electrolyte Solution A and that of each of EMC and DMC in Electrolyte Solution C.

TABLE 2

| | Electrolyte Solution A | | Electrolyte Solution B | | Electrolyte Solution C | | |
|---|---|---|---|---|---|---|---|
| | EC | DEC | FEC | MTFP | EC | EMC | DMC |
| | Ethylene | Diethyl | Fluoroethylene | Methyl 3,3,3- | Ethylene | Ethyl methyl | Dimethyl |
| Name | carbonate | carbonate | carbonate | trifluoropropionate | carbonate | carbonate | carbonate |
| Structure | 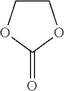 | 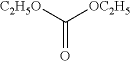 | 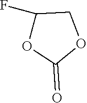 | 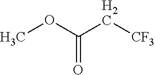 | 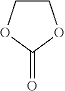 | 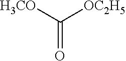 | 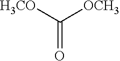 |
| Flash | 143 | 25 | >102 | −2 | 143 | 22 | 17 |
| point (° C.) | | | | | | | |
| Boiling | 238 | 127 | 210 | 96 | 238 | 107 | 90 |
| point (° C.) | | | | | | | |
| Melting | 38 | 43 | 17 | No data | 38 | −54 | 3 |
| point (° C.) | | | | | | | |

### <Fabrication of Lithium Ion Secondary Battery>

A lithium-ion secondary battery (Cell 1A) was fabricated using the positive electrode that included Sample 1-1 formed as described above, the negative electrode formed as described above, Electrolyte Solution A prepared as described above, a separator, and an exterior body. Furthermore, a lithium-ion secondary battery (Cell 1B) substituting Electrolyte Solution B for Electrolyte Solution A above was fabricated. A lithium-ion secondary battery (Cell 1C) substituting Electrolyte Solution C for Electrolyte Solution A above was fabricated.

A lithium-ion secondary battery (Cell 2A) was fabricated using the positive electrode that included Sample 2 formed as described above, the negative electrode formed as described above, Electrolyte Solution A prepared as described above, a separator, and an exterior body. Furthermore, a lithium-ion secondary battery (Cell 2B) substituting Electrolyte Solution B for Electrolyte Solution A above was fabricated. A lithium-ion secondary battery (Cell 2C) substituting Electrolyte Solution C for Electrolyte Solution A above was fabricated.

As the separator, a 25-μm-thick porous polypropylene film was used.

As the exterior body, an aluminum laminate film was used.

The outer size of each cell was 4.6 cm×6.4 cm. The area of the positive electrode was 20.5 cm² and that of the negative electrode was 23.8 cm². The area of the negative electrode is preferably larger than, or specifically greater than or equal to 1.1 times and less than or equal to 1.3 times as large as, that of the positive electrode.

Next, the initial charging and discharging were performed on Cell 1A, Cell 1B, Cell 1C, Cell 2A, Cell 2B, and Cell 2C. Table 3 shows the method of the initial charging and discharging performed on Cell 1A, Cell 1B, and Cell 1C, and Table 4 shows the method of the initial charging and discharging performed on Cell 2A, Cell 2B, and Cell 2C. The initial charging and discharging are sometimes referred to as aging or conditioning. Note that 1 C=200 mA/g (positive electrode active material weight).

TABLE 3

| | Charging discharging | Condition |
|---|---|---|
| Step A1 | Constant current | 0.01 C. Environmental temperature: 25° C. |
| | charging | Finished when a termination voltage of 4.5 V |
| | | of a termination capacity of 15 mAb/g was |
| | | reached. |
| Step A2 | Constant current | 0.1 C. Environmental temperature: 25° C. |
| | charging | Finished when a termination voltage of 4.5 V |
| | | or a termination capacity of 120 mAh/g was |
| | | reached. |
| Step A3 | Not performed | The cell was left still standing in a thermostatic |
| | | oven at 60° C. for 24 hours. |
| Step A4 | Not performed | One side of the cell was opened in a glove box |
| | | and the cell was resealed in an environment |
| | | with a reduc pressure of −60 kPa. |
| Step A5 | Constant current- | 0.1 C, 4.5 V. Environmental temperature: 25° C. |
| | constant voltage | Finished when a termination current of 0.01 C |
| | charging | was reached or a termination time of 10 hours |
| | | passed. |
| Step A6 | Constant current | 0.2 C. Environmental temperature: 25° C. |
| | discharging | Finished when a termination voltage of 2.5 V |
| | | was reached or a termination time of eight |
| | | hours passed. |
| Step A7 | Constant current- | 0.2 C, 4.5 V. Environmental temperature: 25° C. |
| | constant voltage | Finished when a termination current of 0.02 C |
| | charging | was reached or a termination time of eight |
| | | hours passed. |
| Step A8 | Constant current | 0.2 C. Environmental temperature: 25° C. |
| | discharging | Finished when a termination voltage of 2.5 V |
| | | was reached or a termination time of eight |
| | | hours passed. |

*Step A7 and Step A8 were repeated three times.

TABLE 4

| | Charging/discharging | Condition |
|---|---|---|
| Step A1 | Constant current | 0.01 C. Environmental temperature: 25° C. |
| | charging | Finished when a termination voltage of 4.2 V |
| | | or a termination capacity of 15 mAh/g was |
| | | reached. |
| Step A2 | Constant current | 0.1 C. Environmental temperature: 25° C. |
| | charging | Finished when a termination voltage of 4.2 V |
| | | or a termination capacity of 120 mAh/g was |
| | | reached. |
| Step A3 | Not performed | The cell was left standing in a thermostatic |
| | | oven at 60° C. for 24 hours. |
| Step A4 | Not performed | One side of the cell was opened in a glove box |
| | | and the cell was sealed in an environment |
| | | with a reduced pressure of −60 kPa. |
| Step A5 | Constant current- | 0.1 C, 4.2 V. Environment temperature: 25° C. |
| | constant voltage | Finished when a termination current of 0.01 C |
| | charging | was reached or a termination time of 10 hours |
| | | passed. |
| Step A6 | Constant current | 0.2 C. Environmental temperature: 25° C. |
| | discharging | Finished when a termination voltage of 2.5 V |
| | | was reached or a termination time of eight |
| | | hours passed. |
| Step A7 | Constant current- | 0.2 C, 4.2 V. Environmental temperature: 25° C. |
| | constant voltage | Finished when a termination current of 0.02 C |
| | charging | was reached or a termination time of eight |
| | | hours passed. |
| Step A8 | Constant current | 0.2 C. Environmental temperature: 25° C. |
| | discharging | Finished when termination voltage of 2.5 V |
| | | was reached or a termination time of eight |
| | | hours passed. |

*Step A7 and Step A8 were repeated three times.

### <Nail Penetration Test 1>

After the initial charging and discharging, a nail penetration test was conducted on Cell 1A, Cell 1B, Cell 1C, Cell 2A, Cell 2B, and Cell 2C. The nail penetration test was conducted in an environment at room temperature, or specifically, 25° C. Furthermore, the nail penetration test was conducted on a reference lithium-ion secondary battery (commercially available cell) that had been incorporated in a commercially available electronic device. The nail penetration test was conducted using a tester as shown in FIGS. 1A and 1B, or specifically, Advanced Safety Tester produced by ESPEC CORP.

As the nail 1003 in FIG. 1A, a nail having a diameter of 3 mm was used. The nail penetration speed was 5 mm/s. The nail penetration depth was 10 mm. The other conditions in the nail penetration test were compliant with SAE J2464, “Electric and Hybrid Electric Vehicle Rechargeable Energy Storage System (RESS) Safety and Abuse Testing”.

The nail penetration test was conducted on Cell 1A, Cell 1B, Cell 1C, Cell 2A, Cell 2B, Cell 2C, and the commercially available cell with the use of the above-described nail penetration test device 1000. Cell 1A, Cell 1B, Cell 1C, Cell 2A, Cell 2B, Cell 2C, and the commercially available cell to undergo the nail penetration test were fully charged under the conditions of Step A7 shown in Table 3. At this time, the battery voltage was 4.5 V. Before the nail penetration test, it was verified that the battery temperature was ° C. A battery temperature or simply a temperature in a nail penetration test refers to a value obtained by a temperature sensor; the battery temperature or the temperature of the case where the temperature sensor is in contact with an exterior body is equal to the temperature of the exterior body. In this example, a temperature sensor was placed at a distance of 2 cm from a nail hole.

The tables below list the conditions for Cell 1A, Cell 1B, Cell 1C, Cell 2A, Cell 2B, and Cell 2C, including the positive electrode active material loading levels, negative electrode active material loading levels, charge capacities, and the like thereof. The proportion of negative electrode capacity to positive electrode capacity in each table is the proportion of the capacity of the negative electrode to the capacity of the positive electrode, where the capacity refers to the product of the loading level, the charge capacity of the active material, and the area of the electrode. Note that the charge capacities of Sample 2 and Sample 1-1 as the positive electrode active materials were respectively 185 mAh/g and 200 mAh/g when 4.5-V charging was performed with the use of a counter electrode formed of graphite. The charge capacity of the graphite as the negative electrode active material was 300 mAh/g. The capacity of the commercially available cell in a fully charged state was 3180 mAh.

TABLE 5

| | | Cell 1A | Cell 1B | Cell 1C |
|---|---|---|---|---|
| Positive | Positive electrode active | Sample 1-1 | | |
| electrode | material | | | |
| | Binder | PVdF | | |
| | Conductive additive | Acetylene black | | |
| | Loading level | 9.8 mg/cm² | 9.9 mg/cm² | 10.2 mg/cm² |
| | (per one surface) | | | |
| | Material and thickness of | Al, 20 μm | | |
| | current collecting foil | | | |
| | Pressure for pressing | 210 kN/m | | |
| Negative | Active material | Graphite | | |
| electrode | Binder and thickener | SBR and CMC | | |
| | Conductive additive | VGCF | | |
| | Loading level | 6.8 mg/cm2 | 6.9 mg/cm² | 7.0 mg/cm² |
| | (per one surface) | | | |
| | Material and thickness of | Cu, 18 μm | | |
| | current collecting foil | | | |
| Separator | Material and thickness | Polypropylene (PP), 25 μm | | |
| Electrolyte | Solvent | EC:DEC = 30:70 | FEC:MTFP = 20:80 | EC:EMC:DMC = 30:35:35 |
| solution | Lithium salt | 1M LiPF₆ | | |
| Cell | Number of positive | 15 electrodes (double side coating) | | |
| | electrodes | | | |
| condition | Number of negative | 14 electrodes (double side coating) + 2 outermost electrodes | | |
| | electrodes | (single side coating) | | |
| | Exterior body | Aluminum laminate film | | |
| Condition | Charge voltage | 4.5 V | | |
| of nail | (at the time of aging) | | | |
| penetration | Charge voltage | 4.5 V | | |
| test | (at the time | | | |
| | of nail penetration) | | | |
| | Designed capacity | 1200 mAh | | |
| | Proportion of negative | 82.7% | 82.5% | 83.5% |
| | electrode capacity to | | | |
| | positive electrode capacity | | | |

TABLE 6

| | | Cell 2A | Cell 2B | Cell 2C |
|---|---|---|---|---|
| Positive | Positive electrode active | Sample 2 | | |
| electrode | material | | | |
| | Binder | PVdF | | |
| | Conductive additive | Acetylene black | | |
| | Loading level | 21.3 mg/cm² | 21.6 mg/cm² | 22.0 mg/cm² |
| | (per one surface) | | | |
| | Material and thickness of | Al, 20 μm | | |
| | current collecting foil | | | |
| | Pressure for pressing | 210 kN/m | | |
| Negative | Active material | Graphite | | |
| electrode | Binder and thickener | SBR and CMC | | |
| | Conductive additive | VGCF | | |
| | Loading level | 10.1 mg/cm² | 10.2 mg/cm² | 10.2 mg/cm² |
| | (per one surface) | | | |
| | Material and thickness of | Cu, 18 μm | | |
| | current collecting foil | | | |
| Separator | Material and thickness | Polypropylene (PP), 25 μm | | |
| Electrolyte | Solvent | EC:DEC = 30:70 | FEC:MTFP = 20:80 | EC:EMC:DMC = 30:35:35 |
| solution | Lithium salt | 1M LiPF₆ | | |
| Cell | Number of positive | 7 electrodes (double side coating) | | |
| condition | electrodes | | | |
| | Number of negative | 6 electrodes (double side coating) + 2 outermost electrodes | | |
| | electrodes | (single side coating) | | |
| | Exterior body | Aluminum laminate film | | |
| Condition | Charge voltage | 4.2 V | | |
| of nail | (at the time of aging) | | | |
| penetration | Charge voltage | 4.5 V | | |
| test | (at the time | | | |
| | of nail penetration) | | | |
| | Designed capacity | 1200 mAh | | |
| | Proportion of negative | 111.9% | 112.6% | 114.6% |
| | electrode capacity to | | | |
| | positive electrode capacity | | | |

As the loading level of the active material of each electrode, it is possible to use the weight of the active material obtained by subtracting the weights of the components other than the active material, e.g., the current collector, conductive material, binder, and thickener, from the weight of the electrode. The combination ratio between the active material, the conductive material, the binder, and the thickener is identified for the calculation of the weight of the active material. Specifically, for example, a portion having a certain area is taken out from a first region in which the active material layer is not applied on the current collector, a portion having the same area as the above portion is taken out from a second region in which the active material layer is applied and stacked on the current collector, and the weights of these portions are measured. The difference between the weights indicates the weight of the active material layer. Then, the combination ratio between the active material, the conductive material, the binder, and the thickener is identified, whereby the weight of the active material is found out. The weight of the active material is divided by the area of the taken portion.

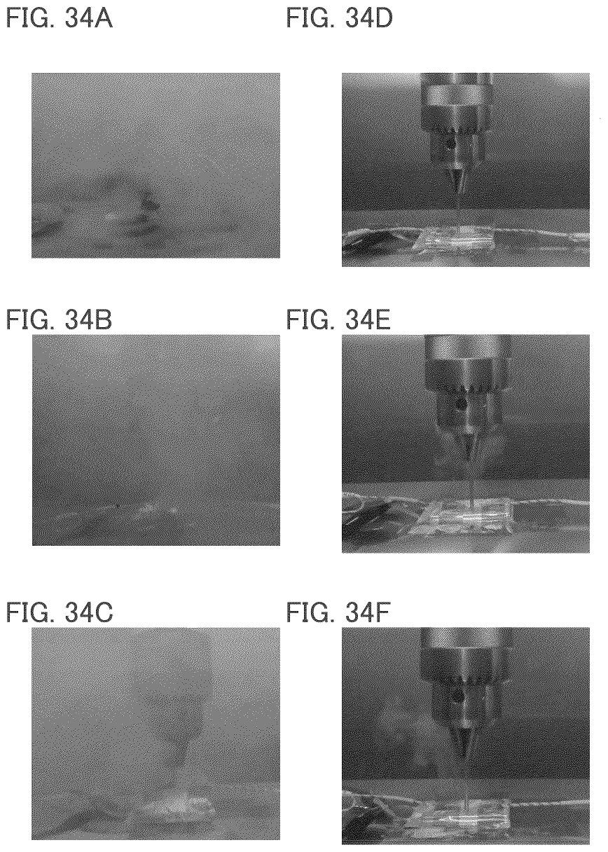

FIGS. 34A to 34F respectively show the states of Cell 2A, Cell 2B, Cell 2C, Cell 1A, Cell 1B, and Cell 1C undergoing the nail penetration test. As shown in FIGS. 34A to 34F, no or a small amount of smoke was observed in the nail penetration test of Cell 1A, Cell 1B, and Cell 1C and it was judged that these cells did not ignite. A large amount of smoke was observed in the nail penetration test of Cell 2A, Cell 2B, and Cell 2C. Fire was also observed in the nail penetration test of Cell 2A and Cell 2B and it was judged that Cell 2A and Cell 2B ignited. The table below lists the results of the nail penetration test.

TABLE 7

| | Result of nail penetration test |
|---|---|
| Cell 1A | No ignition |
| Cell 1B | No ignition |
| Cell 1C | No ignition |
| Cell 2A | Ignition and smoking |
| Cell 2B | Ignition and smoking |
| Cell 2C | Smoking |

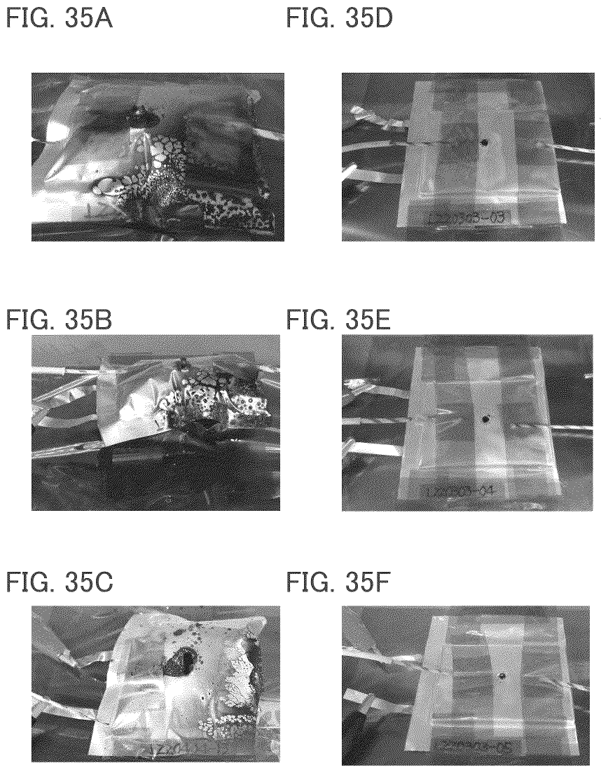

FIGS. 35A to 35F respectively show the states of Cell 2A, Cell 2B, Cell 2C, Cell 1A, Cell 1B, and Cell 1C at the time of removal of the nail after the nail penetration test. Nail holes were observed in Cell 1A, Cell 1B, and Cell 1C. Cell 2A, Cell 2B, and Cell 2C were seen expanding as a result of an increase in internal pressure by generation of a gas. Such a state may be regarded as indicating occurrence of thermal runaway.

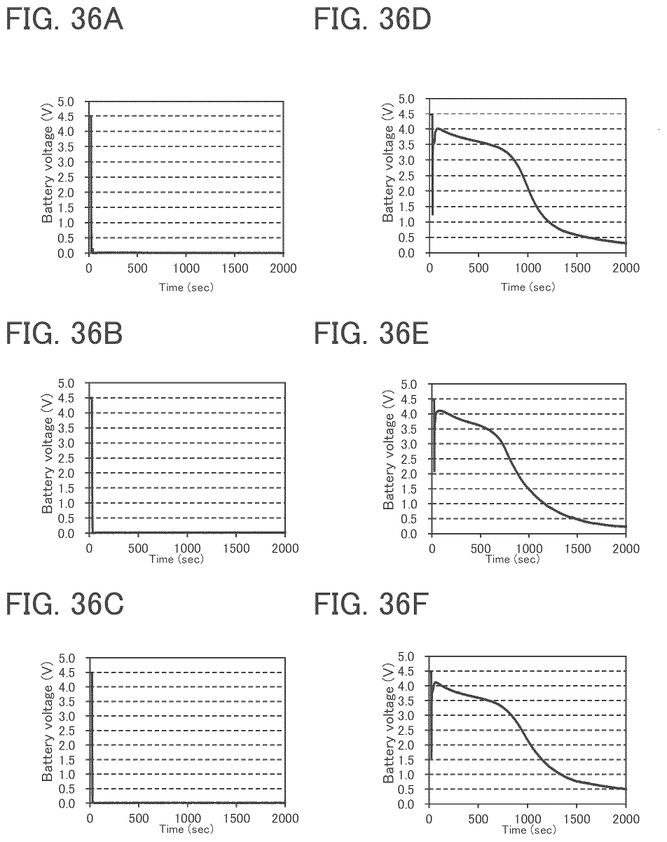

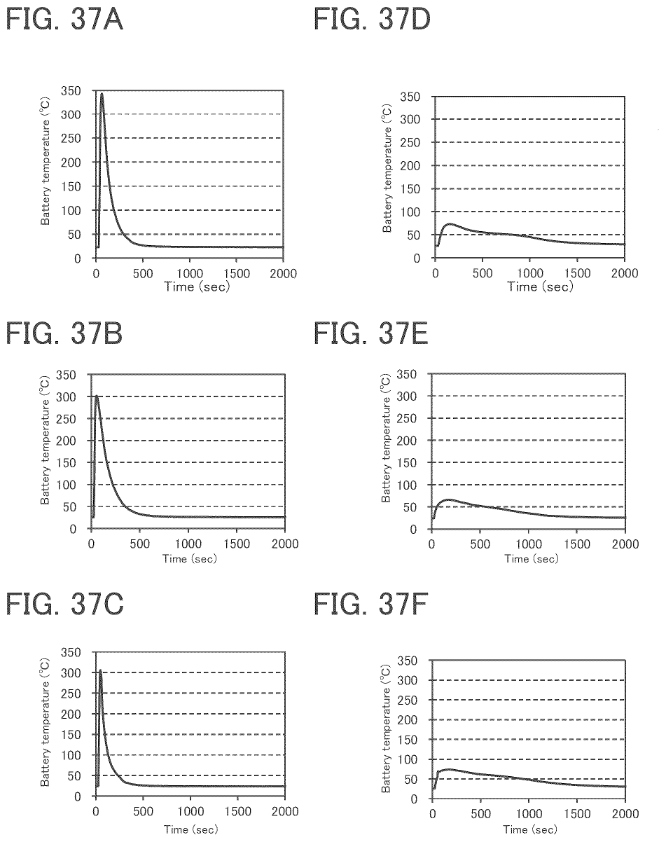

FIG. 36A and FIG. 37A respectively show a voltage change and a temperature change in Cell 2A during the nail penetration test. FIG. 36B and FIG. 37B respectively show a voltage change and a temperature change in Cell 2B during the nail penetration test. FIG. 36C and FIG. 37C respectively show a voltage change and a temperature change in Cell 2C during the nail penetration test. FIG. 36D and FIG. 37D respectively show a voltage change and a temperature change in Cell 1A during the nail penetration test. FIG. 36E and FIG. 37E respectively show a voltage change and a temperature change in Cell 1B during the nail penetration test. FIG. 36F and FIG. 37F respectively show a voltage change and a temperature change in Cell 1C during the nail penetration test. In each of FIGS. 36A to 37F, the timing of the contact between the nail and the battery is the 22th second.

As shown in FIG. 36D, Cell 1A showed a peculiar behavior: the battery voltage plummeted to less than or equal to approximately 1.5 V immediately after the nail penetration operation and then, the battery voltage increased to approximately 4.0 V. The battery voltage was seen decreasing gradually after the increase. By contrast, as shown in FIG. 36A, the battery voltage of Cell 2A decreased to 0 V immediately after the nail penetration operation and the battery voltage remained at 0 V thereafter.

As shown in FIG. 37D, the temperature of Cell 1A increased to 73° C. after the nail penetration operation. As shown in FIG. 37A, the temperature of Cell 2A increased to 340° C. The difference between the maximum value obtained with the temperature sensor and the battery temperature at the start of the test corresponds to the increment of temperature that was presumably due to heat generation at the time of the nail penetration test (an increment ΔT of temperature). The increment ΔT of temperature was 315° C. (the difference between 340° C. and 25° C.) in Cell 2A and 48° C. (the difference between 73° C. and 25° C.) in Cell 1A. This means that the increment ΔT of temperature in Cell 1A is less than or equal to 50° C.

As shown in FIG. 36E, the battery voltage of Cell 1B was seen decreasing to less than or equal to approximately 2.0 V immediately after the nail penetration operation, then increasing to approximately 4.0 V, and then gradually decreasing. By contrast, as shown in FIG. 36B, the battery voltage of Cell 2B decreased to 0 V immediately after the nail penetration operation and the battery voltage remained at 0 V thereafter.

As shown in FIG. 37E, the temperature of Cell 1B increased to 66° C. after the nail penetration operation. As shown in FIG. 37B, the temperature of Cell 2B increased to 302° C. The increment ΔT of temperature at the time of the nail penetration test was 277° C. (the difference between 302° C. and 25° C.) in Cell 2B and 41° C. (the difference between 66° C. and 25° C.) in Cell 1B. This means that the increment ΔT of temperature in Cell 1B is less than or equal to 50° C.

As shown in FIG. 36F, the battery voltage of Cell 1C was seen decreasing to less than or equal to approximately 1.5 V immediately after the nail penetration operation, then increasing to approximately 4.0 V, and then gradually decreasing. By contrast, as shown in FIG. 36C, the battery voltage of Cell 2C decreased to 0 V immediately after the nail penetration operation and the battery voltage remained at 0 V thereafter. As shown in FIG. 37F, the temperature of Cell 1C increased to 74° C. after the nail penetration operation. As shown in FIG. 37C, the temperature of Cell 2C increased to 306° C. The increment ΔT of temperature at the time of the nail penetration test was 281° C. (the difference between 306° C. and 25° C.) in Cell 2C and 49° C. (the difference between 74° C. and 25° C.) in Cell 1C. This means that the increment ΔT of temperature in Cell 1C is less than or equal to 50° C.

As described above, the battery voltage of each of Cell 1A, Cell 1B, and Cell 1C fabricated using the positive electrode active material of Sample 1-1 decreased immediately after the nail penetration operation, then increased, and decreased gradually. By contrast, the battery voltage of Cell 2A, Cell 2B, and Cell 2C fabricated using Sample 2, the reference positive electrode active material, decreased to 0 V and remained at 0 V thereafter.

The temperature of each of Cell 1A, Cell 1B, and Cell 1C fabricated using the positive electrode active material of Sample 1-1 only gradually increased during the nail penetration test. By contrast, the temperature of each of Cell 2A, Cell 2B, and Cell 2C fabricated using Sample 2, the reference positive electrode active material, sharply increased during the nail penetration test.

Moreover, Cell 1A, Cell 1B, and Cell 1C fabricated using the positive electrode active material of Sample 1-1 did not ignite during the nail penetration test. By contrast, Cell 2A, Cell 2B, and Cell 2C fabricated using Sample 2, the reference positive electrode active material, ignited during the nail penetration test. In other words, the lithium-ion secondary batteries fabricated using Sample 1-1 as the positive electrode active material did not ignite during the nail penetration test irrespective of the kind of the electrolyte solution. As will be described later, the lithium cobalt oxide of one embodiment of the present invention has a sleek or shiny surface, which may inhibit cracking of the lithium cobalt oxide. It is presumable that at the time of the nail penetration test in this example, the nail was likely to slide on the sleek or shiny surface.

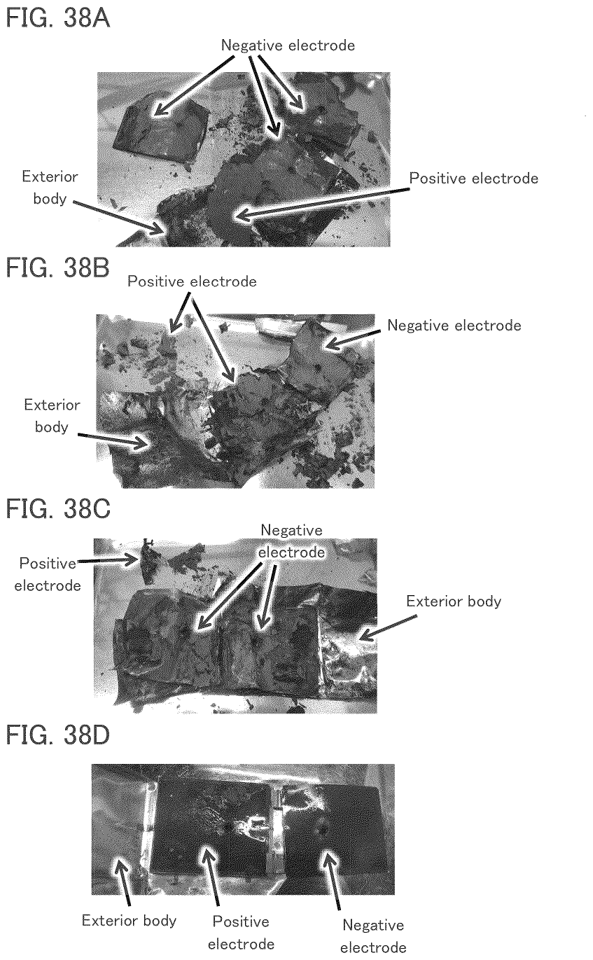

Next, the cells that underwent the nail penetration test were disassembled. FIGS. 38A, 38B, 38C, and 38D respectively show photographs of Cell 2A, Cell 2B, Cell 2C, and Cell 1A that were disassembled after the nail penetration test. In each of Cell 2A, Cell 2B, and Cell 2C, which ignited, the separator was destructed by fire and collapse of the current collector was observed. Although fire was not observed in the nail penetration test of Cell 2C, the state of Cell 2C was the same as the states of Cell 2A and Cell 2B, suggesting that the inside of Cell 2C caught fire. The difference between the electrolyte solutions did not affect the results.

As already shown by Table 2, there is not much difference between the flash point of DEC in Electrolyte Solution A and that of each of EMC and DMC in Electrolyte Solution C. Accordingly, a secondary battery that includes the positive electrode active material of one embodiment of the present invention does not ignite and can be safe owing to the physical properties, e.g., heat resistance, of the positive electrode active material, irrespective of the kind of the electrolyte solution used.

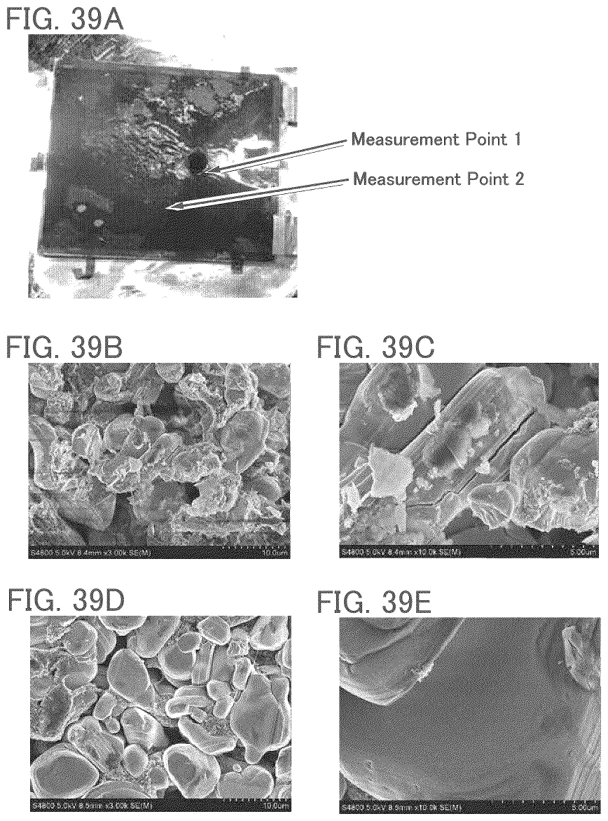

The SEM observation of the positive electrode that was collected from Cell 1A disassembled after the nail penetration test is described with reference to FIGS. 39A to 39E. In FIG. 39A, observed portions are denoted as Measurement Point 1 and Measurement Point 2. Measurement Point 1 is in the vicinity of the nail hole and Measurement Point 2 is 2 cm apart from the nail hole. FIGS. 39B to 39E show SEM images of Measurement Point 1 and Measurement Point 2. FIG. 39B shows the SEM image of Measurement Point 1 at 3000-fold magnification, and FIG. 39C shows the SEM image of Measurement Point 1 at 10000-fold magnification. FIG. 39D shows the SEM image of Measurement Point 2 at 3000-fold magnification and FIG. 39E shows the SEM image of Measurement Point 2 at 10000-fold magnification. The SEM images showed that the surfaces of the lithium cobalt oxide of Cell 1A had many cracks at Measurement Point 1 near the nail hole but maintained smoothness at Measurement Point 2. The crack in the SEM image of Measurement Point 1 at 10000-fold magnification might have been caused along the C-plane of the lithium cobalt oxide.

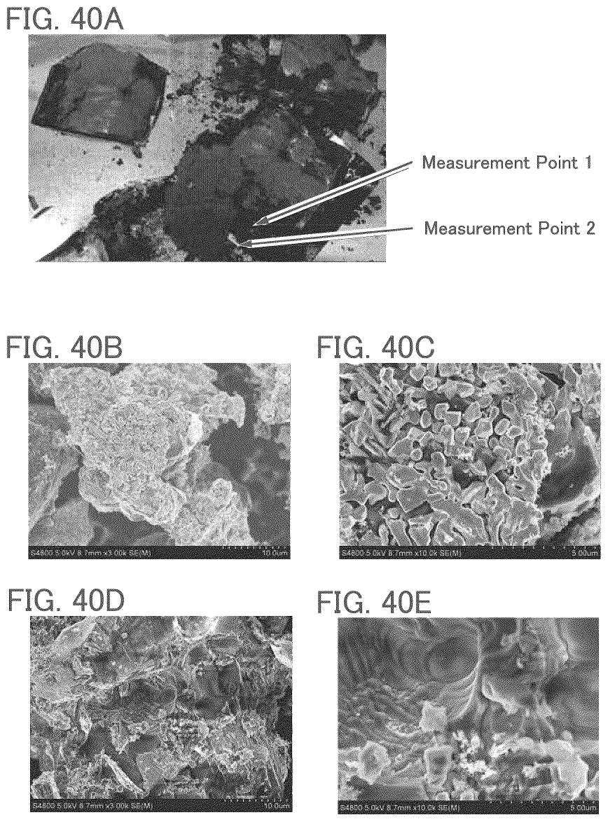

The SEM observation of the positive electrode that was collected from Cell 2A disassembled after the nail penetration test is described with reference to FIGS. 40A to 40E. In FIG. 40A, observed portions are denoted as Measurement Point 1 and Measurement Point 2. FIGS. 40B to 40E show SEM images of Measurement Point 1 and Measurement Point 2. FIG. 40B shows the SEM image of Measurement Point 1 at 3000-fold magnification, and FIG. 40C shows the SEM image of Measurement Point 1 at 10000-fold magnification. FIG. 40D shows the SEM image of Measurement Point 2 at 3000-fold magnification and FIG. 40E shows the SEM image of Measurement Point 2 at 10000-fold magnification. The SEM images revealed that the lithium cobalt oxide of Cell 2A significantly changed in shape to lose its original form.

It is presumable that the stable crystal structure of the positive electrode active material of Sample 1-1 inhibited a thermal decomposition reaction involving oxygen release from occurring even after much lithium was extracted from the positive electrode active material, which in turn hindered ignition due to thermal runaway. It is also presumable that formation of a desirable shell in the positive electrode active material of Sample 1-1 inhibited a thermal decomposition reaction involving oxygen release, which in turn hindered ignition due to thermal runaway. In other words, the positive electrode active material of one embodiment of the present invention is highly safe because it does not easily ignite when abnormalities such as an internal short circuit occurs.

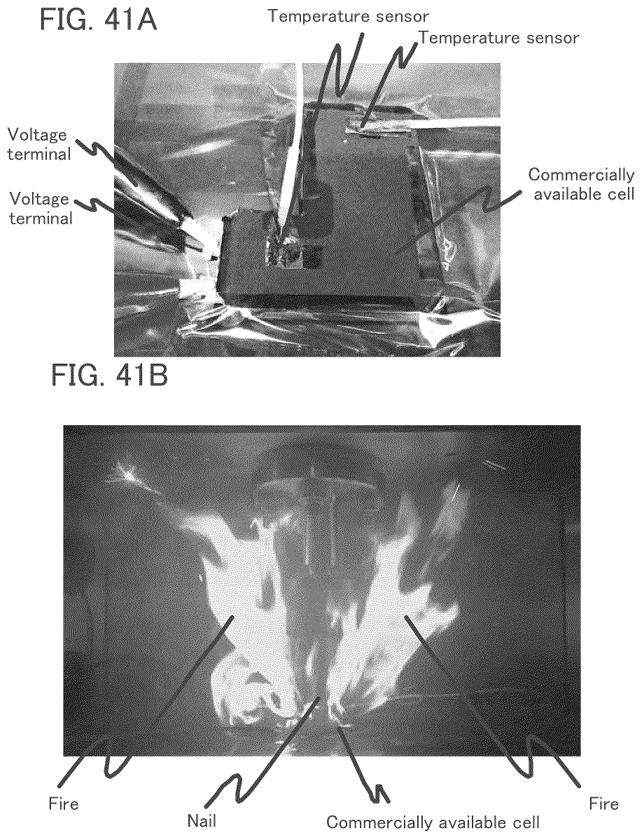

Next, the nail penetration test was conducted on the commercially available cell. FIG. 41A shows a photograph of the commercially available cell before the nail penetration test and FIG. 41B shows a photograph of the commercially available cell at the time of the nail penetration test. As shown in FIG. 41B, a large amount of smoke and fierce fire were observed in the nail penetration test of the commercially available cell. Temperature sensors were put along the periphery of the exterior body. The positive electrode active material of the commercially available cell probably included no desirable shell, like the positive electrode active material of Cell 2A to Cell 2C.

### <EDX Analysis>

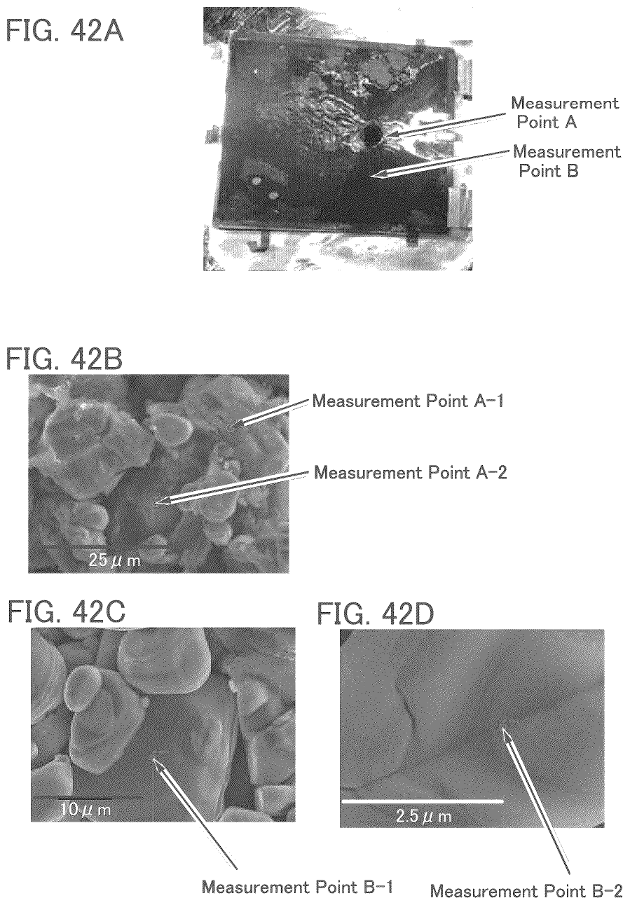

FIG. 42A shows the appearance of Cell 1A after the nail penetration test. FIGS. 42B to 42D show SEM images of the positive electrode collected from Cell 1A disassembled after the nail penetration test. Measurement Point A and Measurement Point B shown in FIG. 42A were observed with a SEM in this example. Measurement Point A is in the vicinity of the nail hole (less than 2 cm away from the nail hole) and Measurement Point B is 2 cm away from the nail hole.

In the SEM image shown in FIG. 42B, which is an observation image of Measurement Point A, Measurement Point A-1 and Measurement Point A-2 are indicated by the arrows. In the SEM image shown in FIG. 42C, which is an observation image of Measurement Point B, Measurement Point B-1 is indicated by the arrow. In the SEM image shown in FIG. 42D, which is an observation image of Measurement Point B, Measurement Point B-2 is indicated by the arrow. EDX analysis was conducted on the positive electrode active material at Measurement Points A-1, A-2, B-1, and B-2 in this example.

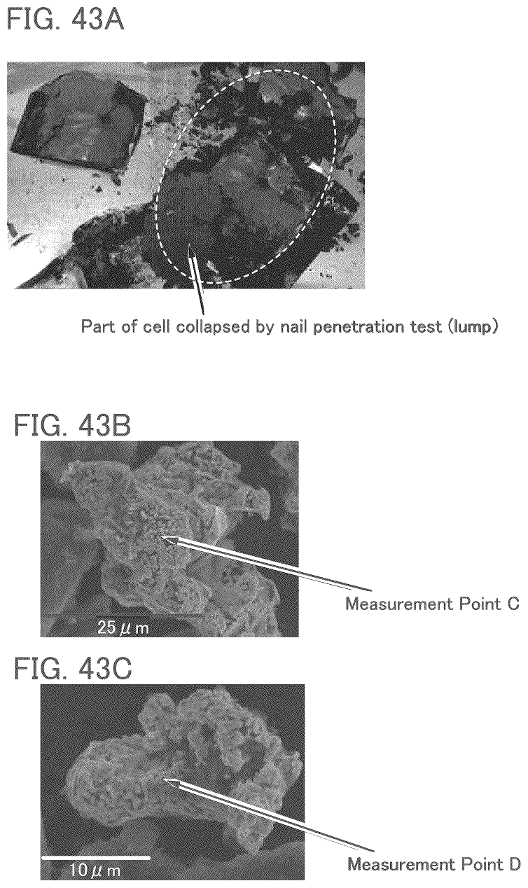

FIG. 43A shows the appearance of Cell 2A after the nail penetration test. FIGS. 43B and 43C show SEM images of the positive electrode collected from Cell 2A disassembled after the nail penetration test. The lump seen in the dashed line circle in FIG. 43A, which is part of the cell that collapsed as a result of the nail penetration test, was subjected to SEM observation in this example.

FIGS. 43B and 43C show two SEM images obtained through observation of powder of the positive electrode active material taken from the above lump. In the SEM image of FIG. 43B, Measurement Point C is indicated by the arrow. In the SEM image of FIG. 43C, Measurement Point D is indicated by the arrow. EDX analysis was conducted on these two measurement points in this example.

Table 8 shows results of the EDX analysis conducted on Measurement Point A-1, Measurement Point A-2, Measurement Point B-1, and Measurement Point B-2 of the positive electrode collected from Cell 1A after the nail penetration test, i.e., the atomic ratios (atomic %), which are hereinafter also referred to as atomic concentrations (%), of detected elements. Table 9 shows results of the EDX analysis conducted on Measurement Point C and Measurement Point D of the positive electrode collected from Cell 2A after the nail penetration test.

Note that some of the elements detected in the positive electrode collected from Cell 1A (see Table 8) were not detected in the positive electrode collected from Cell 2A (see Table 9). However, for easy comparison, Table 8 and Table 9 show the same elements (C, O, F, Mg, A1, P, and Co), including the elements not detected in the latter positive electrode.

TABLE 8

| | Atomic concentration (%) | | | |
|---|---|---|---|---|
| | Measurement | Measurement | Measurement | Measurement |
| | Point | Point | Point | Point |
| Element | A-1 | A-2 | B-1 | B-2 |
| C | 21.81 | 27.46 | 8.37 | 7.65 |
| O | 36.9 | 31.51 | 64.04 | 59.08 |
| F | 8.45 | 8.73 | — | — |
| Mg | 0.24 | — | — | 0.37 |
| Al | 1.24 | 1.11 | 0.97 | 1.28 |
| P | 1.02 | 1.31 | — | — |
| Co | 30.33 | 29.88 | 26.62 | 31.63 |

TABLE 9

| | Atomic concentration (%) | |
|---|---|---|
| | Measurement | Measurement |
| Element | Point C | Point D |
| C | 34.38 | 29.74 |
| O | 32.97 | 8.63 |
| F | — | — |
| Mg | — | — |
| Al | 0.76 | 1.36 |
| P | — | — |
| Co | 31.9 | 60.27 |

As seen from Table 8, in the vicinities of the nail hole (Measurement Point A-1 and Measurement Point A-2) in the positive electrode collected from Cell 1A after the nail penetration test, C, O, and Co were detected at higher atomic concentrations and the atomic concentrations of the three elements accounted for almost 90% of the sum of the atomic concentrations of the elements shown in Table 8. Meanwhile, at the points 2 cm away from the nail hole (Measurement Point B-1 and Measurement Point B-2), 0 and Co were detected at higher atomic concentrations and the atomic concentrations of the two elements accounted for approximately 90% of the sum of the atomic concentrations of the elements shown in Table 8.

It was also found that the atomic concentration of Co was close to that of O, i.e., Co:O was approximately 1:1, in the vicinities of the nail hole (Measurement Point A-1 and Measurement Point A-2), whereas the atomic concentration of 0 was approximately twice as high as that of Co, i.e., Co:O was approximately 1:2, at the points 2 cm away from the nail hole (Measurement Point B-1 and Measurement Point B-2). This showed that the nail penetration test caused O release in the vicinities of the nail hole (the points less than 2 cm away from the nail hole) and caused almost no O release at the points away from the nail hole (the points at least 2 cm or more away from the nail hole). At the points 2 cm away from the nail hole (Measurement Point B-1 and Measurement Point B-2), the elements detected in the vicinities of the nail hole (Measurement Point A-1 and Measurement Point A-2), e.g., F and P, were not detected and the atomic concentration of C was lower than in the vicinities of the nail hole (Measurement Point A-1 and Measurement Point A-2). All of these elements were the components contained in the electrolyte solution used in Cell 1A fabricated in this example. It is thus presumable that the nail penetration test caused decomposition of the electrolyte in the vicinities of the nail hole (Measurement Point A-1 and Measurement Point A-2).

As already described above, in the case where LiCoO₂ is used as a positive electrode active material, it can be said that, when EDX analysis after a nail penetration test reveals that the O/Co ratio at a position more than or equal to 2 cm away from a penetration point is greater than or equal to 1.3, neither thermal runaway nor ignition has occurred. In this example, the EDX analysis conducted on the positive electrode collected from Cell 1A after the nail penetration test showed that the O/Co ratio at each of Measurement Point A-1 and Measurement Point A-2 in the vicinities of the nail hole (less than 2 cm away from the nail hole) was approximately 1 (Co: 0=approximately 1:1), whereas the O/Co ratio at each of Measurement Point B-1 and Measurement Point B-2 that were 2 cm away from the nail hole was approximately 2 (Co: 0=approximately 1:2). Thus, it can be said that the nail penetration test did not cause thermal runaway or ignition in Cell 1A.

By contrast, the EDX analysis results of the positive electrode collected from Cell 2A after the nail penetration test demonstrated a different tendency. For example, as shown in Table 9, the atomic concentrations of Co and O were each approximately 30% and Co and O were in substantially the same proportion (Co: 0=approximately 1:1) at Measurement Point C; however, at Measurement Point D, the atomic concentration of was only approximately 10% while that of Co was approximately 60% (Co: 0=approximately 6:1). That is, in the positive electrode collected from Cell 2A, the atomic concentration of 0 was lower than or equal to that of Co, suggesting that the nail penetration test caused O release.

As described above, in this example, the results of the EDX analysis conducted on the two points (Measurement Point C and Measurement Point D) of the positive electrode collected from part of the cell that collapsed by the nail penetration test showed that the O/Co ratio at each of the points was less than 1.3 (Co: 0=approximately 1:1 and approximately 6:1 respectively at Measurement Point C and Measurement Point D). Thus, it can be said that the nail penetration test caused thermal runaway and ignition in Cell 2A.

The difference in the nail penetration test results between Cell 1A and Cell 2A presumably reflects the difference therebetween in the crystal structure and the presence or absence of the shell, for example. That is, neither thermal runaway nor ignition was observed in the nail penetration test of Cell 1A, which included the positive electrode active material of one embodiment of the present invention (Sample 1-1), presumably because the stable crystal structure of Sample 1-1 inhibited a thermal decomposition reaction involving oxygen release from occurring even after much lithium was extracted from the positive electrode active material. Furthermore, neither thermal runaway nor ignition was observed in the nail penetration test of Cell 1A presumably because a desirable shell formed in Sample 1-1 inhibited a thermal decomposition reaction involving oxygen release. In other words, the positive electrode active material of one embodiment of the present invention is highly safe because it does not easily ignite when abnormalities such as an internal short circuit occurs.

### Example 2

In this example, batteries were fabricated using the positive electrode active material of one embodiment of the present invention and underwent nail penetration tests under conditions different from those in the above example.

### <Nail Penetration Test 2>

Lithium-ion secondary batteries that included Sample 1-1 as their positive electrode active materials were assembled by the same method as the above-described lithium-ion secondary batteries. The batteries for Nail Penetration Test 2 included Electrolyte Solution A described above and were different from each other in the loading level of the positive electrode active material and the proportion of negative electrode capacity to positive electrode capacity. The loading level of the negative electrode active material was adjusted in accordance with the loading level of the positive electrode active material, and the number of positive electrodes stacked and the number of negative electrodes stacked were also adjusted. The conditions of the nail penetration test of Cell 1D, Cell 1E, Cell 1F, Cell 1G, and Cell 1H are shown in the table below.

TABLE 10

| | | Cell 1D | Cell 1E | Cell 1F | Cell 1G | Cell 1H |
|---|---|---|---|---|---|---|
| Positive | Positive electrode active | Sample 1-1 | | | | |
| electrode | material | | | | | |
| | Binder | PVdF | | | | |
| | Conductive additive | Acetylene black | | | | |
| | Loading level (per one | 10.1 mg/cm² | 13.5 mg/cm² | 15.1 mg/cm² | 20.4 mg/cm² | 19.7 mg/cm² |
| | surface) | | | | | |
| | Material and thickness of | Al, 20 μm | | | | |
| | current collecting foil | | | | | |
| | Pressure for pressing | 210 kN/m | | | | |
| Negative | Active material | Graphite | | | | |
| electrode | Binder and thickener | SBR and CMC | | | | |
| | Conductive additive | VGCF | | | | |
| | Loading level (per one | 7.2 mg/cm² | 9.1 mg/cm² | 10.4 mg/cm² | 13.9 mg/cm² | 10.2 mg/cm² |
| | surface) | | | | | |
| | Material and thickness of | Cu, 18 μm | | | | |
| | current collecting foil | | | | | |
| Separator | Material and thickness | Polypropylene (PP), 25 μm | | | | |
| Electrolyte | Solvent | EC:DEC = 30:70 | | | | |
| solution | Lithium salt | 1M LiPF₆ | | | | |
| Cell | Number of positive | 15 electrodes | 11 electrodes | 10 electrodes | 7 electrodes (double side coating) | |
| condition | electrodes | (double side coating) | (double side coating) | (double side coating) | | |
| | Number of negative | 14 electrodes | 10 electrodes | 9 electrodes (double | 6 electrodes (double side coating) + 2 | |
| | electrodes | (double side coating) + | (double side coating) + | side coating) + 2 | outermost electrodes (single side | |
| | | 2 outermost | 2 outermost | outermost electrodes | coating) | |
| | | electrodes (single | electrodes (single | (single side coating) | | |
| | | side coating) | side coating) | | | |
| | Exterior body | Aluminum laminate film | | | | |
| Condition of | Charge voltage (at the time | 4.5 V | | | | |
| nail | of aging) | | | | | |
| penetration | Charge voltage (at the time | 4.5 V | | | | |
| test | of nail penetration) | | | | | |
| | Designed capacity | 1200 mAh | | | | |
| | Proportion of negative | 80.6% | 83.0% | 83.0% | 84.0% | 110.7% |
| | electrode capacity to | | | | | |
| | positive electrode capacity | | | | | |

| | | | | | |
|---|---|---|---|---|---|
| Result of nail penetration test | No ignition | No ignition | No ignition | No ignition | No ignition |

No or a small amount of smoke was observed in the nail penetration test of Cell 1D, Cell 1E, Cell 1F, Cell 1G, and Cell 1H and it was judged that these cells did not ignite. According to the results for Cell 1A to Cell 1H, a lithium-ion secondary battery that includes the positive electrode active material of one embodiment of the present invention does not ignite when the loading level of the positive electrode active material is greater than or equal to 9 mg/cm² and less than or equal to 21 mg/cm² and thus, the lithium-ion secondary battery can be highly safe.

Next, lithium-ion secondary batteries that included Sample 2 as their positive electrode active materials were assembled by the same method as the above-described lithium-ion secondary batteries. The batteries for Nail Penetration Test 2 included Electrolyte Solution A described above and were different from each other in the loading level of the positive electrode active material and the like. The loading level of the negative electrode active material was adjusted in accordance with the loading level of the positive electrode active material, and the number of positive electrodes stacked and the number of negative electrodes stacked were also adjusted. The conditions of the nail penetration test of Cell 2D, Cell 2E, Cell 2F, Cell 2G, and Cell 2H are shown in the table below.

TABLE 11

| | | Cell 2D | Cell 2E | Cell 2F | Cell 2G | Cell 2H |
|---|---|---|---|---|---|---|
| Positive | Positive electrode active | Sample 2 | | | | |
| electrode | material | | | | | |
| | Binder | PVdF | | | | |
| | Conductive additive | Acetylene black | | | | |
| | Loading level (per one | 11.1 mg/cm² | 13.5 mg/cm² | 14.6 mg/cm² | 21.6 mg/cm² | 21.7 mg/cm² |
| | surface) | | | | | |
| | Material and thickness of | Al, 20 μm | | | | |
| | current collecting foil | | | | | |
| | Pressure for pressing | 210 KN/m | | | | |
| Negative | Active material | Graphite | | | | |
| electrode | Binder and thickener | SBR and CMC | | | | |
| | Conductive additive | VGCF | | | | |
| | Loading level (per one | 7.1 mg/cm² | 8.8 mg/cm² | 10.1 mg/cm² | 13.8 mg/cm² | 10.0 mg/cm² |
| | surface) | | | | | |
| | Material and thickness of | Cu, 18 μm | | | | |
| | current collecting foil | | | | | |
| Separator | Material and thickness | Polypropylene (PP), 25 μm | | | | |
| Electrolyte | Solvent | EC:DEC = 30:70 | | | | |
| solution | Lithium salt | 1M LiPF₆ | | | | |
| Cell | Number of positive | 15 electrodes (double | 12 electrodes (double | 11 electrodes (double | 7 electrodes | 7 electrodes |
| condition | electrodes | side coating) | side coating) | side coating) | (double side | (double side |
| | | | | | coating) | coating) |
| | Number of negative | 14 electrodes (double | 11 electrodes (double | 10 electrodes (double | 6 electrodes (double side coating) + 2 | |
| | electrodes | side coating) + 2 | side coating) + 2 | side coating) + 2 | outermost electrodes (single side | |
| | | outermost electrodes | outermost electrodes | outermost electrodes | coating) | |
| | | (single side coating) | (single side coating) | (single side coating) | | |
| | Exterior body | Aluminum laminate film | | | | |
| Condition of | Charge voltage (at the time | 4.2 V | | | | |
| nail | of aging) | | | | | |
| penetration | Charge voltage (at the time | 4.5 V | | | | |
| test | of nail penetration) | | | | | |
| | Designed capacity | 1200 mAh | | | | |
| | Proportion of negative | 83.5% | 81.4% | 77.0% | 83.0% | 114.6% |
| | electrode capacity to | | | | | |
| | positive electrode capacity | | | | | |

| | | | | | |
|---|---|---|---|---|---|
| Result of nail penetration test | No ignition | No ignition | No ignition | Ignition | Ignition |

No or a small amount of smoke was observed in the nail penetration test of Cell 2D, Cell 2E, and Cell 2F and it was judged that these cells did not ignite. By contrast, fire was observed in the nail penetration test of Cell 2G and Cell 2H and it was judged that these cells ignited. According to the results for Cell 2A to Cell 2H, a lithium-ion secondary battery that includes Sample 2 does not ignite when the loading level of the positive electrode active material is greater than or equal to 7 mg/cm² and less than or equal to 10 mg/cm². It is thus found that a lithium-ion secondary battery that includes the positive electrode active material of one embodiment of the present invention is more favorable because of having a wider allowable range of the positive electrode active material loading level.

Next, Sample 3 was prepared in the following manner to check the effect of the heating in Step S15: the heating in Step S15 was performed on Sample 2 and no additive element was then added. Furthermore, to check the range of the loading level of the positive electrode active material in which a lithium-ion secondary battery does not ignite, Cell 3A and Cell 3B in which the loading levels of Sample 3 were respectively 10.3 mg/cm² and 19.8 mg/cm² were assembled. The conditions of the nail penetration test of Cell 3A and Cell 3B are shown in the table below.

TABLE 12

| | | Cell 3A | Cell 3B |
|---|---|---|---|
| Positive | Positive electrode active material | Sample 2 + Step S15 | |
| electrode | Binder | PVdF | |
| | Conductive additive | Acetylene black | |
| | Loading level (per one surface) | 10.3 mg/cm² | 19.8 mg/cm² |
| | Material and thickness of current | Al, 20 μm | |
| | collecting foil | | |
| | Pressure for pressing | 210 KN/m | |
| Negative | Active material | Graphite | |
| electrode | Binder and thickener | SBR and CMC | |
| | Conductive additive | VGCF | |
| | Loading level (per one surface) | 7.1 mg/cm² | 13.8 mg/cm² |
| | Material and thickness of current | Cu, 18 μm | |
| | collecting foil | | |
| Separator | Material and thickness | Polypropylene (PP), 25 μm | |
| Electrolyte | Solvent | EC:DEC = 30:70 | |
| solution | Lithium salt | 1M LiPF₆ | |
| Cell condition | Number of positive electrodes | 15 electrodes (double side coating) | 8 electrodes (double side coating) |
| | Number of negative electrodes | 14 electrodes (double side coating) + | 7 electrodes (double side coating) + |
| | | 2 outermost electrodes | 2 outermost electrodes |
| | | (single side coating) | (single side coating) |
| | Exterior body | Aluminum laminate film | |
| Condition of | Charge voltage | 4.2 V | |
| nail | (at the time of aging) | | |
| penetration | Charge voltage | 4.5 V | |
| test | (at the time of nail penetration) | | |
| | Designed capacity | 1200 mAh | |
| | Proportion of negative electrode | 77.1% | 75.9% |
| | capacity to positive electrode | | |
| | capacity | | |

| | | |
|---|---|---|
| Result of nail penetration test | No ignition | No ignition |

No or a small amount of smoke was observed in the nail penetration test of Cell 3A and Cell 3B and it was judged that these cells did not ignite. According to the results for Cell 3A and Cell 3B, a lithium-ion secondary battery that includes Sample 3 does not ignite when the loading level of the positive electrode active material is greater than or equal to 10 mg/cm² and less than or equal to 20 mg/cm². That is, the heating in Step S15 raised the upper limit of the range of the positive electrode active material loading level in which a battery does not ignite to make the range close to that of Sample 1-1 that is one embodiment of the present invention. In other words, the heating in Step S15 was found to be very effective in providing a high-safety secondary battery.

The table below lists the positive electrode active material loading levels and the proportions of negative electrode capacity to positive electrode capacity in the samples that underwent Nail Penetration Test 1 and Nail Penetration Test 2.

TABLE 13

| | | Proportion | |
|---|---|---|---|
| | | of negative | |
| | | electrode | |
| | | capacity | Result |
| | Loading | to positive | of nail |
| | level | electrode | penetration |
| Cell No. | (mg/cm²) | capacity | test |
| Cell 1A | 9.8 | 82.7% | No ignition |
| Cell 1B | 9.9 | 82.5% | No ignition |
| Cell 1C | 10.2 | 83.5% | No ignition |
| Cell 1D | 10.1 | 80.6% | No ignition |
| Cell 1E | 13.5 | 84.7% | No ignition |
| Cell 1F | 15.1 | 83.0% | No ignition |
| Cell 1G | 20.4 | 84.0% | No ignition |
| Cell 1H | 19.7 | 110.7% | No ignition |
| Cell 2A | 21.3 | 111.9% | Ignition |
| Cell 2B | 21.6 | 112.6% | Ignition |
| Cell 2C | 22 | 114.6% | Ignition |
| Cell 2D | 11.1 | 83.5% | No ignition |
| Cell 2E | 13.5 | 81.4% | No ignition |
| Cell 2F | 14.6 | 77.0% | No ignition |
| Cell 2G | 21.6 | 83.0% | Ignition |
| Cell 2H | 21.7 | 114.6% | Ignition |
| Cell 3A | 10.3 | 77.1% | No ignition |
| Cell 3B | 19.8 | 75.9% | No ignition |

The table above suggests that not only the positive electrode active material loading level but also the proportion of negative electrode capacity to positive electrode capacity has a certain range in which ignition does not occur. Ignition tends to occur when the proportion of negative electrode capacity to positive electrode capacity is higher than 100%; thus, the proportion of negative electrode capacity to positive electrode capacity is preferably higher than or equal to 75% and lower than 100% to prevent ignition. It was also found that in the case where Sample 1-1 of one embodiment of the present invention is used, the proportion of negative electrode capacity to positive electrode capacity for preventing ignition may be higher than or equal to 75% and lower than or equal to 110%, which means that the use of Sample 1-1 of one embodiment of the present invention allows increasing the proportion of negative electrode capacity to positive electrode capacity.

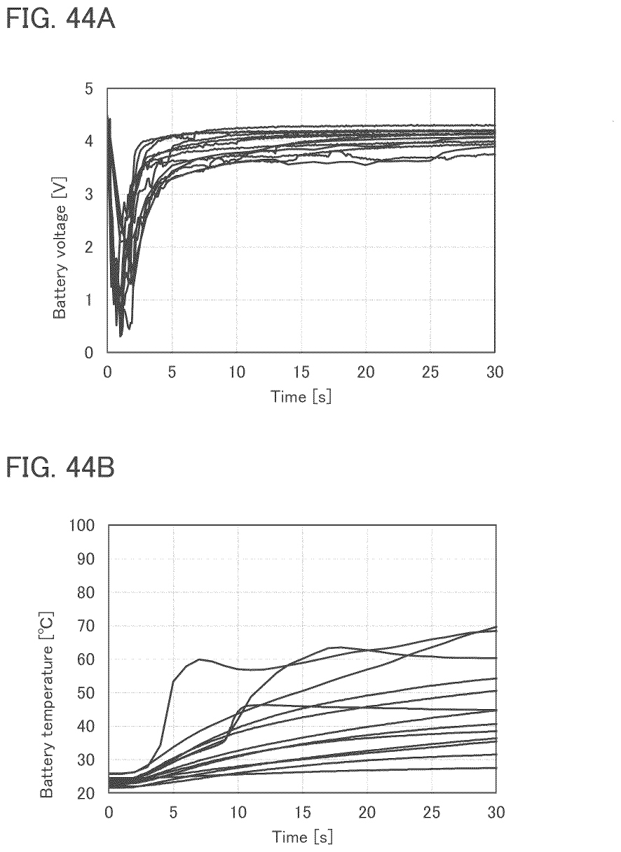

FIGS. 44A and 44B respectively show a change in voltage over time and a change in temperature over time in the 13 cells that did not ignite in Nail Penetration Test 1 and Nail Penetration Test 2. Here, the 0-th second is the time when the nail contacted the battery. It was found that the battery voltage of each of the cells that did not ignite decreased and then increased. Specifically, the battery voltage was found to remain steady at approximately 3.5 V to 4.0 V after approximately 10 seconds passed after the nail penetration. It was found that this inhibited heat generation.

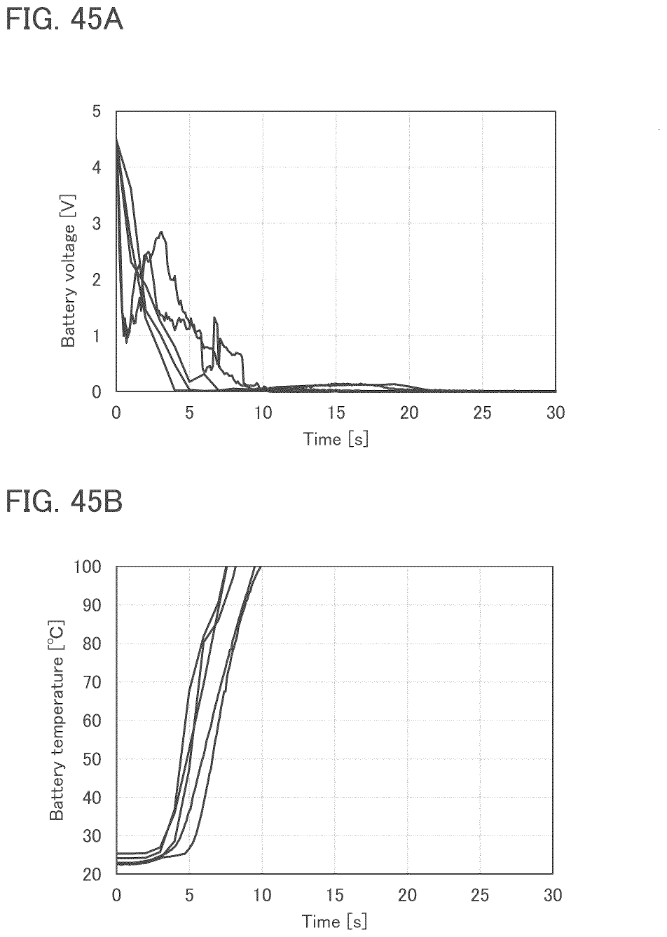

FIGS. 45A and 45B respectively show a change in voltage over time and a change in temperature over time in the five cells that ignited in Nail Penetration Test 1 and Nail Penetration Test 2. Here, the 0-th second is the time when the nail contacted the battery. The voltage of each of the cells that ignited was found to decrease to 0 V, suggesting that a current kept on flowing between the positive and negative electrodes and heat generation continued, which caused the ignition.

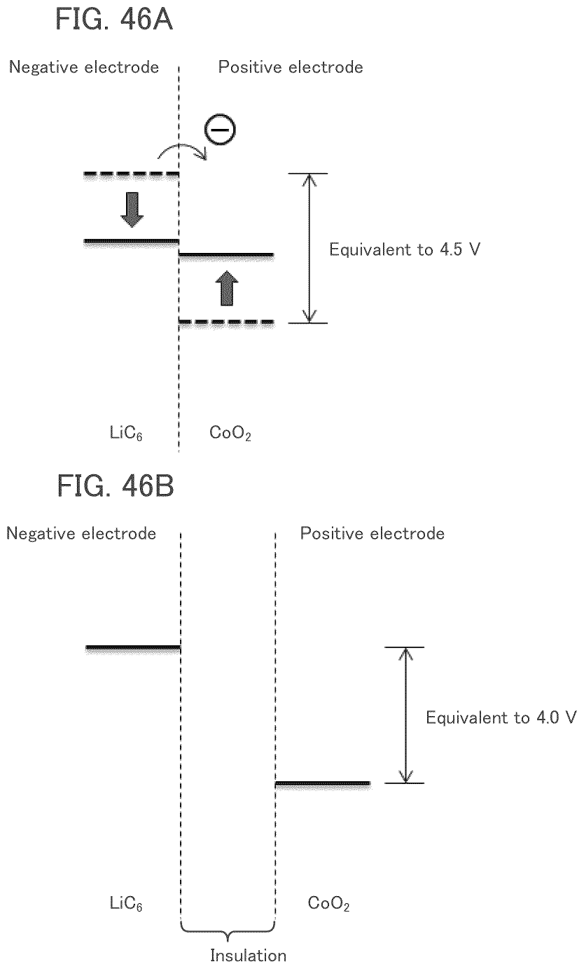

The voltage change in the cells that did not ignite was examined using energy diagrams created on the assumption that a lithium ion moves from LiCoO₂ of the positive electrode active material to C of the negative electrode active material to generate CoO₂ in the positive electrode and LiC₆ in the negative electrode. FIG. 46A shows the energy diagram at the time of occurrence of an internal short circuit in the cell that did not ignite. First, the nail penetration-induced internal short circuit makes electrons flow at once as shown in FIG. 46A, so that the Fermi levels of the positive electrode and the negative electrode become equal to each other. The lithium ion is heavier than the electron and thus moves more slowly than the electron. This prevents the lithium ion from moving from the negative electrode to the positive electrode within a few seconds, e.g., approximately one second, following the nail penetration. The materials of the positive electrode and the negative electrode do not change if the lithium ion does not move.

FIG. 46B shows the energy diagram at the time of termination of the internal short circuit in the cell that did not ignite. Formation of an insulating region between the nail and the cell penetrated by the nail after the nail penetration, for example, is considered as termination of an internal short circuit. The insulating region includes a region in which the separator is positioned and/or a region immersed in the electrolyte solution. When the internal short circuit is terminated, the difference in Fermi energy becomes large again as shown in FIG. 46B. It was found that as shown in FIG. 44A, the voltage was 4.5 V before the nail penetration test and remained steady at approximately 3.5 V to 4.0 V after approximately 10 seconds passed after the nail penetration. This difference in voltage was presumably caused by a change in Fermi energy due to either return of the lithium ion in the electrolyte solution near the positive electrode to the positive electrode or a structural change of CoO₂ as the positive electrode active material due to the electron flowing into the positive electrode.

### Example 3

### <Nail Penetration Test 3>

In this example, a battery was fabricated using the positive electrode active material of one embodiment of the present invention and underwent a cycle test at an environmental temperature of 45° C. and a subsequent nail penetration test.

In this example, Cell 1A-1 having the same structure as Cell 1A described in Example 1 was fabricated as a lithium-ion secondary battery. That is, in the fabricated lithium-ion secondary battery, Sample 1-1 was used as the positive electrode active material, Electrolyte Solution A was used as the electrolyte solution, and graphite was used for the negative electrode. As already described above, Electrolyte Solution A is an organic electrolyte solution prepared by dissolving lithium hexafluorophosphate (LiPF₆) in a mixed organic solvent containing ethylene carbonate (EC) and diethyl carbonate (DEC) at a volume ratio of EC:DEC=30:70 in such a manner that LiPF₆ was at 1 mol/L with respect to the mixed organic solvent. As in Example 1, a 25-μm-thick porous polypropylene film was used as the separator and an aluminum laminate film was used as the exterior body.

Cell 1A-1 underwent a charge and discharge cycle test at an environmental temperature of 45° C. An environmental temperature in a charge and discharge cycle test means the temperature of a thermostatic oven in which a cell is put. Specifically, Cell 1A-1 was put in a thermostatic oven, the initial charging and discharging (environmental temperature: 25° C.) shown in Table 3 in Example 1 were performed, the temperature of the thermostatic oven was raised to set the environmental temperature to ° C., five cycles of charging and discharging (a set of charging and discharging is one cycle) were performed, and then, charging was performed once. In other words, Cell 1A-1 was subjected to the initial charging and discharging and the subsequent charge and discharge cycle test with five cycles, and was then brought into a charged state. The charging in the charge and discharge cycle test and the charging after the charge and discharge cycle test were each constant current-constant voltage charging (CC-CV charging). In CC-CV charging, constant current charging is performed until the upper limit voltage of charging is reached, and then, constant voltage charging is performed. In the above charging in the charge and discharge cycle test and the above charging after the charge and discharge cycle test in this example, constant current charging was performed up to 4.6 V and then, constant voltage charging was performed for three hours. As the discharging in the charge and discharge cycle test, constant current discharging at 0.42 C (500 mA) was performed up to 3.0 V. Note that here, 1 C was set to 200 mA/g (positive electrode active material weight).

After the above charging and discharging were performed on Cell 1A-1, the nail penetration test was conducted under the same conditions as the nail penetration test in Example 1. As described in Example 1, the nail penetration test was conducted at room temperature, or specifically, 23° C. The table below shows the positive electrode active material loading level, the negative electrode active material loading level, the charge capacity, and other conditions of Cell 1A-1.

TABLE 14

| | | Cell 1A-1 |
|---|---|---|
| Positive | Positive electrode active | Sample 1-1 |
| electrode | material | |
| | Binder | PVdF |
| | Conductive additive | Acetylene black |
| | Loading level | 9.9 mg/cm² |
| | (per one surface) | |
| | Material and thickness of | Al, 20 μm |
| | current collecting foil | |
| | Pressure for pressing | 210 kN/m |
| Negative | Active material | Graphite |
| electrode | Binder and thickener | SBR and CMC |
| | Conductive additive | VGCF |
| | Loading level | 7.0 mg/cm² |
| | (per one surface) | |
| | Material and thickness of | Cu, 18 μm |
| | current collecting foil | |
| Separator | Material and thickness | Polypropylene (PP), 25 μm |
| Electrolyte | Solvent | EC:DEC = 30:70 |
| solution | Lithium salt | 1M LiPF₆ |
| Cell | Number of positive | 15 electrodes |
| condition | electrodes | (double side coating) |
| | Number of negative | 14 electrodes (double side |
| | electrodes | coating) + 2 outermost |
| | | electrodes (single side coating) |
| | Exterior body | Aluminum laminate film |
| Condition | Charge voltage | 4.5 V |
| of nail | (at the time of aging) | |
| penetration | Charge voltage | 4.6 V |
| test | (at the time of nail | |
| | penetration) | |
| | Designed capacity | 1200 mAh |
| | Proportion of negative | 80.9% |
| | electrode capacity to | |
| | positive electrode capacity | |

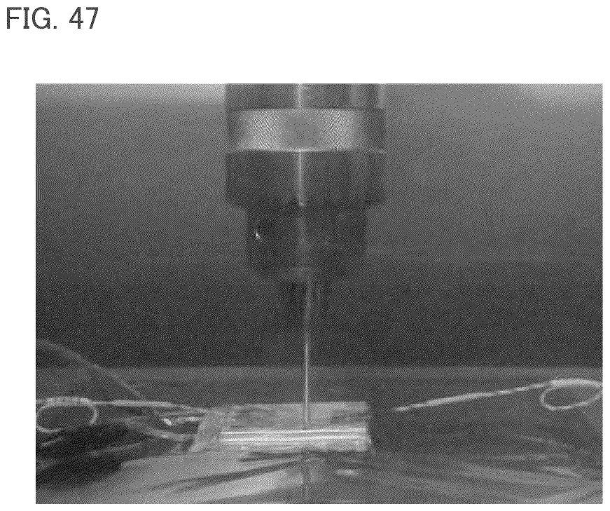

FIG. 47 shows Cell 1A-1 undergoing the nail penetration test. As shown in FIG. 47, Cell 1A-1 was seen smoking slightly and did not ignite.

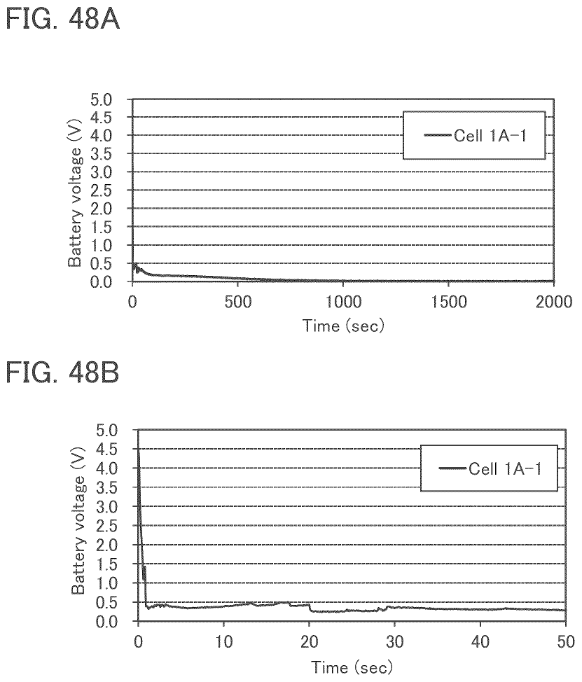

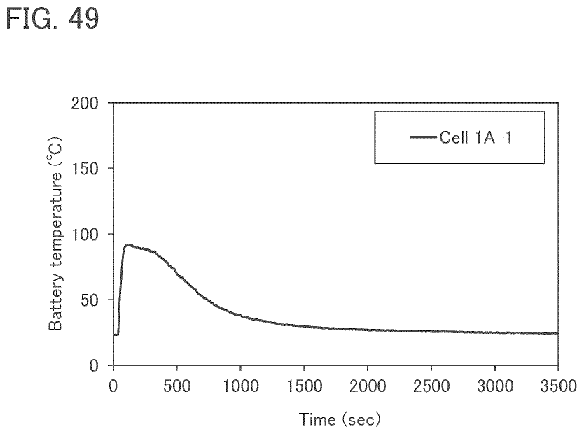

FIG. 48A and FIG. 49 are graphs showing a voltage change and a temperature change, respectively, of Cell 1A-1 during the nail penetration test. Here, the 0-th second is the time when the nail contacted the battery. FIG. 48B is an enlarged view of the range from the 0-th second to the 50-th second in FIG. 48A.

As shown in FIGS. 48A and 48B, Cell 1A-1 showed a peculiar behavior: the battery voltage decreased to less than or equal to 0.5 V immediately after the nail penetration operation and then, the battery voltage remained at approximately 0.5 V.

As shown in FIG. 49, the temperature of Cell 1A-1 increased to 90.7° C. after the nail penetration operation. The temperature of Cell 1A-1 before the nail penetration operation was 23.1° C. Accordingly, the increment ΔT of temperature in Cell 1A-1 was 67.6° C. That is, the increment ΔT of temperature in Cell 1A-1 was less than or equal to 70° C.

Cell 1A-1, which was slightly degraded by the charge and discharge cycles, was free from thermal runaway and ignition in the nail penetration test by including Sample 1-1 in the positive electrode. This is presumably because the stable crystal structure of Sample 1-1 inhibited a thermal decomposition reaction involving oxygen release from occurring even after much lithium was extracted from the positive electrode active material. Furthermore, neither thermal runaway nor ignition was observed in the nail penetration test of Cell 1A-1 presumably because a desirable shell formed in Sample 1-1 inhibited a thermal decomposition reaction involving oxygen release. In other words, the positive electrode active material of one embodiment of the present invention is highly safe even after degradation.

### Example 4

### [DSC Test 1]

A DSC test for a charged state was conducted to examine the thermal stability of the positive electrode active material of one embodiment of the present invention. In the DSC test, a positive electrode that was subjected to charging up to 4.6 V in a half cell whose negative electrode was made of a lithium metal was used. A method for fabricating the battery subjected to the test is described below.

### <Formation 2 of Positive Electrode Active Material>

Sample 1-2 formed in this example is described with reference to the formation method in FIG. 23 and FIGS. 24A to 24C.

As the LiCoO₂ in Step S14 in FIG. 23, commercially available lithium cobalt oxide (Cellseed C-10N produced by NIPPON CHEMICAL INDUSTRIAL CO., LTD.) containing cobalt as the transition metal M and no additive element was prepared. The initial heating in Step S15 was performed on the lithium cobalt oxide, which was put in a crucible covered with a lid, in a muffle furnace at 850° C. for two hours. No flowing was performed after the muffle furnace was filled with an oxygen atmosphere (O2 purging). The collected amount after the initial heating showed a slight decrease in weight. The decrease in weight was probably caused by elimination of impurities such as lithium carbonate from the lithium cobalt oxide.

Mg, F, Ni, and A1 were separately added as the additive elements in accordance with Step S21 and Step S41 shown in FIG. 24A and FIG. 24C. In accordance with Step S21 shown in FIG. 24A, LiF and MgF₂ were prepared as the F source and the Mg source, respectively. The LiF and MgF₂ were weighed such that LiF:MgF₂=1:3 (molar ratio). Then, the LiF and MgF₂ were mixed into dehydrated acetone and the mixture was stirred at a rotational speed of 400 rpm for 12 hours, whereby an additive element source (A1 source) was produced. In the mixing, a ball mill was used and a grinding medium was zirconium oxide balls. The F source and Mg source weighing approximately 9 g in total were put in a 45-mL-capacity container of the mixing ball mill together with 20 mL of dehydrated acetone and 22 g of zirconium oxide balls (1 mm (I)) and mixed. Then, the mixture was made to pass through a sieve with an aperture of 300 μm, whereby the A1 source was obtained.

Then, in Step S31, the A1 source and the lithium cobalt oxide subjected to the initial heating were weighed such that the magnesium of the A1 source was 1 mol % with respect to the cobalt, and were mixed by a dry method. Stirring was performed at a rotational speed of 150 rpm for one hour. These conditions were milder than those of the stirring in the production of the A1 source. Finally, the mixture was made to pass through a sieve with an aperture of 300 μm, whereby the mixture 903 having a uniform particle diameter was obtained (Step S32).

Subsequently, in Step S33, the mixture 903 was heated. The heating was performed at 900° C. for 20 hours. During the heating, the mixture 903 was in a crucible covered with a lid. The crucible was filled with an atmosphere containing oxygen and the leakage of the oxygen was blocked (purging). By the heating, a composite oxide containing Mg and F was obtained (Step S34a).

Then, in Step S51, the composite oxide and the additive element sources (the A2 sources) were mixed. Nickel hydroxide on which a grinding step was performed was prepared as the nickel source and aluminum hydroxide on which a grinding step was performed was prepared as the aluminum source in accordance with Step S41 shown in FIG. 24C. The nickel hydroxide, the aluminum hydroxide, and the composite oxide were weighed such that the nickel in the nickel hydroxide and the aluminum in the aluminum hydroxide were each 0.5 mol % with respect to the cobalt, and the nickel hydroxide, the aluminum hydroxide, and the composite oxide were mixed by a dry method. Stirring was performed at a rotational speed of 150 rpm for one hour. In the mixing, a ball mill was used and a grinding medium was zirconium oxide balls. The composite oxide, the nickel source, and the aluminum source weighing approximately 7.5 g in total were put in a 45-mL-capacity container of the mixing ball mill together with 22 g of zirconium oxide balls (1 mm (I)) and mixed. These conditions were milder than those of the stirring in the production of the A1 source. Finally, the mixture was made to pass through a sieve with an aperture of 300 μm, whereby the mixture 904 having a uniform particle diameter was obtained (Step S52).

Subsequently, in Step S53, the mixture 904 was heated. The heating was performed at 850° C. for 10 hours. During the heating, the mixture 904 was in a crucible covered with a lid. The crucible was filled with an atmosphere containing oxygen and the leakage of the oxygen was blocked (purging). By the heating, lithium cobalt oxide containing Mg, F, Ni, and A1 was obtained (Step S54). This positive electrode active material (composite oxide), which was obtained through the above steps, was used as Sample 1-2.

### <Formation of Reference Positive Electrode Active Material>

As a reference in this example, Sample 2 was used as in the nail penetration test.

### <Fabrication of Half Cell>

A half cell (Cell 4A-1) was fabricated which included a positive electrode containing Sample 1-2 formed as described above, a lithium metal foil, a separator, an electrolyte solution (Electrolyte Solution A in the above example), a coin cell positive electrode can, and a coin cell negative electrode can. The positive electrode active material loading level of Sample 1-2 for the DSC test was 14.5 mg/cm².

A half cell (Cell 5A-1) was fabricated which included a positive electrode containing Sample 2 formed as described above, a lithium metal foil, a separator, an electrolyte solution, a coin cell positive electrode can, and a coin cell negative electrode can. The positive electrode active material loading level of Sample 2 for the DSC test was 15.2 mg/cm².

### <Pretreatment for DSC Test>

As pretreatment for the DSC test, Cell 4A-1 and Cell 5A-1 described above were charged and discharged. The conditions of the charging were as follows: constant current charging at 0.1 C was performed up to 4.6 V, and constant voltage charging was performed at 4.6 V until a termination current of 0.005 C was reached. The discharging was constant current discharging at 0.1 C up to 2.5 V. The above charging and discharging were repeated twice. Note that the environmental temperature of the charging and discharging was 25° C.

Then, on Cell 4A-1 and Cell 5A-1, constant current charging at 0.1 C was performed up to 4.6 V and then, constant voltage charging at 4.6 V was performed until a termination current of 0.005 C was reached, so that Cell 4A-1 and Cell 5A-1 were in a 4.6-V charged state. After that, Cell 4A-1 and Cell 5A-1 in the 4.6-V charged state were disassembled in a glove box with an argon atmosphere to take out the positive electrodes, and the positive electrodes were washed with DMC to remove the electrolyte solution. The positive electrode including Sample 1-2 and taken out from Cell 4A-1 and the positive electrode including Sample 2 and taken out from Cell 5A-1 were each stamped out to have a diameter of 3 mm ϕ.

The positive electrodes (Sample 1-2 and Sample 2) stamped out were each put in a stainless steel container and then, 1 μL, of an electrolyte solution was dripped. This electrolyte solution was formed under the same conditions as the electrolyte solution used for the half cell. Then, zirconium oxide balls with a diameter of 2 mm were put on the positive electrode in the above stainless steel container. Putting such zirconium oxide balls has an effect of inhibiting the above positive electrode from being detached from the bottom surface of the container. After that, a stainless steel lid was pressed into the above container to seal the container.

### <DSC Test>

For the DSC test, Thermo plus EVO2 DSC8231, a high-sensitive differential scanning calorimeter produced by Rigaku Corporation, was used. The measurement conditions were as follows: the temperature range was from room temperature to 400° C. and the temperature rising rate was 5° C./min.

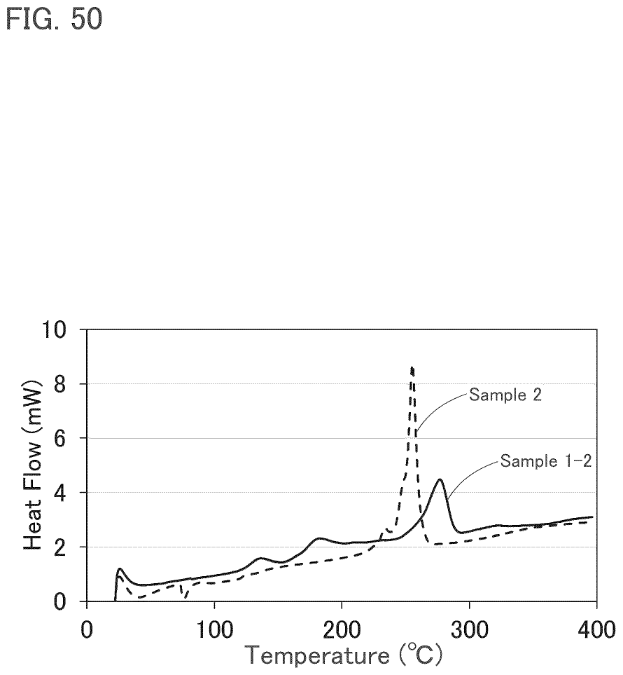

FIG. 50 shows the results of the DSC test. The horizontal axis represents temperature and the vertical axis represents heat flow. In the graph, the solid line indicates the results for Sample 1-2 in the 4.6-V charged state and the dashed line indicates the results for Sample 2 in the 4.6-V charged state.

As shown in FIG. 50, Sample 1-2 in the 4.6-V charged state exhibited the maximum peak at 276.8° C. in the DSC test, and Sample 2 in the 4.6-V charged state exhibited the maximum peak at 255.2° C. in the DSC test. The maximum peak of Sample 1-2 at 276.8° C. is presumably attributable to heat generation due to (5) oxygen release from the positive electrode and thermal decomposition of the positive electrode (the thermal decomposition includes a structural change of a positive electrode active material) in FIG. 4. It is presumable that ignition did not occur in the nail penetration test in the above example because the temperature, i.e., internal temperature, of the lithium-ion secondary battery did not exceed 276.8° C.

As can be seen from comparison between the temperatures at which the maximum peaks were exhibited in the DSC test, the temperature at which Sample 1-2 in the 4.6-V charged state exhibited the maximum peak was higher than the temperature at which Sample 2 in the 4.6-V charged state exhibited the maximum peak by approximately 20° C. In other words, Sample 1-2 has higher thermal stability than Sample 2.

It is presumable that formation of a desirable shell in Sample 1-2 inhibited a thermal decomposition reaction involving oxygen release, which in turn hindered an increase in the internal temperature of the battery. In other words, the positive electrode active material of one embodiment of the present invention is highly safe because it does not easily ignite when abnormalities such as an internal short circuit occurs.

### Example 5

In this example, the influence of the presence or absence of a lid on a container at the time of heat treatment was examined.

### <Formation 3 of Positive Electrode Active Material>

Sample 1-3 formed in this example is described with reference to the formation method in FIG. 23 and FIGS. 24A to 24C.

As the LiCoO₂ in Step S14 in FIG. 23, commercially available lithium cobalt oxide (Cellseed C-10N produced by NIPPON CHEMICAL INDUSTRIAL CO., LTD.) containing cobalt as the transition metal M and no additive element was prepared. The initial heating in Step S15 was not performed.

In accordance with Step S21 shown in FIG. 24A, LiF and MgF₂ were prepared as the F source and the Mg source, respectively. The LiF and MgF₂ were weighted such that LiF:MgF₂=1:3 (molar ratio), dehydrated acetone was added as a solvent, and the materials were mixed and ground by a wet method to give the A1 source.

Then, in Step S31 in FIG. 23, the A1 source and the lithium cobalt oxide were weighed such that the magnesium of the A1 source was 0.3 mol % with respect to the cobalt of the lithium cobalt oxide, and the A1 source and the lithium cobalt oxide were mixed in 20 mL of dehydrated acetone, to give the mixture 903 (Step S32).

Subsequently, in Step S33 in FIG. 23, the mixture 903 was heated. In this example, the presence or absence of the lid and the number of lids were varied to examine the effect of the lid of the crucible in which the mixture 903 is put. Specifically, Sample 3-1 was formed with the use of a crucible covered with one lid. Sample 3-2 was formed with the use of a crucible covered with four lids stacked. Sample 3-3 was formed with the use of a crucible covered with three lids stacked. Sample 4 was formed with the use of a crucible covered with no lid. For each sample, an oxygen gas was made to continuously flow at 10 L/min in a furnace (O2 flowing). The heating was performed at 850° C. for 60 hours. The temperature rising rate was 200° C./h, and the temperature decreasing time was longer than or equal to 10 hours.

Lithium cobalt oxide containing magnesium and fluorine was collected after the heating (Step S34a). No A2 source was added in this example.

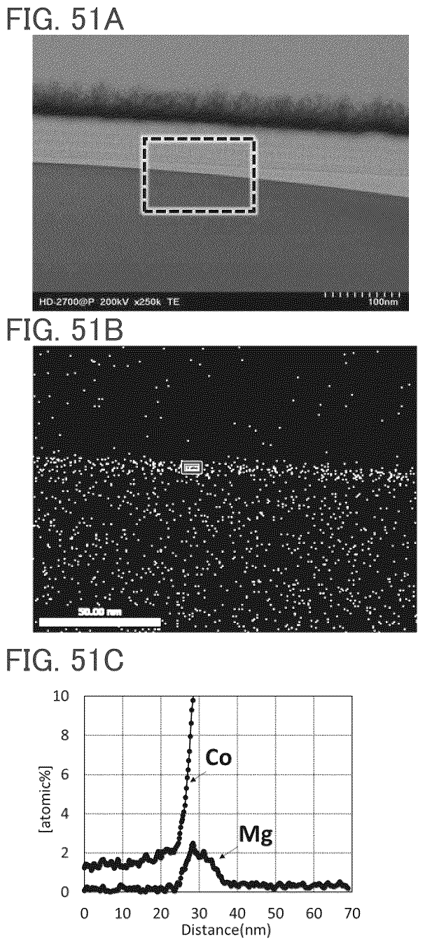

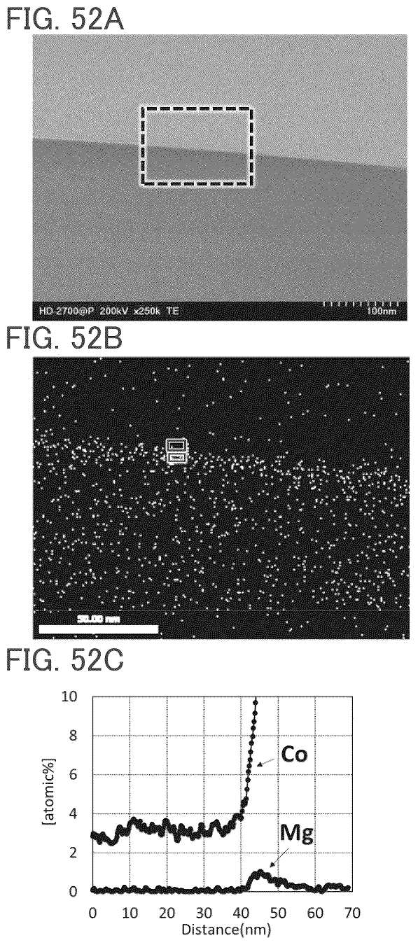

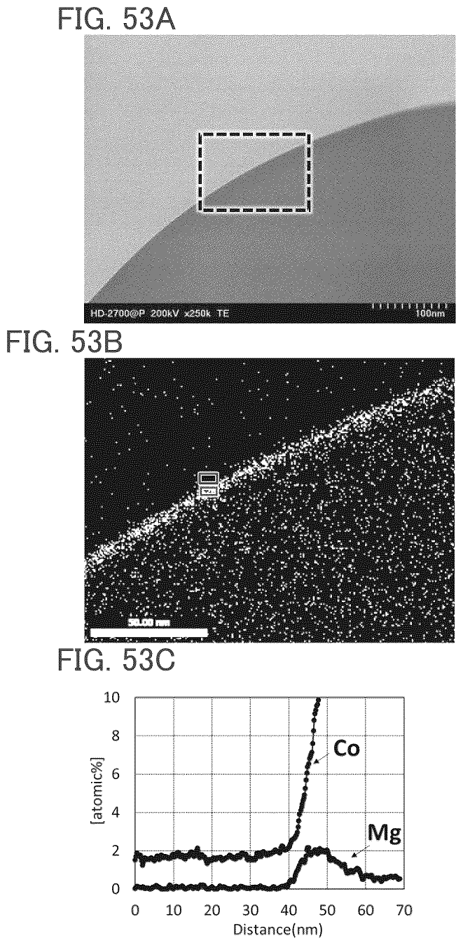

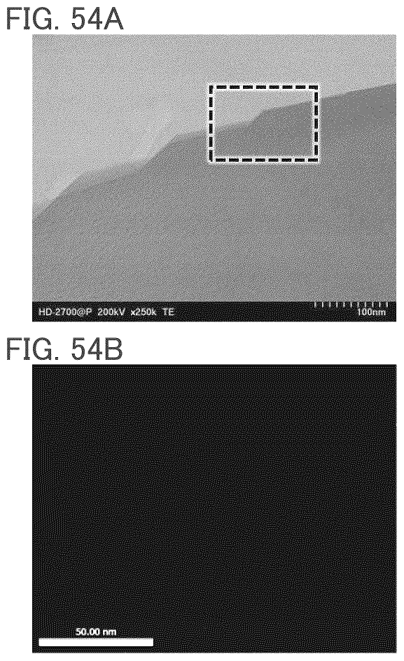

FIG. 51A shows a cross-sectional STEM image of Sample 3-1. FIG. 52A shows a cross-sectional STEM image of Sample 3-2. FIG. 53A shows a cross-sectional STEM image of Sample 3-3. FIG. 54A shows a cross-sectional STEM image of Sample 4. In a cross-sectional STEM image, lithium cobalt oxide looks dark and a carbon coating or a resin layer provided for observation looks bright. Such contrast in a cross-sectional STEM image enables specifying the surface of the lithium cobalt oxide. The cross-sectional STEM images show that Sample 3-1, Sample 3-2, and Sample 3-3 had no projection, were rounded, and were sleek or shiny. By contrast, a projection was observed in Sample 4.

Next, EDX mapping images for magnesium in the regions enclosed with the dashed line rectangles in the aforementioned cross-sectional STEM images are shown. FIG. 51B shows the EDX mapping image of Sample 3-1. FIG. 52B shows the EDX mapping image of Sample 3-2. FIG. 53B shows the EDX mapping image of Sample 3-3. FIG. 54B shows the EDX mapping image of Sample 4. Much magnesium distributed unevenly in a surface portion was observed in each of Sample 3-1, Sample 3-2, and Sample 3-3. Note that magnesium may be distributed in an inner portion to have a low concentration. By contrast, a bright spot indicating magnesium was not observed in Sample 4.

Next, FIG. 51C shows results of EDX line analysis performed on the surface portion of the EDX mapping image in FIG. 51B in a direction perpendicular to the surface. Likewise, FIG. 52C shows results of EDX line analysis performed on the surface portion of the EDX mapping image in FIG. 52B in a direction perpendicular to the surface. Likewise, FIG. 53C shows results of EDX line analysis performed on the surface portion of the EDX mapping image in FIG. 53B in a direction perpendicular to the surface. As shown by the distribution of the magnesium concentration in each of Sample 3-1, Sample 3-2, and Sample 3-3, the magnesium concentration had the maximum value in the region extending 5 nm from the surface.

EDX point analysis was performed on a region (part of the surface portion) of the EDX mapping image enclosed with the solid line rectangle in each of FIG. 51B, FIG. 52B, and FIG. 53B. The magnesium concentrations obtained by the EDX point analysis were 1.1 atomic %, 0.5 atomic %, and 1.6 atomic % in Sample 3-1, Sample 3-2, and Sample 3-3, respectively. Here, the sum of the numbers of atoms of oxygen, fluorine, magnesium, aluminum, silicon, and cobalt detected from the lithium cobalt oxide was used as a reference. Thus, the magnesium concentration in each of Sample 3-1, Sample 3-2, and Sample 3-3 was found to be higher than 0.3 atomic % and lower than or equal to 2 atomic %, preferably higher than 0.5 atomic % and lower than or equal to 1.6 atomic %. This state is described with the expression “higher than 0 atomic % and lower than or equal to 2 atomic %”.

The distribution width of magnesium is 10 nm in Sample 3-1 according to the EDX line analysis and is presumed to be smaller than that in Samples 3-2 and 3-3.

According to this example, in the case where magnesium is used as an additive element of lithium cobalt oxide, the magnesium concentration is preferably higher than atomic % and lower than or equal to 2 atomic %, further preferably higher than 0.3 atomic % and lower than or equal to 2 atomic %, further preferably higher than or equal to 1 atomic % and lower than or equal to 2 atomic %, still further preferably higher than 0.5 atomic % and lower than 1.6 atomic %.

According to this example, in the case where magnesium is used as an additive element of lithium cobalt oxide, magnesium is preferably present within a thin region extending greater than or equal to 2 nm and less than or equal to 20 nm, further preferably greater than or equal to 2 nm and less than or equal to 10 nm, still further preferably greater than or equal to 2 nm and less than or equal to 5 nm from the surface. In other words, it was found that magnesium is preferably present in a shell and the magnesium concentration is higher in the shell than in an inner portion.

According to this example, use of the lid enabled the lithium cobalt oxide to be smooth without a projection and to be sleek or shiny. In a nail penetration test on a lithium-ion secondary battery that includes such lithium cobalt oxide having a sleek or shiny surface, the nail probably slides on the surface, which can inhibit cracking of the lithium cobalt oxide.

Next, the characteristics of batteries that included Sample 3-1, Sample 3-2, Sample 3-3, and Sample 4 were examined.

Positive electrodes were formed by using Sample 3-1, Sample 3-2, Sample 3-3, and Sample 4 as positive electrode active materials. Acetylene black (AB) and poly(vinylidene fluoride) (PVDF) were prepared as a conductive material and a binding agent, respectively. The PVDF prepared was one dissolved in N-methyl-2-pyrrolidone (NMP) with the weight ratio of PVDF to NMP being 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the application of the slurry on the positive electrode current collector, the solvent was volatilized.

After that, pressing was performed with a roller press machine to increase the density of the positive electrode active material layer over the positive electrode current collector. In the pressing, a linear pressure of 210 kN/m was applied and furthermore, a pressure of 1467 kN/m was applied. Note that the temperature of each of an upper roll and a lower roll of the roller press machine was 120° C. In each sample, the loading level of the positive electrode active material was approximately 7 mg/cm².

### <Fabrication of Half Cell>

Half cells were each fabricated using the positive electrode fabricated as described above with the use of Sample 3-1, Sample 3-2, Sample 3-3, or Sample 4, a lithium metal foil, a separator, an electrolyte solution (Electrolyte Solution A in the above example to which vinylene carbonate (VC) as an additive agent was added at 2 wt %), a coin cell positive electrode can, and a coin cell negative electrode can.

As the separator, 25-μm-thick polypropylene was used.

The positive electrode can and the negative electrode can were those formed of stainless steel (SUS).

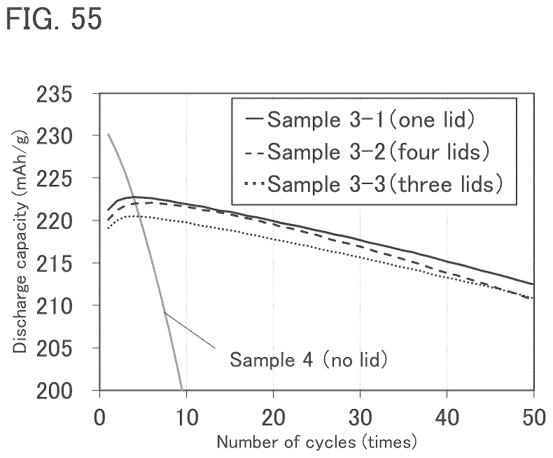

FIG. 55 shows the cycle performance of the half cells formed using Sample 3-1, Sample 3-2, Sample 3-3, and Sample 4. The cycle performance was evaluated at 25° C. while the CCCV charging (0.5 C, 4.6 V, termination current of 0.05 C) and the CC discharging (0.5 C, 2.5 V) were performed.

It was found that the cycle performance was favorable when Sample 3-1, Sample 3-2, and Sample 3-3 were used. By contrast, the cycle performance was poor when Sample 4 was used. The discharge capacity after 50 cycles was 212.5 mAh/g in the case where Sample 3-1 was used, 210.8 mAh/g in the case where Sample 3-2 was used, and 210.8 mAh/g in the case where Sample 3-3 was used. The discharge capacity after 50 cycles was found to be 200 mAh/g, preferably higher than or equal to 210 mAh/g, when the sample containing magnesium as an additive element and heated with a lid covering a crucible was used.

According to this example, covering a container such as a crucible with a lid at the time of heating leads to favorable cycle performance. The lid prevents a material from being volatilized or sublimated at the time of temperature rise and drop and allows the surface of lithium cobalt oxide to be shiny or sleek and free of a projection. Such a projection-free surface of lithium cobalt oxide allows an additive element to be distributed into the lithium cobalt oxide and over the surface uniformly and to be present in a thin region at the surface.

It is presumable that a desirable shell was formed in the positive electrode active materials of Sample 3-1, Sample 3-2, and Sample 3-3. In other words, the positive electrode active material of one embodiment of the present invention is highly safe because it does not easily ignite when abnormalities such as an internal short circuit occurs.

### Example 6

In this example, the positive electrode active material 100 of one embodiment of the present invention was formed and subjected to powder resistivity measurement and a charge and discharge cycle test.

### <Formation 4 of Positive Electrode Active Material>

The positive electrode active materials formed in this example are described with reference to the formation method in FIG. 23 and FIGS. 24A to 24C.

As the LiCoO₂ in Step S14 in FIG. 23, commercially available lithium cobalt oxide (Cellseed C-10N produced by NIPPON CHEMICAL INDUSTRIAL CO., LTD.) containing cobalt as the transition metal M and no additive element was prepared. The initial heating in Step S15 was not performed in this example.

In accordance with Step S21 shown in FIG. 24A, LiF and MgF₂ were prepared as the F source and the Mg source, respectively. The LiF and MgF₂ were weighted such that LiF:MgF₂=1:3 (molar ratio), dehydrated acetone was added as a solvent, and the materials were mixed and ground by a wet method to give the A1 source.

In accordance with Step S31 and Step S32 in FIG. 23, the A1 source was added to give the mixture 903. In Step S31, the A1 source and the lithium cobalt oxide were weighed such that the number of magnesium atoms of the A1 source was 0.1% with respect to the number of cobalt atoms of the lithium cobalt oxide, and were mixed by a dry method.

Subsequently, in Step S33 in FIG. 23, the mixture 903 was heated. The heating was performed at 850° C. for 60 hours. During the heating, the mixture 903 was in a crucible covered with a lid. The crucible and the lid were those made of alumina. In order that the crucible can be filled with an atmosphere containing oxygen, oxygen was supplied at a flow rate of 10 L/min to a furnace used for the heating (flowing). As a result of this heating, Sample 5-1 as lithium cobalt oxide containing magnesium and fluorine was obtained (Step S34a). No A2 source was added in this example.

Sample 5-2, Sample 5-3, Sample 5-4, Sample 5-5, and Sample 5-6 were formed in addition to Sample 5-1. Sample 5-2, Sample 5-3, Sample 5-4, Sample 5-5, and Sample 5-6 were different from Sample 5-1 in the proportion of the A1 source mixed in Step S31 in FIG. 23.

Sample 5-2 was formed under the same conditions as Sample 5-1 except that the A1 source and the lithium cobalt oxide were weighed such that the number of magnesium atoms of the A1 source was 0.5% with respect to the number of cobalt atoms of the lithium cobalt oxide.

Sample 5-3 was formed under the same conditions as Sample 5-1 except that the A1 source and the lithium cobalt oxide were weighed such that the number of magnesium atoms of the A1 source was 1.0% with respect to the number of cobalt atoms of the lithium cobalt oxide.

Sample 5-4 was formed under the same conditions as Sample 5-1 except that the A1 source and the lithium cobalt oxide were weighed such that the number of magnesium atoms of the A1 source was 2.0% with respect to the number of cobalt atoms of the lithium cobalt oxide.

Sample 5-5 was formed under the same conditions as Sample 5-1 except that the A1 source and the lithium cobalt oxide were weighed such that the number of magnesium atoms of the A1 source was 3.0% with respect to the number of cobalt atoms of the lithium cobalt oxide.

Sample 5-6 was formed under the same conditions as Sample 5-1 except that the A1 source and the lithium cobalt oxide were weighed such that the number of magnesium atoms of the A1 source was 6.0% with respect to the number of cobalt atoms of the lithium cobalt oxide.

### <Formation of Reference Positive Electrode Active Material>

As a reference in this example, Sample 2 was used as in the nail penetration test.

### <Powder Resistivity Measurement>

The volume resistivity of powder of Sample 5-2, Sample 5-3, Sample 5-6, and Sample 2 was measured.

The volume resistivity of the powder was measured by the measurement method described in <<Powder resistivity measurement>> in Embodiment 1. As a measurement device, MCP-PD51 produced by Mitsubishi Chemical Analytech Co., Ltd. was used. The range in which accurate measurement can be performed differs between resistance meters; thus, an appropriate resistance meter was selected in accordance with the resistivity of a sample. The measurement was performed in a common laboratory environment (i.e., an environment at a temperature higher than or equal to 15° C. and lower than or equal to 30° C.).

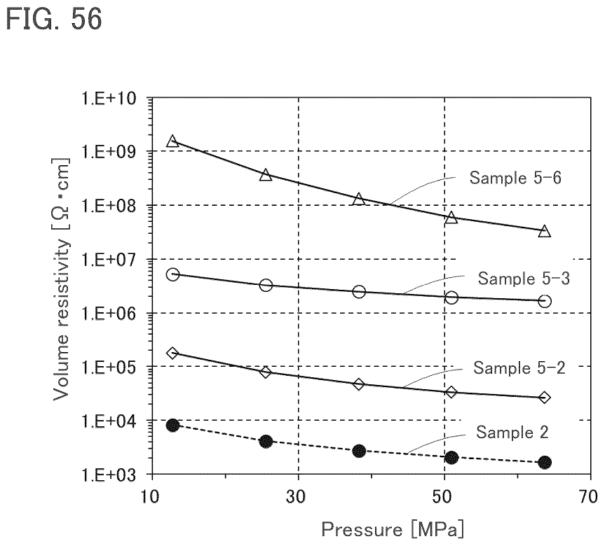

The volume resistivity of the powder of each sample was obtained by measuring the electric resistance and volume of the powder set in a measurement unit, under pressures of 13 MPa, 25 MPa, 38 MPa, 51 MPa, and 64 MPa. FIG. 56 shows the results.

It was found from FIG. 56 that in the positive electrode active material containing magnesium and fluorine, the larger the amount of the A1 source mixed, the higher the powder resistivity. It is presumable that magnesium and the like positioned in a shell increased the powder resistivity of the positive electrode active material. Specifically, the volume resistivity of the powder of Sample 5-2 was found to be higher than or equal to 1.0×10⁴ Ω·cm under a pressure of 64 MPa. The volume resistivity of the powder of Sample 5-3 was found to be higher than or equal to 1.0×10⁶ Ω·cm under a pressure of 64 MPa. The volume resistivity of the powder of Sample 5-6 was found to be higher than or equal to 1.0×10⁷ Ω·cm under a pressure of 64 MPa.

From FIG. 56, the volume resistivity under a pressure of 64 MPa is preferably higher than or equal to 5.0×10³ Ω·cm, further preferably higher than or equal to 1.0×10^{4 Ω·cm, still further preferably higher than or equal to} 1.0×10⁵ Ω·cm, yet still further preferably higher than or equal to 5.0×10⁵ Ω·cm, yet still further preferably higher than or equal to 1.0×10⁶ Ω·cm.

From FIG. 56, the volume resistivity under a pressure of 13 MPa is preferably higher than or equal to 2.0×10⁴ Ω·cm, further preferably higher than or equal to 2.0×10⁵ Ω·cm, still further preferably higher than or equal to 5.0×10⁵ Ω·cm, yet still further preferably higher than or equal to 1.0×10⁶ Ω·cm, yet still further preferably higher than or equal to 2.0×10⁶ Ω·cm.

The volume resistivity tends to be higher under a lower pressure than under a higher pressure. Thus, the volume resistivity is preferably higher than or equal to 1.0×10⁴ Ω·cm under a pressure of 64 MPa and higher than or equal to 2.0×10⁴ Ω·cm under a pressure of 13 MPa. The volume resistivity is further preferably higher than or equal to 1.0×10⁵ Ω·cm under a pressure of 64 MPa and higher than or equal to 2.0×10⁵ Ω·cm under a pressure of 13 MPa. Furthermore, it can be said that the volume resistivity is still further preferably higher than or equal to 5.0×10⁵ Ω·cm under a pressure of 64 MPa and higher than or equal to 1.0×10⁶ Ω·cm under a pressure of 13 MPa.

It can be said that the insulating property of each of Sample 5-2, Sample 5-3, and Sample 5-6 is better than that of Sample 2 by one to five orders of magnitude, preferably by two to three orders of magnitude. Although the powder volume resistivity was measured at room temperature (25° C.) in this example, the insulating property of each of Sample 5-2, Sample 5-3, and Sample 5-6 is presumably better than that of Sample 2 also at a temperature higher than room temperature. It is thus presumable that secondary batteries that include Sample 5-2, Sample 5-3, and Sample 5-6 do not easily ignite in a nail penetration test and are highly safe.

### <Fabrication of Half Cell>

Next, coin-type half cells were fabricated using Sample 5-1, Sample 5-2, Sample 5-3, Sample 5-4, Sample 5-5, and Sample 5-6 as positive electrode active materials.

First, the positive electrode active materials were prepared, and acetylene black (AB) and poly(vinylidene fluoride) (PVDF) were prepared as a conductive material and a binding agent, respectively. The PVDF prepared was one dissolved in N-methyl-2-pyrrolidone (NMP) with the weight ratio of PVDF to NMP being 5%. Then, the positive electrode active material, AB, and PVDF were mixed at a weight ratio of 95:3:2 to form a slurry, and the slurry was applied on an aluminum positive electrode current collector. As a solvent of the slurry, NMP was used.

Next, after the application of the slurry on the positive electrode current collector, the solvent was volatilized, whereby a positive electrode active material layer was formed over the positive electrode current collector.

After that, pressing was performed with a roller press machine to increase the density of the positive electrode active material layer over the positive electrode current collector. The pressing was performed with a linear pressure of 210 kN/m. Note that the temperature of each of an upper roll and a lower roll of the roller press machine was 120° C.

Through the above steps, the positive electrode was obtained. In the positive electrode, the loading level of the active material was approximately 7 mg/cm².

As an electrolyte solution, a mixture of ethylene carbonate (EC) and diethyl carbonate (DEC) at a volume ratio of 3:7 to which vinylene carbonate (VC) as an additive agent was added at 2 wt % was used. The electrolyte solution contained lithium hexafluorophosphate (LiPF₆) as a lithium salt at 1 mol/L. As a separator, a polypropylene porous film was used.

For a negative electrode (counter electrode), a lithium metal was used. The coin-type half cells were fabricated using these components.

The half cell fabricated using Sample 5-1 as the positive electrode active material is referred to as Cell 5-1, the half cell fabricated using Sample 5-2 as the positive electrode active material is referred to as Cell 5-2, the half cell fabricated using Sample as the positive electrode active material is referred to as Cell 5-3, the half cell fabricated using Sample 5-4 as the positive electrode active material is referred to as Cell the half cell fabricated using Sample 5-5 as the positive electrode active material is referred to as Cell 5-5, and the half cell fabricated using Sample 5-6 as the positive electrode active material is referred to as Cell 5-6.

### <Charge and Discharge Cycle Test>

Cell 5-1 to Cell 5-6 described above underwent a charge and discharge cycle test.

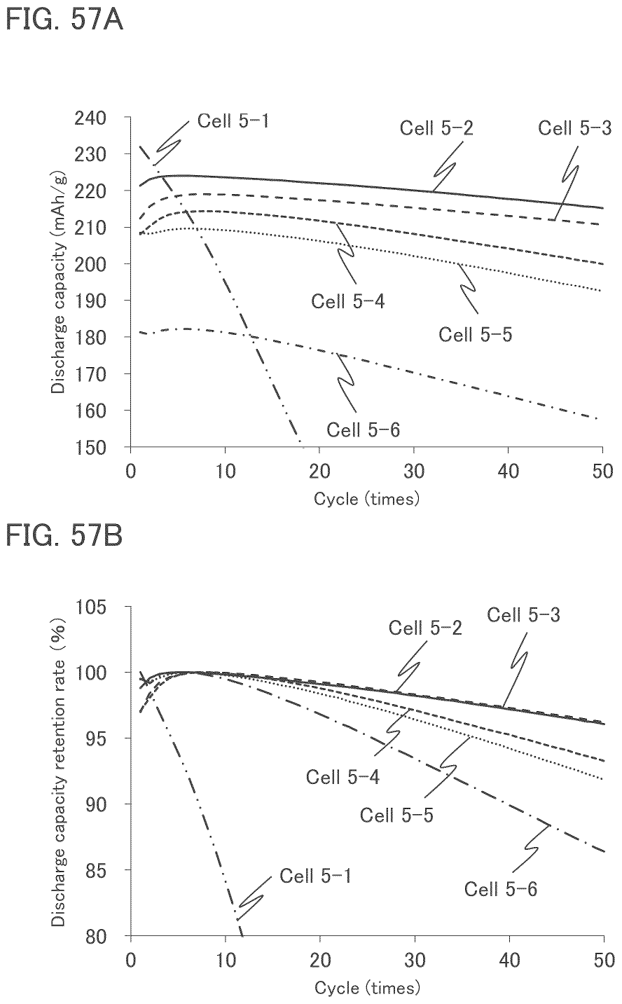

The test conditions were as follows. In the charging, constant current charging at 0.5 C was performed up to 4.6 V and then, constant voltage charging was performed until the current value reached 0.05 C. As the discharging, constant current discharging at 0.5 C was performed up to 2.5 V. Note that here, 1 C was set to 200 mA/g. The environmental temperature of the measurement was 25° C. The charging and discharging were repeated 50 times. FIGS. 57A and 57B show the results of the charge and discharge cycle test.

The vertical axis in FIG. 57A represents discharge capacity (mAh/g), and the vertical axis in FIG. 57B represents discharge capacity retention rate (%). The horizontal axis in each graph represents the number of cycles in the charge and discharge cycle test. In FIG. 57B, the discharge capacity in the cycle in which the discharge capacity became the largest during the charge and discharge cycle test was assumed to be 100% in each cell.

The discharge capacity in the 50th cycle of the charge and discharge cycle test was 215.2 mAh/g in Cell 5-2, 210.7 mAh/g in Cell 5-3, 199.9 mAh/g in Cell 5-4, and 192.5 mAh/g in Cell 5-5. Cell 5-2, Cell 5-3, Cell 5-4, and Cell 5-5 were found to have favorable discharge capacity, or specifically, a discharge capacity in the 50th cycle higher than or equal to 190 mAh/g, preferably higher than or equal to 200 mAh/g. In Cell 5-1, the initial discharge capacity was also favorable. It was shown that a lithium ion (Lit) can be inserted into and extracted from the positive electrode active material in which magnesium and the like are positioned in a shell.

The discharge capacity retention rate in the 50th cycle of the charge and discharge cycle test was 96.1% in Cell 5-2, 96.2% in Cell 5-3, 93.3% in Cell 5-4, and 91.8% in Cell 5-5. Cell 5-2, Cell 5-3, Cell 5-4, and Cell 5-5 were found to have a favorable discharge capacity retention rate, or specifically, a discharge capacity retention rate in the 50th cycle higher than or equal to 90%, preferably higher than or equal to 95%.

Cell 5-6 had a higher discharge capacity retention rate than Cell 5-1 but had a lower discharge capacity retention rate than Cell 5-2 to Cell 5-5. The volume resistivity of Sample 5-6, which was used as the positive electrode active material of Cell 5-6, was 3.3×10⁷ Ω·cm under 64 MPa according to FIG. 56. From these results, it is presumable that to have high discharge capacity, a secondary battery preferably includes a positive electrode active material whose volume resistivity is lower than 3.3×10⁷ Ω·cm under 64 MPa.

### Example 7

In this example, a change in powder resistivity during a formation process of the positive electrode active material 100 of one embodiment of the present invention was analyzed. Sample 6-1, Sample 6-2, Sample 6-3, and Sample 6-4 were prepared for powder resistivity measurement.

### <Formation of Sample for Powder Resistivity Measurement>

Sample 6-1, Sample 6-2, Sample 6-3, and Sample 6-4 for the powder resistivity measurement are described with reference to the formation method in FIG. 23 and FIGS. 24A to 24C. Note that specific conditions of the formation method were the same as those in Example 1.

As in Example 1, the LiCoO₂ of Step S14 in FIG. 23 was prepared and used as Sample 6-1.

As in Example 1, the LiCoO₂ subjected to the initial heating of Step S15 in FIG. 23 was formed and used as Sample 6-2.

As in Example 1, the composite oxide of Step S34a in FIG. 23 was formed and was used as Sample 6-3.

As in Example 1, the positive electrode active material 100 of Step S54 in FIG. 23 was formed and was used as Sample 6-4.

### <Powder Resistivity Measurement>

The volume resistivity of the powder of Sample 6-1, Sample 6-2, Sample 6-3, and Sample 6-4 was measured.

The volume resistivity of the powder was measured by the measurement method described in <<Powder resistivity measurement>> in Embodiment 1. As a measurement device, MCP-PD51 produced by Mitsubishi Chemical Analytech Co., Ltd. was used. As a resistance meter, Loresta-GP or Hiresta-UP was used. The measurement was performed in a common laboratory environment, i.e., in an environment at 25° C.

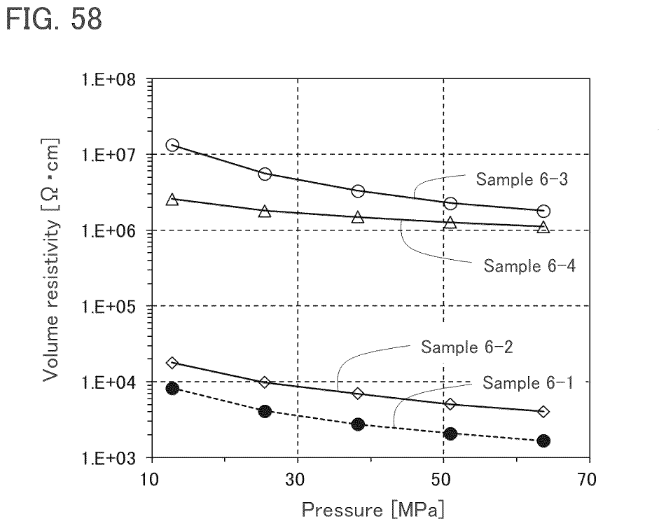

The volume resistivity of the powder of each sample was obtained by measuring the electric resistance and volume of the powder set in a measurement unit, under pressures of 13 MPa, 25 MPa, 38 MPa, 51 MPa, and 64 MPa. FIG. 58 shows the results.

As can be seen in FIG. 58 that shows the results of measuring the volume resistivity of the powder, the volume resistivity of Sample 6-2 was higher than that of Sample 6-1. The volume resistivity of Sample 6-3 was higher than that of Sample 6-2. The volume resistivity of Sample 6-4 was higher than that of Sample 6-2 and lower than that of Sample 6-3. In other words, the volume resistivity value was the largest in Sample 6-1, followed by Sample 6-2, Sample 6-4, and Sample 6-3.

From FIG. 58, the volume resistivity under a pressure of 64 MPa is preferably higher than or equal to 5.0×10³ Ω·cm, further preferably higher than or equal to 1.0×10⁴ Ω·cm, still further preferably higher than or equal to 1.0×10⁵ Ω·cm, yet still further preferably higher than or equal to 5.0×10⁵ Ω·cm, yet still further preferably higher than or equal to 1.0×10⁶ Ω·cm.

From FIG. 58, the volume resistivity under a pressure of 13 MPa is preferably higher than or equal to 2.0×10⁴ Ω·cm, further preferably higher than or equal to 2.0×10⁵ Ω·cm, still further preferably higher than or equal to 5.0×10⁵ Ω·cm, yet still further preferably higher than or equal to 1.0×10⁶ Ω·cm, yet still further preferably higher than or equal to 2.0×10⁶ Ω·cm.

The volume resistivity tends to be higher under a lower pressure than under a higher pressure. Thus, the volume resistivity is preferably higher than or equal to 1.0×10⁴ Ω·cm under a pressure of 64 MPa and higher than or equal to 2.0×10⁴ Ω·cm under a pressure of 13 MPa. The volume resistivity is further preferably higher than or equal to 1.0×10⁵ Ω·cm under a pressure of 64 MPa and higher than or equal to 2.0×10⁵ Ω·cm under a pressure of 13 MPa. Furthermore, it can be said that the volume resistivity is still further preferably higher than or equal to 5.0×10⁵ Ω·cm under a pressure of 64 MPa and higher than or equal to 1.0×10⁶ Ω·cm under a pressure of 13 MPa.

Although the powder volume resistivity was measured at room temperature (25° C.) in this example, the powder volume resistivity is presumably the highest in Sample 6-1, followed by Sample 6-2, Sample 6-4, and Sample 6-3 also at a temperature higher than room temperature. Since Sample 6-1 corresponds to Sample 2 used for the nail penetration test in Example 1, a cell that includes Sample 6-1 might ignite. Accordingly, either Sample 6-4 or Sample 6-3 is preferably used to provide a high-safety secondary battery that does not easily ignite in a nail penetration test.

### Example 8

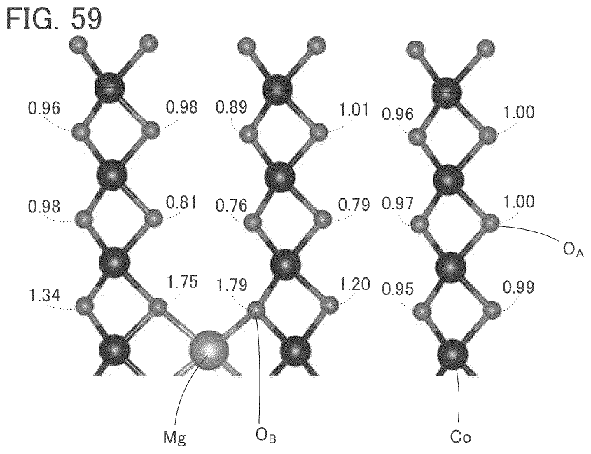

In this example, oxygen vacancy formation energy of oxygen was calculated to examine release of oxygen from the surface of LCO. First, the model shown in FIG. 59 was created. No Li ion is shown because the LCO is in a charged state in a nail penetration test or the like. Mg is located in a region corresponding to the surface and is bonded to oxygen. The oxygen vacancy formation energy (eV) of each oxygen is shown in the drawing. The oxygen vacancy formation energy of the oxygen apart from Mg (e.g., OA) is 1.00±0.20 (eV). By contrast, the oxygen vacancy formation energy (eV) of oxygen OB near Mg is 1.79 (eV), which is larger than that of the oxygen OA apart from Mg. It is thus presumed that oxygen near Mg is not easily released and oxygen is not easily released from the Mg-containing surface of LCO.

The calculation in this example revealed that Mg inhibits release of nearby oxygen. It is presumed that the presence of the Mg in a shell inhibits oxygen release and thereby inhibits oxygen release from a positive electrode also when the nail penetration test is performed, for example, which in turn hinders ignition.

### Example 9

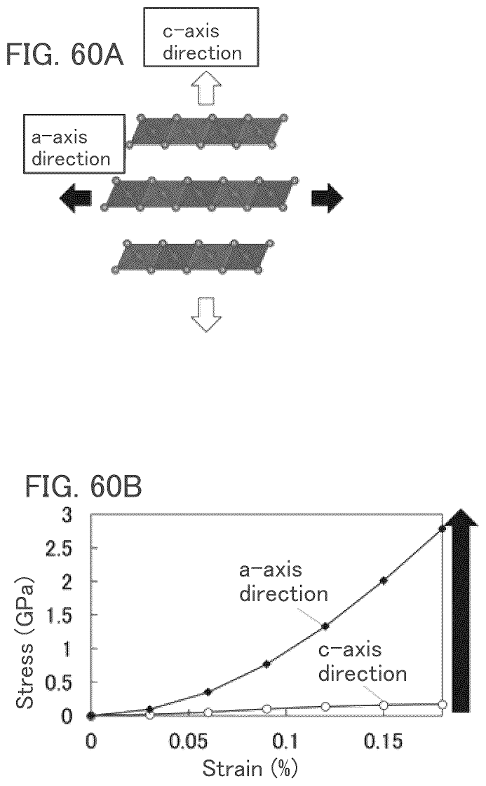

In this example, a plane orientation along which cracking easily occurs when force is exerted on lithium cobalt oxide was examined. First, the model shown in FIG. was created. No Li ion is shown because lithium cobalt oxide is in a charged state in a nail penetration test or the like; only CoO₂ layers are shown. The a-axis direction and the c-axis direction were used as the directions in which tensile strain is applied; thus, these directions are indicated in FIG. 60A. FIG. 60B shows stress (GPa) as a function of strain (%): a stress-strain curve of the case where tensile strain is applied in the a-axis direction and a stress-strain curve of the case where tensile strain is applied in the c-axis direction.

It was thus found that when the amount of strain applied is the same, the stress for the strain in the c-axis direction is smaller than the stress for the strain in the a-axis direction. This revealed that force exerted on lithium cobalt oxide as a result of thermal expansion or the like easily deforms the lithium cobalt oxide along the c-axis direction. It was thus found that the lithium cobalt oxide is easily cracked in a direction parallel to the C-plane as shown by the cracked surface in FIG. 39B.

### Example 10

In this example, energy change at the time of a reaction with a lithium metal in two models was calculated. One model is lithium cobalt oxide containing magnesium and the other model is lithium cobalt oxide containing magnesium and fluorine.

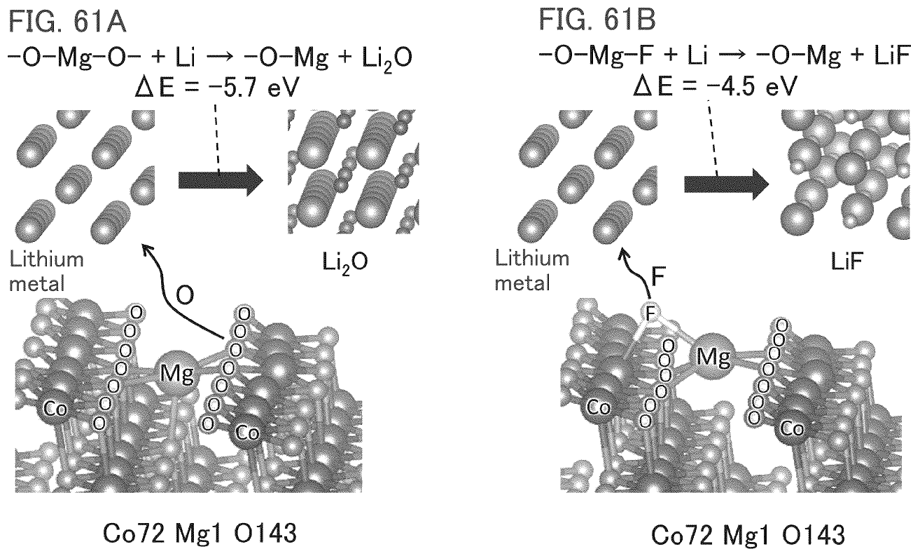

FIG. 61A shows the model assuming that no fluorine is at the surface and oxygen released from the lithium cobalt oxide reacts with a lithium metal originating from a negative electrode (which is assumed to be Li dendrite that have extended from the negative electrode) to form lithium oxide (Li₂O). FIG. 61B shows the model assuming that fluorine is at the surface and a lithium metal originating from the negative electrode reacts with fluorine to form lithium fluoride (LiF).

The calculation conditions are as follows.
Software: Vienna Ab initio Simulation Package (VASP)
Version: 6.2.1
Functional: GGA-PBE
Pseudopotential: PAW
k-point:
   Surface model: only gamma point
   Metallic Li: 5×5×5
   LiF: 5×5×5
   Li₂O: 5×5×5
Cutoff energy: 1000 eV
Van der Waals force: DFT-D2
LDAUU:
   Co: 2.0
   Other elements: 0.0
LDAUJ: 0.0 for all elements

The difference ΔE between the energy before the reaction and the energy after the reaction was calculated. It was shown that the ΔE is negatively larger (more heat is generated) in FIG. 61A (formation of Li₂O) than in FIG. 61B (formation of LiF).

The details of the calculation results are shown in the tables below. The unit is eV.

TABLE 15
FIG. 61A

| After reaction | | Before reaction | | |
|---|---|---|---|---|
| Surface model | LiO | Surface model | Lithium metal | |
| Co72 Mg1 O143 | Li2 O1 | Co72 Mg1 O144 | Li2 | ΔE |
| −1298.62641320 | −15.41324260 | −1304.31497189 | −4.02233156 | −5.70235235 |

FIG. 61B

| After reaction | | Before reaction | | |
|---|---|---|---|---|
| Surface model | LiF | Surface model | Lithium metal | |
| Co72 Mg1 O144 | Li1 F1 | Co72 Mg1 O144 F1 | Li1 | ΔE |
| −1304.31497189 | −10.17948788 | −1307.99960814 | −2.01116578 | −4.48368585 |

As described above, a reaction between a lithium metal and fluorine generates less heat than a reaction between a lithium metal and oxygen; thus, it is presumed that lithium cobalt oxide containing fluorine is highly safe when used in a secondary battery. It is presumed that while oxygen might be released from lithium cobalt oxide in a nail penetration test, a secondary battery that includes lithium cobalt oxide containing fluorine does not ignite in the nail penetration test.

### Example 11

In this example, lithium-ion secondary batteries were fabricated using the positive electrode active material of one embodiment of the present invention under conditions different from those described in the above example and underwent a nail penetration test.

### <Nail Penetration Test 4>

The lithium-ion secondary batteries to undergo Nail Penetration Test 4 were assembled by the same method as the lithium-ion secondary batteries in Example 1. All the lithium-ion secondary batteries to undergo Nail Penetration Test 4 included Electrolyte Solution A described above. The lithium-ion secondary batteries were each fabricated to have a capacity of approximately 2500 mAh. The loading level of the negative electrode active material was adjusted in accordance with the loading level of the positive electrode active material, and the number of positive electrodes stacked and the number of negative electrodes stacked were also adjusted. As the positive electrode active materials, Sample 1-1 and Sample 2 described in Example 1 were used. Table 16, Table 17, and Table 18 show the conditions of Nail Penetration Test 4. The tester and test conditions employed in this nail penetration test were the same as those in Nail Penetration Test 1.

TABLE 16

| | | Cell 1J | Cell 2J |
|---|---|---|---|
| Positive | Positive electrode active | Sample 1-1 | Sample 2 |
| electrode | material | | |
| | Binder | PVdF | PVdF |
| | Conductive additive | Acetylene black | Acetylene black |
| | Loading level | 21.5 mg/cm² | 21.3 mg/cm² |
| | (per one surface) | | |
| | Material and thickness of | Al, 20 μm | Al, 20 μm |
| | current collecting foil | | |
| | Pressure for pressing | 210 kN/m | 210 kN/m |
| Negative | Active material | Graphite | Graphite |
| electrode | Binder and thickener | SBR and CMC | SBR and CMC |
| | Conductive additive | VGCF | VGCF |
| | Loading level | 14.6 mg/cm² | 13.8 mg/cm² |
| | (per one surface) | | |
| | Material and thickness of | Cu, 18 μm | Cu, 18 μm |
| | current collecting foil | | |
| Separator | Material and thickness | Polypropylene (PP), 25 μm | Polypropylene (PP), 25 μm |
| Electrolyte | Solvent | EC:DEC = 30:70 | EC:DEC = 30:70 |
| solution | Lithium salt | 1M LiPF₆ | 1M LiPF₆ |
| Cell | Number of positive | 15 electrodes (double side coating) | 15 electrodes (double side coating) |
| condition | electrodes | | |
| | Number of negative | 14 electrodes (double side coating) + 2 | 14 electrodes (double side coating) + 2 |
| | electrodes | outermost electrodes (single side coating) | outermost electrodes (single side coating) |
| | Exterior body | Aluminum laminate film | Aluminum laminate film |
| Condition | Charge voltage | 4.5 V | 4.2 V |
| of nail | (at the time of aging) | | |
| penetration | Charge voltage | 4.5 V | 4.5 V |
| test | (at the time of nail | | |
| | penetration) | | |
| | Designed capacity | 2500 mAh | 2500 mAh |
| | Proportion of negative | 84.6% | 81.9% |
| | electrode capacity to | | |
| | positive electrode capacity | | |

TABLE 17

| | | Cell 1K | Cell 1L |
|---|---|---|---|
| Positive | Positive electrode active | Sample 1-1 | Sample 1-1 |
| electrode | material | | |
| | Binder | PVdF | PVdF |
| | Conductive additive | Acetylene black | Acetylene black |
| | Loading level | 21.0 mg/cm² | 21.1 mg/cm² |
| | (per one surface) | | |
| | Material and thickness of | Al, 20 μm | Al, 20 μm |
| | current collecting foil | | |
| | Pressure for pressing | 210 kN/m | 210 KN/m |
| Negative | Active material | Graphite | Graphite |
| electrode | Binder and thickener | SBR and CMC | SBR and CMC |
| | Conductive additive | VGCF | VGCF |
| | Loading level | 14.3 mg/cm² | 14.3 mg/cm² |
| | (per one surface) | | |
| | Material and thickness of | Cu, 18 μm | Cu, 18 μm |
| | current collecting foil | | |
| Separator | Material and thickness | Polypropylene (PP), 25 μm | Polypropylene (PP), 25 μm |
| Electrolyte | Solvent | EC:DEC = 30:70 | EC:DEC = 30:70 |
| solution | Lithium salt | 1M LiPF₆ | 1M LiPF₆ |
| Cell | Number of positive | 15 electrodes (double side coating) | 15 electrodes (double side coating) |
| condition | electrodes | | |
| | Number of negative | 14 electrodes (double side coating) + 2 | 14 electrodes (double side coating) + 2 |
| | electrodes | outermost electrodes (single side coating) | outermost electrodes (single side coating) |
| | Exterior body | Aluminum laminate film | Aluminum laminate film |
| Condition | Charge voltage | 4.5 V | 4.5 V |
| of nail | (at the time of aging) | | |
| penetration | Charge voltage | 4.5 V | 4.5 V |
| test | (at the time of nail | | |
| | penetration) | | |
| | Designed capacity | 2500 mAh | 2500 mAh |
| | Proportion of negative | 84.4% | 84.6% |
| | electrode capacity to | | |
| | positive electrode capacity | | |

TABLE 18

| | | Cell 1M |
|---|---|---|
| Positive | Positive electrode active | Sample 1-1 |
| electrode | material | |
| | Binder | PVdF |
| | Conductive additive | Acetylene black |
| | Loading level | 21.1 mg/cm² |
| | (per one surface) | |
| | Material and thickness of | Al, 20 μm |
| | current collecting foil | |
| | Pressure for pressing | 210 kN/m |
| Negative | Active material | Graphite |
| electrode | Binder and thickener | SBR and CMC |
| | Conductive additive | VGCF |
| | Loading level | 14.2 mg/cm² |
| | (per one surface) | |
| | Material and thickness of | Cu, 18 μm |
| | current collecting foil | |
| Separator | Material and thickness | Polypropylene (PP), 25 μm |
| Electrolyte | Solvent | EC:DEC = 30:70 |
| solution | Lithium salt | 1M LiPF₆ |
| Cell | Number of positive | 15 electrodes |
| condition | electrodes | (double side coating) |
| | Number of negative | 14 electrodes |
| | electrodes | (double side coating) + |
| | | 2 outermost electrodes |
| | | (single side coating) |
| | Exterior body | Aluminum laminate film |
| Condition | Charge voltage | 4.5 V |
| of nail | (at the time of aging) | |
| penetration | Charge voltage | 4.6 V |
| test | (at the time of nail | |
| | penetration) | |
| | Designed capacity | 2500 mAh |
| | Proportion of negative | 85.0% |
| | electrode capacity to | |
| | positive electrode capacity | |

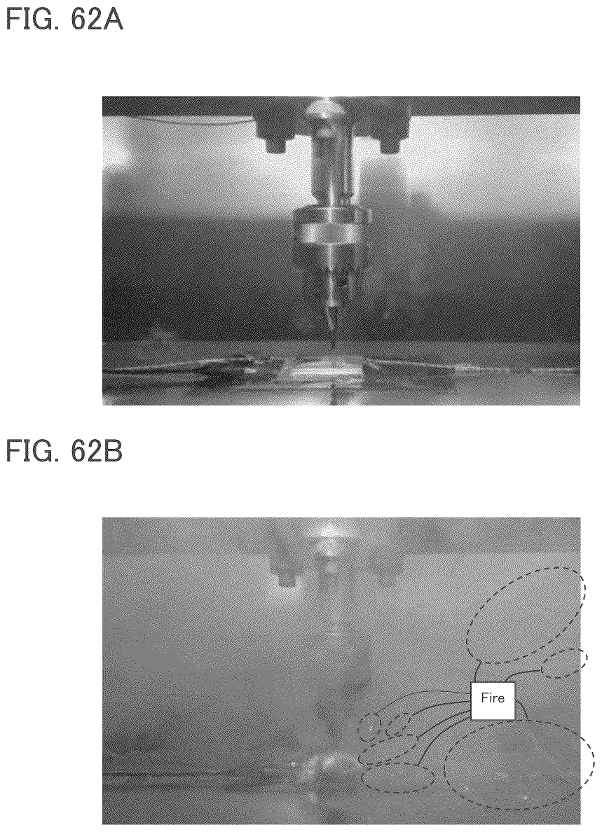

FIG. 62A and FIG. 62B respectively show Cell 1J and Cell 2J undergoing the nail penetration test. For easy understanding, regions in which fire was observed are indicated with dotted line circles in FIG. 62B. As shown in FIG. 62A, neither fire nor battery shape change was observed in the nail penetration test of Cell 1J, although a small amount of smoke was observed; thus, it was judged that Cell 1J did not ignite. By contrast, as shown in FIG. 62B, smoke and fire were observed in the nail penetration test of Cell 2J and thus, it was judged that Cell 2J ignited. The lithium-ion secondary battery including the positive electrode active material of one embodiment of the present invention did not ignite despite its capacity of approximately 2500 mAh. In other words, the lithium-ion secondary battery including the positive electrode active material of one embodiment of the present invention is highly safe.

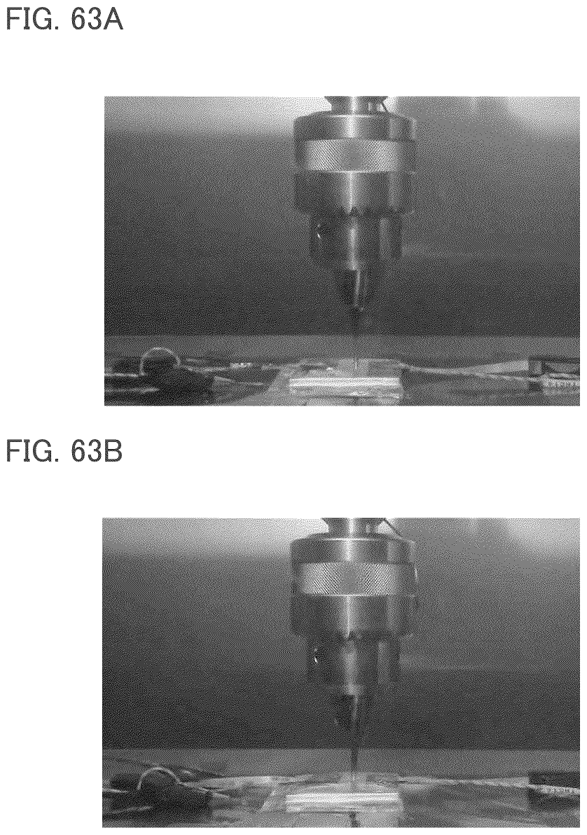

FIG. 63A and FIG. 63B respectively show Cell 1K and Cell 1L undergoing the nail penetration test. As in the nail penetration test of Cell 1J, neither fire nor battery shape change was observed in the nail penetration test of Cell 1K and Cell 1L, although a small amount of smoke was observed; thus, it was judged that Cell 1K and Cell 1L did not ignite. Cell 1K and Cell 1L are lithium-ion secondary batteries fabricated under conditions similar to those of Cell 1J, which proves the reproducibility of the result that the lithium-ion secondary battery including the positive electrode active material of one embodiment of the present invention does not ignite despite its capacity of approximately 2500 mAh.

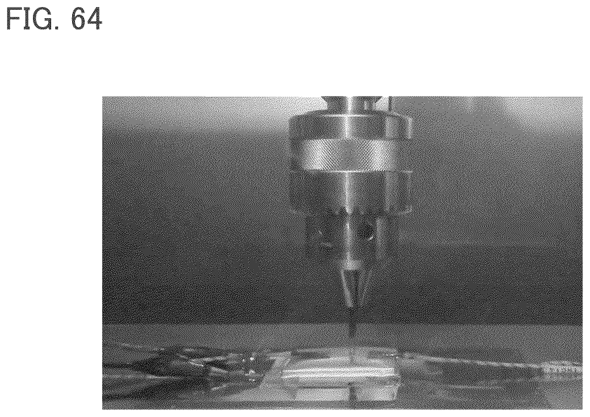

FIG. 64 shows Cell 1M undergoing the nail penetration test. As in the nail penetration test of Cell 1J and the like, neither fire nor battery shape change was observed in the nail penetration test of Cell 1M, although a small amount of smoke was observed; thus, it was judged that Cell 1M did not ignite. Note that the charge voltage of Cell 1M during the nail penetration test was 4.6 V, which was higher than that of Cell 1J during the test by 0.1 V. The results of the nail penetration test of Cell 1M suggest that the lithium-ion secondary battery including the positive electrode active material of one embodiment of the present invention does not ignite even when overcharged, and is extremely safe.

### <AC Impedance Measurement>

Before the above nail penetration test, Cell 1J and Cell 2J in a fully charged state were subjected to AC impedance measurement.

The AC impedance measurement was performed using VMP3 (multi-channel potentio/galvanostat) produced by Bio-Logic Science Instruments under the following conditions: the amplitude voltage was 10 mV, the frequency was in the range of 200 kHz to 10 mHz (the number of measurement points was 74), and the temperature of the measurement environment was 25° C.

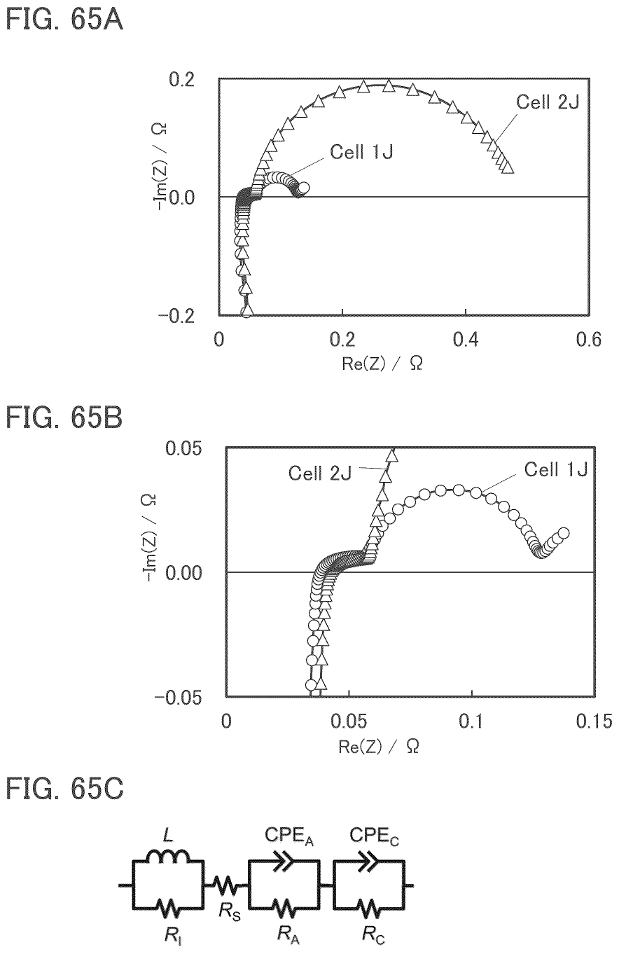

As the results of the AC impedance measurement, FIG. 65A and FIG. 65B show Nyquist diagrams. FIG. 65B is an enlarged view of a part in FIG. 65A. FIG. 65C shows an equivalent circuit used for analysis of the measurement data of the AC impedance. For the analysis of the measurement data, Z fit of EC-Lab, measurement and analysis software produced by Bio-Logic Science Instruments, was used.

In FIG. 65C, R_{I}, L, R_{S}, R_{A}, R_{C}, and constant phase elements (CPE) are arranged in the equivalent circuit on the assumption that R_{I} corresponds to the resistance due to a lead and a wiring of the battery, L corresponds to the inductance due to the lead and the wiring of the battery, R_{S} corresponds to the resistance of the electrolyte solution and the electric resistance of the electrode, RA corresponds to the resistance due to a coating film on the positive electrode surface, the resistance due to a coating film on the negative electrode surface, and charge transfer resistance on the negative electrode surface (resistance due to solvation and desolvation of Li ions and extraction and insertion of Li ions from and into the active material), R_{C} corresponds to charge transfer resistance on the positive electrode surface (resistance due to solvation and desolvation of Li ions and extraction and insertion of Li ions from and into the active material), and CPEs correspond to capacitance components in the porous electrodes.

Table 19 shows the values of R_{S}, R_{A}, and R_{C} of Cell 1J and Cell 2J as the analysis results of the measurement data of the AC impedance.

TABLE 19

| | Cell 1J | Cell 2J |
|---|---|---|
| R_{S} | 0.039 Ω | 0.034 Ω |
| R_{A} | 0.019 Ω | 0.026 Ω |
| R_{C} | 0.415 Ω | 0.068 Ω |

As shown in Table 19, R_{C} of Cell 1J is significantly different from that of Cell 2J; specifically, the R_{C} value of Cell 1J was approximately six times that of Cell 2J. R_{C} probably corresponds to charge transfer resistance on the positive electrode surface (resistance due to solvation and desolvation of Li ions and extraction and insertion of Li ions from and into the active material), which suggests that a difference between the positive electrode of Cell 1J and that of Cell 2J affected the results of the nail penetration test in this example.

### Example 12

### [DSC Test 2]

A DSC test for a charged state was conducted under conditions different from those in Example 4 to examine the thermal stability of the positive electrode active material of one embodiment of the present invention. In the DSC test, a positive electrode that was subjected to charging up to 4.6 V in a half cell whose negative electrode was made of a lithium metal was used. A method for fabricating the battery subjected to the test is described below.

### <Fabrication of Half Cell>

A half cell (Cell 4A-2) was fabricated which included a positive electrode containing Sample 1-2 formed in Example 4, a lithium metal foil, a separator, an electrolyte solution (Electrolyte Solution A in the above example), a coin cell positive electrode can, and a coin cell negative electrode can. The positive electrode active material loading level of Sample 1-2 for the DSC test in this example was 20.9 mg/cm².

A half cell (Cell 5A-2) was fabricated which included a positive electrode containing Sample 2, a lithium metal foil, a separator, an electrolyte solution, a coin cell positive electrode can, and a coin cell negative electrode can. The positive electrode active material loading level of Sample 2 for the DSC test in this example was 19.9 mg/cm².

### <Pretreatment for DSC Test>

As pretreatment for the DSC test, Cell 4A-2 and Cell 5A-2 described above were charged and discharged. The conditions of the charging for Cell 4A-2 were as follows: constant current charging at 0.1 C was performed up to 4.6 V, and constant voltage charging was performed at 4.6 V until a termination current of 0.005 C was reached. The discharging for Cell 4A-2 was constant current discharging at 0.1 C up to 2.5 V. The above charging and discharging for Cell 4A-2 were repeated twice. The conditions of the charging for Cell 5A-2 were as follows: constant current charging at 0.1 C was performed up to 4.3 V, and constant voltage charging was performed at 4.3 V until a termination current of 0.005 C was reached. The discharging for Cell 5A-2 was constant current discharging at 0.1 C up to 2.5 V. The above charging and discharging for Cell 5A-2 were repeated twice. Note that the environmental temperature of the charging and discharging for each cell was 25° C.

Then, on Cell 4A-2 and Cell 5A-2, constant current charging at 0.1 C was performed up to 4.6 V and then, constant voltage charging at 4.6 V was performed until a termination current of 0.005 C was reached, so that Cell 4A-2 and Cell 5A-2 were in a 4.6-V charged state. After that, Cell 4A-2 and Cell 5A-2 in the 4.6-V charged state were disassembled in a glove box with an argon atmosphere to take out the positive electrodes, and the positive electrodes were washed with DMC to remove the electrolyte solution. The positive electrode including Sample 1-2 and taken out from Cell 4A-2 and the positive electrode including Sample 2 and taken out from Cell 5A-2 were each stamped out to have a diameter of 3 mm ϕ.

The positive electrodes (Sample 1-2 and Sample 2) stamped out were each put in a stainless steel container and then, 1.5 μL of an electrolyte solution was dripped. This electrolyte solution was formed under the same conditions as the electrolyte solution used for the half cell. Then, zirconium oxide balls with a diameter of 2 mm were put on the positive electrode in the above stainless steel container. Putting such zirconium oxide balls has an effect of inhibiting the above positive electrode from being detached from the bottom surface of the container. After that, a stainless steel lid was pressed into the above container to seal the container.

### <DSC Test>

For the DSC test, Thermo plus EVO2 DSC8231, a high-sensitive differential scanning calorimeter produced by Rigaku Corporation, was used. The measurement conditions were as follows: the temperature range was from room temperature to 400° C. and the temperature rising rate was 5° C./min.

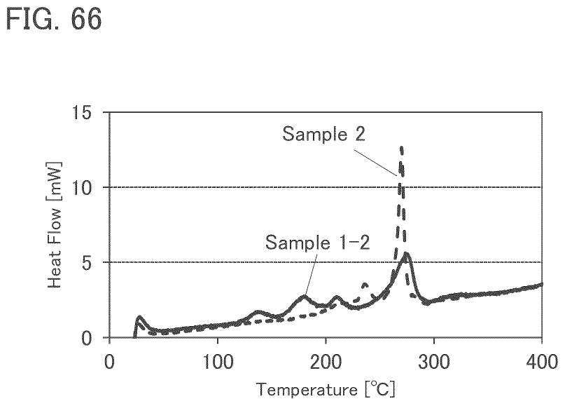

FIG. 66 shows the results of the DSC test in this example. The horizontal axis represents temperature and the vertical axis represents heat flow. In the graph, the solid line indicates the results for Sample 1-2 in the 4.6-V charged state and the dashed line indicates the results for Sample 2 in the 4.6-V charged state.

As shown in FIG. 66, Sample 1-2 in the 4.6-V charged state exhibited the maximum peak at 276° C. in the DSC test, and Sample 2 in the 4.6-V charged state exhibited the maximum peak at 270° C. in the DSC test. The maximum peak of Sample 1-2 at 276° C. is presumably attributable to heat generation due to (5) oxygen release from the positive electrode and thermal decomposition of the positive electrode (the thermal decomposition includes a structural change of a positive electrode active material) in FIG. 4. It is presumable that ignition did not occur in the nail penetration test in the above example because the temperature, i.e., internal temperature, of the lithium-ion secondary battery did not exceed 276° C. Furthermore, the calorific value at the above maximum peak of Sample 1-2 in the 4.6-V charged state was calculated to be 266 J/g, and the calorific value at the above maximum peak of Sample 2 in the 4.6-V charged state was calculated to be 300 J/g. Note that the weight (g) used for the calculation of the calorific value (J/g) is the sum of the weight of the active material layer of the positive electrode put in the above stainless steel container and the weight of the electrolyte solution put in the above stainless steel container. The weight of the active material layer is the sum of the weights of the active material, the binder, and the conductive material.

In the DSC test in this example, there was no significant difference in the temperature at which the maximum peak was exhibited; however, the calorific value at the peak in Sample 1-2 in the 4.6-V charged state was smaller than the calorific value at the peak in Sample 2 in the 4.6-V charged state by approximately 35 J/g. The smaller calorific value at the maximum peak in Sample 1-2 means that Sample 1-2 has higher thermal stability than Sample 2.

It is presumable that formation of a desirable shell in Sample 1-2 inhibited a thermal decomposition reaction involving oxygen release, which in turn hindered an increase in the internal temperature of the battery. In other words, the positive electrode active material of one embodiment of the present invention is highly safe because it does not easily ignite when abnormalities such as an internal short circuit occurs.

This application is based on Japanese Patent Application Serial No. 2022-092770 filed with Japan Patent Office on Jun. 8, 2022, Japanese Patent Application Serial No. 2022-100210 filed with Japan Patent Office on Jun. 22, 2022, Japanese Patent Application Serial No. 2022-103321 filed with Japan Patent Office on Jun. 28, 2022, Japanese Patent Application Serial No. 2022-110660 filed with Japan Patent Office on Jul. 8, 2022, Japanese Patent Application Serial No. 2022-139925 filed with Japan Patent Office on Sep. 2, 2022, Japanese Patent Application Serial No. 2022-151119 filed with Japan Patent Office on Sep. 22, 2022, Japanese Patent Application Serial No. 2023-001793 filed with Japan Patent Office on Jan. 10, 2023, and Japanese Patent Application Serial No. 2023-O34991 filed with Japan Patent Office on Mar. 7, 2023, the entire contents of which are hereby incorporated by reference.

What is claimed is:

1. A battery comprising a positive electrode,
wherein the positive electrode comprises a positive electrode active material,
wherein the positive electrode active material comprises a first region and a second region,
wherein the first region comprises lithium, cobalt, magnesium, and oxygen,
wherein the second region comprises lithium, cobalt, and oxygen,
wherein the first region is closer to a surface of the positive electrode active material than the second region is,
wherein the first region has a thickness greater than or equal to 1 nm and less than or equal to 20 nm, and
wherein the magnesium has a concentration higher than 0 atomic % and lower than or equal to 10 atomic %.

2. The battery according to claim 1,
wherein the first region further comprises nickel.

3. The battery according to claim 1,
wherein the first region further comprises nickel and fluorine.

4. The battery according to claim 1,
wherein the second region further comprises aluminum.

5. The battery according to claim 1,
wherein the first region extends 5 nm from the surface.

6. The battery according to claim 1,
wherein volume resistivity of powder of the positive electrode active material is higher than or equal to 1.0×10⁵ Ω·cm under a pressure of 64 MPa.

7. The battery according to claim 1,
wherein an increment ΔT of a temperature of the battery is less than or equal to ° C. when the battery undergoes a nail penetration test in which a voltage of the battery is 4.5 V, a nail diameter is 3 mm, and a nail penetration speed is 5 mm/sec.

8. A battery comprising a positive electrode,
wherein the positive electrode comprises a positive electrode active material,
wherein the positive electrode active material comprises a first region and a second region,
wherein the first region comprises first lithium, cobalt, magnesium, and oxygen,
wherein the second region comprises second lithium, cobalt, and oxygen,
wherein the first region is closer to a surface of the positive electrode active material than the second region is,
wherein fluorine is adsorbed onto the surface of the positive electrode active material,
wherein the fluorine is bonded to the first lithium,
wherein the first region has a thickness greater than or equal to 2 nm and less than or equal to 20 nm, and
wherein the magnesium has a concentration higher than 0 atomic % and lower than or equal to 10 atomic %.

9. The battery according to claim 8,
wherein the first region further comprises nickel.

10. The battery according to claim 8,
wherein the first region further comprises nickel and second fluorine.

11. The battery according to claim 8,
wherein the second region further comprises aluminum.

12. The battery according to claim 8,
wherein the first region extends 5 nm from the surface.

13. The battery according to claim 8,
wherein volume resistivity of powder of the positive electrode active material is higher than or equal to 1.0×10⁵ Ω·cm under a pressure of 64 MPa.

14. A battery comprising a positive electrode,
wherein the positive electrode comprises a positive electrode active material,
wherein the positive electrode active material comprises cobalt, nickel, and lithium,
wherein the positive electrode active material comprises a first region and a second region, the first region comprising at least part of a surface of the positive electrode active material, the second region being located inward from the first region,
wherein a ratio of the number of atoms of the nickel of the first region to the number of atoms of the cobalt of the first region is less than 1,
wherein a ratio of the number of atoms of the nickel of the second region to the number of atoms of the cobalt of the second region is less than the ratio of the number of the atoms of the nickel of the first region to the number of the atoms of the cobalt of the first region, and
wherein when the battery undergoes a nail penetration test for short-circuiting the battery without undergoing a charge and discharge cycle test, the battery does not ignite.

15. The battery according to claim 14,
wherein the nail penetration test is performed on the battery in a charged state in an environment at 25° C.

16. The battery according to claim 14,
wherein an increment ΔT of a temperature of the battery is less than or equal to 50° C. when the battery undergoes the nail penetration test in which a voltage of the battery is 4.5 V, a nail diameter is 3 mm, and a nail penetration speed is 5 mm/sec.

17. The battery according to claim 14,
wherein when the battery undergoes the nail penetration test for short-circuiting the battery after undergoing the charge and discharge cycle test with one to five cycles, the battery does not ignite.

18. The battery according to claim 17,
wherein the nail penetration test is performed on the battery in a charged state in an environment at 23° C.

19. The battery according to claim 18,
wherein an increment ΔT of a temperature of the battery is less than or equal to 70° C. when the battery undergoes the nail penetration test in which a voltage of the battery is 4.6 V, a nail diameter is 3 mm, and a nail penetration speed is 5 mm/sec.

20. The battery according to claim 14, further comprising an electrolyte solution.

21. The battery according to claim 14,
wherein resistance of the first region is higher than resistance of the second region.

22. The battery according to claim 17,
wherein the charge and discharge cycle test is performed in an environment at 45° C., and
wherein in the charge and discharge cycle test, charging is constant current-constant voltage charging and discharging is constant current discharging.

23. The battery according to claim 14,
wherein the first region comprises lithium,
wherein fluorine is adsorbed onto the surface, and
wherein the fluorine is capable of being bonded to the lithium of the first region.

24. A battery comprising a positive electrode,
wherein the positive electrode comprises a positive electrode active material,
wherein the positive electrode active material comprises a first region and a second region,
wherein the first region comprises lithium, cobalt, magnesium, and oxygen,
wherein the second region comprises lithium, cobalt, and oxygen,
wherein the first region is closer to a surface of the positive electrode active material than the second region is,
wherein in the positive electrode active material at a distance less than 2 cm from a nail hole due to a nail penetration test, a ratio of an atomic concentration of oxygen to an atomic concentration of cobalt is less than 1.3, and
wherein in the positive electrode active material at a distance more than or equal to 2 cm from the nail hole, a ratio of an atomic concentration of oxygen to an atomic concentration of cobalt is greater than or equal to 1.3.

25. The battery according to claim 24,
wherein the first region further comprises nickel.

26. The battery according to claim 24,
wherein the first region further comprises nickel and fluorine.

27. The battery according to claim 24,
wherein the second region further comprises aluminum.

28. The battery according to claim 24, further comprising a negative electrode and an electrolyte solution,
wherein the negative electrode comprises a negative electrode active material,
wherein the negative electrode active material comprises graphite, and
wherein the electrolyte solution comprises ethylene carbonate and diethyl carbonate.

29. The battery according to claim 24,
wherein in the nail penetration test, a voltage of the battery is 4.5 V, a nail diameter is 3 mm, and a nail penetration speed is 5 mm/sec.

30. A battery comprising a positive electrode, a negative electrode, and an electrolyte solution,
wherein the positive electrode comprises a positive electrode active material,
wherein the negative electrode comprises a negative electrode active material,
wherein the positive electrode active material comprises a first region and a second region,
wherein the first region comprises cobalt, magnesium, fluorine, and oxygen,
wherein the second region comprises cobalt and oxygen,
wherein the first region is closer to a surface of the positive electrode active material than the second region is,
wherein the negative electrode active material comprises graphite,
wherein the electrolyte solution comprises a mixed organic solvent, and
wherein when the battery in a fully charged state undergoes a nail penetration test in which a nail diameter is 3 mm and a nail penetration speed is 5 mm/sec, a voltage of the battery decreases from a first voltage Vb to a second voltage Vc and then exceeds the second voltage Vc.

31. The battery according to claim 30,
wherein an increment ΔT of a temperature of the battery is less than or equal to ° C. when the battery undergoes the nail penetration test in which a voltage of the battery is 4.5 V.

32. The battery according to claim 30,
wherein volume resistivity of powder of the positive electrode active material is higher than or equal to 1.0×10⁵ Ω·cm under a pressure of 64 MPa.

33. The battery according to claim 30,
wherein the battery does not ignite when the battery undergoes the nail penetration test.

34. A battery comprising a positive electrode, a negative electrode, and an electrolyte solution,
wherein the positive electrode comprises a positive electrode active material,
wherein the negative electrode comprises a negative electrode active material,
wherein the positive electrode active material comprises a first region and a second region,
wherein the first region comprises cobalt, magnesium, fluorine, and oxygen,
wherein the second region comprises cobalt and oxygen,
wherein the first region is closer to a surface of the positive electrode active material than the second region is,
wherein the negative electrode active material comprises graphite,
wherein the electrolyte solution comprises a mixed organic solvent, and
wherein when the battery in a fully charged state undergoes a nail penetration test in which a nail diameter is 3 mm and a nail penetration speed is 5 mm/sec after undergoing a charge and discharge cycle test in an environment at 45° C., a voltage of the battery decreases to Vc and remains at the Vc.

35. The battery according to claim 34,
wherein an increment ΔT of a temperature of the battery is less than or equal to 70° C. when the battery undergoes the nail penetration test in which a voltage of the battery is 4.6 V.

36. The battery according to claim 34,
wherein volume resistivity of powder of the positive electrode active material is higher than or equal to 1.0×10⁵ Ω·cm under a pressure of 64 MPa.

37. The battery according to claim 34,
wherein the battery does not ignite when the battery undergoes the nail penetration test.
